(19) United States
(12) Patent Application Publication
(10) Pub. No.: US 2026/0253225 A1
(43) Pub. Date: Aug. 27, 2026

(54) OPTICAL SYSTEM AND METHOD FOR MONITORING ABNORMALITY ASSOCIATED PARAMETERS IN CELL-CONTAINING SAMPLES

(71) Applicants: Eilon SHERMAN, Mevaseret-Zion (IL); Ishay WOHL, Herzliya (IL)

(72) Inventors: Eilon SHERMAN, Mevaseret-Zion (IL); Ishay WOHL, Herzliya (IL)

(21) Appl. No.: 19/160,214

(22) PCT Filed: Mar. 12, 2024
(86) PCT No.: PCT/IL2024/050261

§ 371 Date: Aug. 27, 2025

Related U.S. Application Data
(60) Provisional application No. 63/490,390, filed on Mar. 15, 2023.

(51) Int. Cl. G06T 7/00

(52) U.S. Cl. CPC G06T 7/0016; G06T 2207/10016; G06T 2207/10056; G06T 2207/20056; G06T 2207/30024

(57) ABSTRACT

An inspection system is presented for inspecting a live cell-containing sample by analyzing image data pieces corresponding to a sequence of acquisitions from a surface region of the sample detected using a pixelated detector, identifying dynamics in the image data indicative of vibrational motion of cells, in a direction substantially perpendicular to the cells' surface, underneath the surface region, and generating data about abnormality associated parameter(s) of cells. The analyzing comprises determining data indicative of distribution of mechanical properties within the surface region by determining Discrete Fourier Transform (DFT) and correlations of data corresponding to said image data and generating DFT representation thereof indicative of temporal position changes of cellular constituents, and/or for each pairs of images from said sequence of images, determining data indicative of a Pearson correlation coefficient between the images, enabling extraction of tumor associated parameter(s) of the cells.

### CROSS-REFERENCE TO RELATED APPLICATIONS

This application is a national phase filing under 35 C.F.R. § 371 of and claims priority to PCT Patent Application No. PCT/IL2024/050261, filed on Mar. 12, 2024, which claims the benefit of U.S. Provisional Application No. 63/490,390, filed on Mar. 15, 2023, the contents of which are hereby incorporated in their entireties by reference.

### TECHNOLOGICAL FIELD

The presently disclosed subject matter is in the field of imaging of biological tissues and relates to an optical system and method for detection of malignant tissues.

### BACKGROUND ART

References considered to be relevant as background to the presently disclosed subject matter are listed below:
1. Wohl, I. Sherman, E. (2021). Spectral Analysis of ATP-dependent mechanical vibrations in T cells. Front. Cell Dev. Biol.|doi: 0.3389/fcell.2021.590655
2. Guo, M., Ehrlicher, A. J., Jensen, M. H., Renz, M., Moore, J. R., Goldman, R. D., et al. (2014). Probing the stochastic, motor-driven properties of the cytoplasm using force spectrum microscopy. Cell 158, 822-832. doi: 10.1016/j.cell.2014.06.051
3. Lau, A. W. C., Hoffman, B. D., Davies, A., Crocker, J. C., and Lubensky, T. C. (2003). Microrheology, stress fluctuations, and active behavior of living cells. Phys. Rev. Lett. 91, 1-4.
4 Wohl, I., and Sherman, E. (2019). ATP-dependent diffusion entropy and homogeneity in living cells. Entropy 21, 962-980. doi: 10.3390/e21100962
5. Chugh, P., and Paluch, E. K. (2018). The actin cortex at a glance. J. Cell Sci. 131:jcs186254.
6. Salbreux, G., Charras, G., and Paluch, E. (2012). Actin cortex mechanics and cellular morphogenesis. Trends Cell Biol. 22, 536-545. doi: 10.1016/j.tcb.2012.07.001
7. Xu, W., Mezencev, R., Kim, B., Wang, L., McDonald, J., and Sulchek, T. (2012). Cell stiffness is a biomarker of the metastatic potential of ovarian cancer cells. PLOS One 7: e46609. doi: 10.1371/journal.pone.0046609
8. Hayashi, K., and Iwata, M. (2015). Stiffness of cancer cells measured with an AFM indentation method. J. Mech. Behav. Biomed. Mater. 49, 105-111. doi: 10.1016/j.jmbbm.2015.04.030
9. Krapf, D., Marinari, E., Metzler, R., Oshanin, G., Xu, X., and Squarcini, A. (2018). Power spectral density of a single Brownian trajectory: what one can and cannot learn from it. New J. Phys. 20:23029.
10. Krapf, D., Lukat, N., Marinari, E., Metzler, R., Oshanin, G., Selhuber-Unkel, C., et al. (2019). Spectral content of a single non-brownian trajectory. Phys. Rev. X 9:11019.
11. Sposini, V., Metzler, R., and Oshanin, G. (2019). Single-Trajectory spectral analysis of scaled Brownian motion. New J. Phys. 21:73043.
12. Wohl, I., Yakovian, O., Razvag, Y., Reches, M., and Sherman, E. (2020). Fast and synchronized fluctuations of cortical actin negatively correlate with nucleoli liquid-liquid phase separation in T cells. Eur. Biophys. J. 49, 409-423. doi: 10.1007/s00249-020-01446-9
13. Ma, Z., and Finkel, T. H. (2010). T cell receptor triggering by force. Trends Immunol. 31, 1-6. doi: 10.1016/j.it.2009.09.008
14. Cai, E., Marchuk, K., Beemiller, P., Beppler, C., Rubashkin, M. G., Weaver, V. M., et al. (2017). Visualizing dynamic microvillar search and stabilization during ligand detection by T cells. Science 356:eaal3118. doi: 10.1126/science.aal 3118
15. Walker, M., Rizzuto, P., Godin, M., and Pelling, A. E. (2020). Structural and mechanical remodeling of the cytoskeleton maintains tensional homeostasis in 3D microtissues under acute dynamic stretch. Sci. Rep. 10:7696.
16. Hwang, J. R., Byeon, Y., Kim, D., and Park, S. G. (2020). Recent insights of T cell receptor-mediated signaling pathways for T cell activation and development. Exp. Mol. Med. 52, 750-761. doi: 10.1038/s12276-020-0435-8
17. Limozin, L., Bridge, M., Bongrand, P., Dushek, O., van der Merwe, P. A., and Robert, P. (2019). TCR-pMHC kinetics under force in a cell-free system show no intrinsic catch bond, but a minimal encounter duration before binding. Proc. Natl. Acad. Sci. U.S.A. 116, 16943-16948. doi: 10.1073/pnas. 19021 41116

Acknowledgement of the above references herein is not to be inferred as meaning that these are in any way relevant to the patentability of the presently disclosed subject matter.

### BACKGROUND

Physicians often visualize tumors for initial evaluation toward early diagnostics. For that, a physician examines a suspected malignant tumor using a scope (cystoscopy for the bladder, colonoscopy for the rectum and colon, bronchoscopy for the lungs, hysteroscopy for the uterus or dermoscopy for the skin, etc.) and decides whether to perform a biopsy from the visually suspected area. Unfortunately, for this decision the physician can rely only on subjective morphological and clinical parameters.

False positive decisions to carry biopsies result in unnecessary patient pain, along with the risk of infection, bleeding or rarely perforation of the organ (a potentially life-threatening condition). These could result in patient suffering, prolonged hospitalization, and high hospitalization costs. False negative decisions may result in late or miss detection of malignant tumors, for which early detection is critical for effective treatment. Incomplete biopsies and resections for tumor removal may result in tumor regrowth and spreading.

### GENERAL DESCRIPTION

There is a need in the art for non-invasive or minimally invasive technique based on imaging capabilities to enable accurate determination of one or more abnormality associated parameters (disease (e.g., tumor) associated parameters) of cells in a cell-containing sample (e.g., various malignant cells in the sample) and thus provide the physician with objective parameters enabling to decide, with high level of accuracy, about further treatment, e.g. whether to proceed with a biopsy. Moreover, there is always a need to determine, with high level of accuracy, the borders of the suspected tumor (i.e. clean margins determination).

The presently disclosed subject matter is based on inventors' understanding that malignant cells are softer with increased intracellular (e.g. cytoskeletal, membrane and cytoplasmic) dynamics and activity (esp. in the form of intracellular mechanical work) relative to their counterpart benign cells. The inventors have found that this increased intracellular dynamics in malignant cells is reflected in these cells by related increase in vibrations of the cell surface in a relatively low frequencies range (<5 Hz), and such increase in vibrations of the cell surface can thus be used as a unique characterization of malignant cells distinguishing them from normal-condition cells.

The technique of the presently disclosed subject matter thus provides for detecting those increased cell surface vibrations that characterize malignant cells in superficial tissues and tissues lining internal lumens and internal cavities. To this end, the presently disclosed subject matter can apply to the cell-containing sample an imaging technique of any known suitable type accompanied by image data analysis in order to identify the vibrations of the tumor cells in the sample being analyzed, thus providing malignant tumor relating data. Such imaging techniques may include Differential Interference Contrast (DIC) microscopy, confocal microscopy, Total Internal Reflection Fluorescence (TIRF) based imaging.

Further, the presently disclosed subject matter provides for utilizing the principles of speckle-based imaging in a novel imaging system which enables simpler system configuration facilitating its implementation in a medical device (such as e.g. endoscope) which enables minimally invasive accurate imaging of regions of interest via body cavity or body lumen. In these regards, the inventors have found that in order to accurately detect abnormally vibrating cell parameters in the sample, the speckle-based imaging system is to implement an imaging mode using coherent light and focused imaging and detection scheme, to thereby obtain an image of the sample's surface with dynamic speckle pattern (induced due to motion of the surface) superimposed with the image.

Preferably, the speckle-based imaging is performed with normal-incidence/detection configuration of the optical scheme, which provides higher detection sensitivity to the cell surface vibration in substantially vertical direction (i.e. perpendicular to the cell surface). It should also be understood that such imaging mode enables collection of light reflected/scattered from surfaces, which while vibrating, may be oriented with some inclination with respect to the vertical direction.

This technique relies on illumination of sample's surface with coherent light focused on said surface to thereby cause the light reflection from the surface indicative of the surface image while including speckles caused by interference of the light components being reflected from the irregular vibrating surface. These interference effects are highly expressed and are highly sensitive to the cell surface vibration when using the normal incidence/detection scheme due to the vibrations of the reflecting surface in the vertical/inclined direction, thereby facilitating the analysis of image dynamics.

More specifically, coherent light (e.g. laser beam) is normally incident on the sample while being focused on the sample's surface, and is reflected back from said surface. It is to be noted that the perpendicularly collected light from the sample may include two components, i.e. specularly reflected light from perpendicularly oriented sample's surfaces and scattered light from sample's surfaces tilted with respect to the normally incident light. The interference of the reflected coherent light from irregular, moving cell surfaces generates dynamic speckle patterns, which are interposed on the image of the sample's surface. The sequentially acquired images of the tissue surface with the speckle patterns are captured by a pixelated imaging detector (e.g. CCD, electron-multiplying CCD, CMOS, scientific CMOS, etc.). The speckles-containing images of the cells are acquired repeatedly during a predetermined time interval in order to identify data indicative of temporal fluctuations of the intensities of specific pixels along the sequence of images.

Generally, the image data analysis of the presently disclosed subject matter applied to a sequence of images of the sample provides for extracting dynamics (time changes) in one or more characteristics/parameters of the cell including one or more of the following: cell surface motion/vibration and intracellular particles' motion, etc. The presently disclosed subject matter provides for detection of such mechanism as increase in mechanical energy (and increase in membrane fluctuations) that characterizes malignant cells in contrast to active and physiologically normal cells.

Considering the speckle-based imaging technique described above, the characteristic parameters to be monitored include a frequency of the pixel intensity fluctuations. To this end, the outputs of the pixelated detector along the imaging session (stream of image) undergo digital Fourier transforms to directly obtain vibration spectra being indicative of the cell surface condition enabling direct identification of malignancy of the sample.

In the description of the technique of the present disclosure, the term “cell surface” refers to cell membrane mechanically attached to the cortical actin part of the cytoskeleton. The mechanical properties of the cell surface reflect mainly the mechanical properties of the cortical actin. Also, in the description below, the vibration spectra are termed “spectral patterns” describing vibrational movements of cell surface/intracellular elements. Also, in the description below, the above-described system utilizing normal incidence and detection optical scheme operable with coherent focused imaging mode is referred to as speckle-based imaging system. However, it should be understood that this should not be confused with and should exclude defocused and/or oblique reflection-based systems, as being not suitable to implement the speckle-based imaging technique of the presently disclosed subject matter.

Considering the use of the Differential Interference Contrast (DIC) microscopy and/or confocal microscopy imaging, the presently disclosed subject matter provides image data analysis enabling detection of, respectively, intracellular large particles and cell's diameter indicative of the cell condition. To this end, the characteristic parameters that are extracted from the image data include such time-dependent parameters as object position and trajectory of movement. The image data obtained using Total Internal Reflection Fluorescence (TIRF) based imaging technique can also be analyzed to determine temporal fluctuations of the intensities of specific pixels along the sequence of images, although requiring use of staining markers (fluorescent) into the sample.

For in-vivo sample examination, the above-described speckle-based technique is preferable.

Detection of the speckle patterns can be optimized by selection of proper image magnification and the pixel size of the detector. The so-optimized detection of the speckle patterns actually improves the spatial resolution of the cell surface fluctuating area in the image being detected, thus providing the highly sensitive detection of the vibrations of the malignant cells surface (as compared to healthy sample's cells).

Implementation of the imaging technique of the presently disclosed subject matter in a medical scope-type device advantageously provides high-quality inspection of external facing tissues such as the skin, cavity-containing organs such as bladder, colon, stomach, lung, larynx, uterus, vagina, the intestine, etc. It should be understood that such cavity-containing organs can be emptied or cleaned from their original contents before the medical test and then filled with air or gas as needed during the endoscopic test so that the optical medium is air-tumor media. This allows to identify areas/regions that are suspected of malignancy, including evaluation of the borders of those tumors where healthy tissue continues (clean margins). The possibility to locate the “clean” borders of tumor is even more important in cases of small tumors, thus providing the biopsy procedure to be performed in an accurate way for the complete resection of the tumor in a minimally invasive procedure.

It should be noted that such an imaging system may utilize the elements of a typical scope-type medical device whose optical head is modified according to the presently disclosed subject matter such that it is configured as normal incidence and detection optical unit operable in coherent light focal imaging mode to thereby enable said scope-type device to acquire images of the surface carrying reflective speckle patterns varying over time. This enables the medical device to be relatively simple, portable and light. For skin monitoring purposes, a Dermoscope can be used modified as described above.

Thus, according to one broad aspect of the presently disclosed subject matter, it provides an inspection system comprising an analyzer configured as a computer system configured and operable for data communication with an image data provider to receive image data comprising a sequence of image data pieces corresponding to a sequence of acquisitions of measurement regions of a cell-containing sample being inspected collected using a pixelated detector, said computer system comprising a data processor configured and operable for processing and analyzing the image data to identify dynamics in the image data indicative of vibrational motion of cells in the sample, and generating data indicative of one or more abnormality associated parameters of cells in the sample being inspected, said processing and analyzing comprising:
determining data indicative of a distribution of mechanical properties within the measurement regions located within a surface region of the cell-containing sample, by carrying out the following:
determining at least one of the following: (i) determining Discrete Fourier Transform (DFT) of data corresponding to said image data and generating DFT representation of said image data indicative of temporal position changes of cellular constituents, and (ii) for each of one or more pairs of images from said sequence of images, determining data indicative of a Pearson correlation coefficient, R, between images of the pair; and
extracting, from at least one of said DFT representation and said data indicative of the Pearson correlation coefficient, R, at least one abnormality associated parameter of the cells in the sample being inspected.

It should be understood that the “cell-containing sample” may be individual cells in cultures, liquid samples (blood, urine, milk, sperm, cerebrospinal fluid, lavage fluid), organoids, as well as in vivo samples that are inspected.

It should be noted that abnormality in the cells to be detected may be associated with any disease in the cells, such as inflammation, infection, hypoxia, metabolic abnormality, etc.

More specifically, the technique of the present disclosure is useful for malignancy detection, and is therefore exemplified below with respect to this specific application. However, it should be understood that the principles of the present disclosure are not limited to this specific application.

It should also be noted that “abnormality” associated parameter(s) is at times referred to as “tumor-related parameters”, but this term should be interpreted broadly as explained above.

Preferably, the image data pieces correspond to the acquisitions performed using speckle-based imaging using normal incidence of coherent illumination focused on the surface region of the cell-containing sample and detection of specular reflection from said surface.

The data indicative of the Pearson correlation coefficient, R, between images of the pair may comprise at least one of the following: the Pearson correlation coefficient, R; spectral variation of the Pearson correlation coefficient, R; and a coefficient of variance, CV, corresponding to temporal variation of the Pearson correlation coefficient, R.

The images of the pair may be sequential images; or may be timely spaced by one or more images of said sequence of images.

In some embodiments, said determining of the data indicative of the distribution of mechanical properties within the measurement regions further comprises determining autocorrelation values of the image data indicative of a degree of arbitrariness of position changes of cellular constituents.

The one or more abnormality (tumor) associated parameters comprise one or more parameters of malignant cells comprising: existence of malignant cells in the sample; grading of the malignancy of the cells (cells prone to metastasis have “softer” cell surface and accordingly higher amplitudes of cell surface vertical fluctuations and this can be measured); location of the cells thus giving the borders of the tumor region.

The image data may comprise images acquired by DIC microscope and/or confocal microscope and/or TIRF imaging system.

Additionally, or alternatively, the image data may be indicative of image acquisitions performed by a speckle-based imaging technique of the present disclosure, enabling to obtain image data comprising the sequence of images of the cell-containing sample with speckle patterns superimposed with said images, variation of said speckle patterns along said sequence of images being indicative of the vibrational motion of the cells' surface.

According to another broad aspect of the presently disclosed subject matter, it provides an inspection system for detecting malignant cells in a cell-containing sample, the system comprising: an imaging system configured and operable to perform an imaging session including acquisition of a sequence of images of the sample utilizing a pixelated detector and generating corresponding image data; and the above-described control system in data communication with said imaging system, the control system being configured and operable to process and analyze the image data to identify predetermined dynamics in the image data indicative of vibrational motion of cells' surface enabling to determine one or more abnormality associated parameters of cells in the sample.

The one or more abnormalities related parameters may comprise parameter(s) indicative of location of a sample region containing the malignant cells.

The imaging system may include any one or more of the following: DIC microscope and/or confocal microscope and/or TIRF imaging system and/or speckle-based imaging of the presently disclosed subject matter.

Preferably, however, the imaging system is the speckle-based imaging system of the present disclosure, thereby enabling the imaging system configuration as/incorporation in a probe unit of a medical device suitable for in vivo tissue inspection. Such imaging system is configured and operable to perform speckle-based imaging sessions, wherein each image acquisition includes illuminating the sample with coherent light being focused on a surface of said sample and detecting light returned from the illuminated surface of the sample by the pixelated detector located in an image plane of said surface. The image data comprises the sequence of images of said sample with speckle patterns superimposed with said images, variation of said speckle patterns along said sequence of images being indicative of the vibrational motion of the cells' surface.

Such speckle-based imaging system is preferably configured to define illumination and light collection channels substantially perpendicular to the sample's surface.

According to yet further broad aspect of the presently disclosed subject matter, it provides an inspection system for determining one or more abnormality associated parameters of a cell-containing sample, the system comprising: an imaging system configured and operable to perform an imaging session including a sequence of acquisitions on the cell-containing sample utilizing normal incidence mode, using focusing of coherent illumination on a surface region of the cell-containing sample, detection with a pixelated detector of specular reflections of the illumination from the surface region of the cell-containing sample and generation of image data in the form of a corresponding sequence of speckled images, and an analyzer system in data communication with said imaging system, the analyzer system being configured and operable to process and analyze the image data to identify predetermined dynamics in the image data indicative of vibrational motion of cells' surface enabling determination of said one or more abnormality associated parameters.

According to yet another broad aspect of the presently disclosed subject matter, there is provided a medical device comprising: a probe unit comprising an imaging system adapted to perform a sequence of image acquisitions of a cell-containing sample during an imaging session and provide corresponding image data, and a control unit for receiving and processing the image data to generate data indicative of malignant cells in said sample, wherein: said imaging system is configured and operable to perform speckle-based image acquisitions, the image data therefore comprising images of the sample's surface superimposed with speckle patterns, and is therefore indicative of vibrational motion of cells' surface in the sample, enabling the processing of the image data to determine one or more abnormality associated parameters (e.g., location of a sample region containing malignant cells).

According to yet further aspect of the present disclosure, it provides a method for use in inspection of a cell-containing sample, the method comprising:
providing image data comprising a sequence of image data pieces corresponding to a sequence of acquisitions of measurement regions within a surface region of the cell-containing sample performed using speckle-based focused imaging with normal incidence of coherent illumination focused on the surface region of the cell-containing sample and detection of specular reflection from the surface region by a pixelated detector,
processing the image data to determine data indicative of distribution of mechanical properties within the measurement regions, said processing comprising:
carrying out at least one of the following: (i) determining Discrete Fourier Transform (DFT) of data corresponding to said image data and generating DFT representation thereof indicative of temporal position changes of intracellular constituents, and (ii) for each pair of image data pieces, determining data indicative of a Pearson correlation coefficient, R, between images of the pair; and
extracting, from at least one of said DFT representation and said data indicative of the Pearson correlation coefficient, R, at least one abnormality associated parameter of the cells in the sample being inspected, thereby identifying predetermined dynamics in the image data indicative of vibrational motion of cells in the sample.

The cell-containing sample is selected from the following: cell culture, liquid live cell-containing sample; live tissue area, organoids. The liquid cell-containing sample comprises at least one of the following: blood, plasma, urine, Cerebral spinal fluid, lavage fluid.

The technique of the present disclosure can be used to test a cell-containing sample in-vitro, ex vivo, or in-vivo in-situ, i.e., meaning directly on the patient on the living tissue in the pathology area and it is aimed at live tissue. Therefore, the term “cell-containing sample” should be interpreted broadly to cover both live tissue or live cell-containing sample out or in the body of the subject.

The test can be performed on a relatively small region of interest, i.e., of a size (diameter) of about 80 microns and therefore can characterize a tumor spatially including its borders.

The test provides for differentiating between malignant tumors and benign tumors that are in their differential diagnosis. Hence, the technique of the present disclosure is capable of identifying and analyzing malignant tumors from among all tumors that also include benign tumors. Additionally, the test enables certain classification of benign lesions as well.

Since it is known that the mechanical properties of aggressive cancerous tumor cells are different relative to cancerous tumors of the same type that are less aggressive, the inspection technique of the present disclosure is also sensitive to a certain extent to the aggressiveness of the tumor in order to provide better prognosis. Hence, in addition to its ability to diagnose whether it is malignant or not, the technique of the present disclosure provides certain indication regarding additional clinical parameters of the cancerous tumor.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

In order to better understand the subject matter that is disclosed herein and to exemplify how it may be carried out in practice, embodiments will now be described, by way of non-limiting examples only, with reference to the accompanying drawings, in which:

FIG. 1A is a block diagram of an example of an inspection system of the present disclosure for inspecting a cell-containing sample to determine one or more tumor associated parameters (e.g., detection of malignant cells in the tissue), which may be used for either one or both of in vivo and in vitro inspection;

FIG. 1B schematically illustrates the configuration of an exemplary inspection system of the present disclosure suitable to be incorporated in/used with a scope-type medical device for in vivo tissue inspection;

FIG. 1C schematically illustrates the configuration of another exemplary inspection system of the present disclosure suitable to be incorporated in/used with a scope-type medical device for in vivo tissue inspection;

FIG. 2A exemplifies a flow diagram of the operational principles of the inspection technique of the presently disclosed subject matter that may be implemented by the inspection system generally similar to that of FIG. 1A being configured for utilizing one or more of the imaging techniques of different types;

FIG. 2B exemplifies a flow diagram of the tumor cells/tumor region identification/definition based on parameters extracted from the image data analysis;

FIGS. 3A-3G more specifically exemplify the implementation of the technique of the presently disclosed subject matter using speckle-based imaging technique generally similar to that of FIG. 1B or FIG. 1C, wherein FIG. 3A shows the main steps of the image data analysis applied to image data obtained by the scope-type medical device, FIGS. 3B-3E illustrate the important and advantageous features of the normal incidence/detection optical scheme utilized in the imaging system of FIGS. 1B (and 3A) for the purposes of the presently disclosed subject matter, and FIGS. 3F-3G illustrate a flow diagram of the image acquisition and image data analysis of the speckle-based inspection technique;

FIGS. 4a-4c demonstrate the analysis of intracellular particle motion embedded inside the cytoskeletal mesh, wherein FIG. 4a defines intracellular particle motion in x and y dimensions; FIG. 4b demonstrates the particle's position change in time in one dimension; and FIG. 4c shows the Discrete Fourier Transform (DFT) of the particle's position serial results (as shown in FIG. 4b);

FIGS. 5a-5f show simulations results of intracellular particles' movements, wherein FIG. 5a shows DFT of a simulated particle's position change in time when the probability density functions (PDF) of translocations are Gaussian and the SD of translocations is 0.05 μm. Power fit parameters of the DFT results are added; FIG. 5b is the same as FIG. 5a except that the SD of translocations is 0.1 μm; FIG. 5c is the same as FIG. 5a except that the SD of translocations is 0.15 μm; FIG. 5d is the same as FIG. 5a except that the SD of translocations is 0.2 μm. 50 simulations were performed for each condition described in FIGS. 5a-5d; FIG. 5e shows the correlation between the SD of translocations and the a parameter of the power fit results (y=axb) in each condition of SD. FIG. 5f shows the correlation between the SD's of translocations and the sum of squared errors (SSE) of the power fit in each condition of SD. Error bars in FIGS. 5a-5d are SEM (Standard Error of Mean);

FIGS. 6a-6e show imaging cell dynamics using DIC, wherein FIG. 6a shows DIC image of a representative live Jurkat cell; FIG. 6b shows image FIG. 6a after thresholding for object tracking; FIG. 6c shows an example of an individual tracked object; FIG. 6d shows trajectories of an intracellular particle in an untreated cell (100 steps); and FIG. 6e shows trajectories of an intracellular particle in an ATP-depleted cell (100 steps);

FIGS. 7a-7f show Differential Interference Contrast (DIC) microscopy results of intracellular particles motion in live cells before and after adenosine triphosphate (ATP) depletion analyzed by amplitude spectral density (ASD) and power spectral density (PSD); wherein FIG. 7a shows ASD analysis results in (n=29) cells before (blue line) and after (red line) ATP depletion and the corresponding power fit parameters;

FIGS. 7b-7e show various fit parameters for the ASD analysis results in the cells [in FIG. 7a] before and after ATP depletion; wherein FIG. 7b shows power fit parameter a; FIG. 7c shows power fit parameter b; FIG. 7d shows power fit parameter a·b; FIG. 7e shows power fit parameter SSE FIG. 7f shows Power fit parameter “Sum of powers” for the PSD analysis results in the cells [in FIG. 7a] before and after ATP depletion. Error bars in panels (7A-7F) are SEM;

FIGS. 8a-8h show correlation of amplitude spectral density (ASD)/power spectral density (PSD) parameters and mean square displacement (MSD) parameters in live cells before and after adenosine triphosphate (ATP) depletion, wherein FIG. 8a shows the correlation between the a parameter of ASD analysis and \sqrt{K_{α}} of MSD analysis in ATP-depleted cells. Analyses relate to DIC microscopy results of intracellular particles motion of shown in FIGS. 7a-7f (n=29). FIG. 8b shows the correlation between the a parameter of ASD analysis and \sqrt{K_{α}} of MSD analysis in cells before ATP depletion. FIG. 8c shows the correlation between the b parameter of ASD analysis and α of MSD analysis in ATP depleted cells. FIG. 8d shows the correlation between the b parameter of ASD analysis and α of MSD analysis in cells before ATP depletion. FIG. 8e shows the correlation between the SSE parameter of ASD analysis and SSE of power fit to MSD analysis in ATP depleted cells. FIG. 8f shows the correlation between the SSE parameter of ASD analysis and the sum of squared errors (SSE) of power fit to MSD analysis in cells before ATP depletion. FIG. 8g shows the correlation between “Sum of powers” parameter of PSD analysis and sum of MSD's parameter (from MSD analysis) in ATP depleted cells. FIG. 8h shows the correlation between “Sum of powers” parameter of PSD analysis and sum of MSD's parameter (from MSD analysis) in cells before ATP depletion. R- and P-values of significant correlations are presented in the corresponding correlations images;

FIG. 9 compares the discrimination power of power spectral density (PSD)/amplitude spectral density (ASD) vs. mean square displacement (MSD) analyses for intracellular mechanical work. T-statistics values for the difference between cells before ATP depletion and the same cells after ATP depletion according to the two groups of parameters. The t-statistics value for the ergodic test is also presented;

FIGS. 10a-10c show live cells measurements of cell diameter fluctuations, wherein FIG. 10a shows a scheme of the cell showing mechanical relations of its constituents. The possible mechanical relation between intracellular cytoskeleton fluctuations and the fluctuations of cytoskeleton borders or the cortical actin; FIG. 10b shows confocal imaging of a live Jurkat cells, stained with CD45; and FIG. 10c shows a kymograph showing fast (2 ms) and repetitive line-scans across the cell membrane at its apparent mid-section, as shown in FIG. 10b;

FIGS. 11a-11e show amplitude spectral density (ASD) and power spectral density (PSD) analysis results of live cells diameter fluctuations before and after adenosine triphosphate (ATP) depletion, wherein FIG. 11a shows average ASD analysis results in cells before (blue line) and after (red line) ATP depletion. Control average ASD results of 20 fixed cells are also presented (green line). Specific ranges of frequencies according to their dominant mechanism of fluctuations are highlighted. N=14 cells; FIG. 11b zooms on ASD results in the frequencies range of 0-3 Hz out of the total frequencies range presented in FIG. 11a (R values for the power fit to the ASD results are also presented); FIG. 11c shows average power fit parameter a·b results of the ASD analysis presented in FIG. 11b before and after ATP depletion; FIG. 11d shows average power fit parameter sum of squared errors (SSE) results of the ASD analysis presented in FIG. 11b before and after ATP depletion; and FIG. 11e shows average power fit parameter “Sum of powers” results of the PSD analysis before and after ATP depletion (Error bars in FIGS. 11b-11e are SEM);

FIGS. 12a-12d show amplitude spectral density (ASD) results in high frequencies (>50 Hz), wherein FIG. 12a shows average ASD results in normal non-treated cells (N=14), adenosine triphosphate (ATP) depleted cells (N=14) and dead fixed cells (N=20). FIGS. 12b-12d show average ASD results in the frequencies range between 50 and 200 Hz in normal non-treated cells (FIG. 12b), ATP depleted cells (FIG. 12c), and fixed dead cells (FIG. 12d). Error bars in FIGS. 12b-12d are SEM;

FIGS. 13a-13c show average autocorrelation results of Amplitude Spectral Density (ASD) analysis, wherein FIG. 13a shows average autocorrelation results of ASD in normal non-treated cells (N=14), adenosine triphosphate (ATP) depleted cells (N=14) and dead fixed cells (N=20) in the frequencies range between 50 and 100 Hz. Results relate to the spectral data in FIGS. 12a-d. On the right the average autocorrelation values of 1-5 lags in each cellular condition with their SD of mean are presented; FIG. 13b shows average autocorrelation results of ASD in the normal non-treated cells, ATP depleted cells and dead fixed cells in the frequencies range between 100 and 150 Hz. On the right the average autocorrelation values of 1-5 lags in each cellular condition with their SD of mean are presented; and FIG. 13c shows average autocorrelation results of ASD in the normal non-treated cells, ATP depleted cells and dead fixed cells in the frequencies range between 150 and 200 Hz. On the right the average autocorrelation values of 1-5 lags in each cellular condition with their SD of mean are presented;

FIGS. 14a-14f show fluctuations of Jurkat cell membrane in a model of the immune synapse imaged by TIRF microscopy, wherein FIG. 14a shows DFT results of fluctuations of normalized intensity of anti-CD45 antibodies labeled with Alexa647, which highlighted the plasma membrane of Jurkat cells. The cells adhered to coverslips coated with anti-CD3ε. Amplitudes of normal cells (N=30) are in blue, adenosine triphosphate (ATP) depleted cells (N=33) are in red and fixed cells (N=24) are in green; FIG. 14b shows frequency range of 0-3 Hz of the amplitudes in (FIG. 14a); FIGS. 14c-14f show power fit parameters obtained from the results of the amplitudes presented in FIG. 14b: a (FIG. 14c), b (FIG. 14d), sum of squared errors (SSE) (FIG. 14e), and Sum of powers (FIG. 14f); Error bars FIGS. 14a-14f are SEM;

FIGS. 15a-15f show DIC microscopy results of intracellular particles motion in live cells before and after 10 μM blebbistatin treatment analyzed by ASD and PSD, wherein FIG. 15a shows ASD analysis results in (N=30) cells before (blue line) and after (red line) blebbistatin treatment and the corresponding power fit parameters. FIGS. 15b-15e show power fit parameters for the ASD analysis results in the cells (shown in FIG. 15a) before and after blebbistatin treatment: a (FIG. 15b), b (FIG. 15c), a-b (FIG. 15d) and SSE (FIG. 15e); and FIG. 15f shows power fit parameter ‘Sum of powers’ for the PSD analysis results in the cells (shown in FIG. 15a) before and after blebbistatin treatment. Error bars in FIGS. 15b-15f are SEM;

FIG. 16a-d show fluctuations of the cell membrane of primary lymphocytes (benign), CD8 (malignant) and Jurkat (malignant) cells in a model of the immune synapse imaged by TIRF microscopy, wherein FIG. 16a shows DFT results of fluctuations of normalized intensity of anti-CD45 antibodies labeled with Alexa647, which highlighted the plasma membrane of cells. The cells adhered to coverslips coated with αCD3ε antibodies. Amplitudes of primary lymphocytes (N=192) are in blue, CD8 cells (N=165) are in green and Jurkat cells (N=237) are in red, shown is frequency range of 0-5 Hz. FIG. 16b shows frequency range of 10-25 Hz of the amplitudes in FIG. 16a. FIGS. 16c-16d show average amplitudes results for the primary lymphocytes, CD8 and Jurkat cells in two frequency ranges: 0-5 Hz and 10-25 Hz before and after Mibefradil treatment.

FIGS. 17a and 17b schematically show possible effects of cell membrane fluctuations on T cell function, wherein FIG. 17a illustrates an immune synapse between an effector T cell with its specific TCR and a benign target cell with a complimentary pMHC. FIG. 17b shows a similar illustration of an immune synapse between effector T cell and a malignant target cell that has increased cell membrane vibrations.

FIGS. 18a-e show experimental procedure for the preparation of an in-vitro model for cell surface of malignant and benign cells, wherein FIG. 18a shows the laboratory tube with the sediment of cells and above the cellular medium, FIG. 18b shows the laboratory tube after the removal of the cellular medium, FIG. 18c shows cutting and removing the upper part of the tube to leave only its lower part that contains the sediment of cells, FIGS. 18d-e show putting the lower part of the tube on the microscope stage to directly illuminate and analyze the cells surface.

FIG. 19A exemplifies a focused speckled-containing image of aggregation of cells, obtained with the system of FIG. 1B or 3A.

FIGS. 19B-19E show results of dynamic reflective laser speckled imaging of cells before and after the augmentation of cell surface vibrations using mibefradil, wherein FIG. 19B shows DFT results of fluctuations of normalized speckles' intensities (showing amplitudes of normal cells (N=19), and cells after treatment with mibefradil (N=14)), FIGS. 19C-19D show power fit parameters for the ASD analysis results in the cells (shown in FIG. 19B) before and after mibefradil treatment: parameter b (FIG. 19C) and sum of amplitudes in the 0-5 Hz range (FIG. 19D), and FIG. 19E shows sum of amplitudes in the 0-5 Hz range of individual cell areas (14) before and after mibefradil treatment (possible threshold allowing classification of cells is marked by a black horizontal line).

FIGS. 19F-19K show maps of amplitudes of cell surface fluctuations obtained from dynamic reflective laser speckled image analysis before and after augmentation of cell membrane vibrations using mibefradil, wherein FIGS. 19F, 19H, 19J show results of normal cells, and FIGS. 19G, 19I, 19K show results of cells after treatment with mibefradil (Color thresholding was guided by the results shown in FIG. 19E).

FIGS. 20A-20D show results of dynamic reflective laser speckled imaging of normal primary lymph cells and Jurkat malignant cells, wherein FIG. 20A shows DFT results of fluctuations of normalized speckles' intensities. Amplitudes of primary lymph cells (N=22) are in blue, Jurkat malignant cells (N=16) are in red. FIGS. 20B-20C show power fit parameters for the ASD analysis shown in FIG. 20A: parameter b (FIG. 20B), bar graph of average amplitudes in the 0-2 Hz range (FIG. 20C); and FIG. 20D shows comparison of average amplitudes in the 0-2 Hz range of individual areas of primary lymph and Jurkat malignant cells (Dashed horizontal line in black marks a possible threshold allowing classification of malignant cells with ~100% accuracy);

FIGS. 21a-h illustrate the experimental results of vibrations in cell sediments of malignant vs. matched benign (primary) cells. FIGS. 21a, 21c, 21e, and 21g show amplitude spectrum of light intensity fluctuations for primary cells (lung N=32 (FIG. 21a), prostate N=36 (FIG. 21c), bladder N=32 (FIG. 21e) and melanocytes N=40 (FIG. 21g)) vs. their corresponding malignant cells (lung N=26, prostate N=44, bladder N=39 and melanoma N=38 cancers); FIGS. 21b, 21d, 21f, and 21h show the respective averaged amplitudes, compared between the benign and malignant cells in FIGS. 21a, 21c, 21e, and 21g;

FIGS. 22a-d illustrate the experimental results of Pearson's R values in cell sediments of malignant vs. matched benign (primary) cells, wherein FIG. 22a shows R values in primary lung cells in comparison to malignant lung cells (N=32 for primary lung, N=26 for lung cancer); FIG. 22b shows R values in primary prostate cells in comparison to malignant prostate cells (N=39 for primary prostate, N=38 for prostate cancer); FIG. 22c shows R values in primary bladder cells in comparison to malignant TCC cells (N=35 for primary bladder, N=39 for TCC); and FIG. 22d shows R values in primary melanocytes cells in comparison to malignant melanoma cells (N=40 for primary melanocytes, N=49 for malignant melanoma cells);

FIGS. 23A-I illustrate the Autocorrelation values and decay in cell sediments of malignant vs. matched benign cells, wherein FIGS. 23A, 23D, 23G, and 23J show the autocorrelation of light fluctuations for primary cells (lung N=32 (FIG. 23A), prostate N=36 (FIG. 23D), bladder N=32 (FIG. 23G) and melanocytes N=40 (FIG. 23J)) vs. their corresponding malignant cells (lung N=26, prostate N=44, bladder N=39 and melanoma N=38 cancers); FIGS. 23B, 23E, 23H, and 23K show the autocorrelation slope and FIGS. 23C, 23F, 23I, and 23L show the autocorrelation maximum, compared, respectively, between the benign and malignant cells in FIGS. 23B, 23E, 23H, and 23K;

FIGS. 24a-b illustrate the experimental results, in the form of the normalized delta from primary cells regression of R CV parameter results in malignant versus match benign cells tissues model, demonstrating the use of CV(R) parameter to differentiate measurements areas (50×50 pixels) of Transitional Cell Carcinoma (TCC) and melanoma cell surfaces from measurements areas of their matched primary benign cells (Primary epithelial bladder cells, and primary epidermal melanocytes) with accuracies of 97.5% and 93%, respectively, wherein FIG. 24a shows the Normalized delta from primary cells regression of R CV parameter results in Transitions cell carcinoma (TCC) cells (N=34) and primary bladder epithelial cells (N=41), and FIG. 24b shows the Normalized delta from primary cells regression of R CV parameter results in malignant melanoma cells (N=62) and primary epidermal melanocyte cells (N=23);

FIGS. 25a-b illustrate similar experimental results, in the form of normalized delta from primary cells regression of R CV parameter results in malignant versus match benign cells tissues model for malignant lung carcinoma cells, malignant prostate carcinoma cells and their matched benign primary epithelial cells, wherein FIG. 25a shows the Normalized delta from primary cells regression of R CV parameter results in prostate carcinoma cells (N=20) and primary prostate epithelial cells (N=8), and FIG. 25b shows the Normalized delta from primary cells regression of R CV parameter results in malignant lung carcinoma cells (N=37) and primary lung epithelial cells (N=14);

FIG. 26a illustrates schematically a portable prototype system of the present disclosure for the investigation of living tissues using perpendicular laser speckles analysis, and FIG. 26b is a photo of the system;

FIGS. 27a-f illustrate the use of the system of FIG. 26 for perpendicular laser speckles analysis for in vivo investigation of skin lesions: a verruca (N=12) and a scar (N=11) in comparison to neighboring normal skin (N=12), showing: FIG. 27a shows DFT results in the frequency range <10 Hz in verruca, scar and normal skin, average amplitudes in the frequency range <3 Hz for each condition are shown in FIG. 27d;

FIG. 27b shows the average R parameter results for different time lags in each skin condition, the average R parameter results for the first time lag in each skin condition are shown in FIG. 27e; and FIG. 27c shows the average results of the standard deviation of the temporal fluctuation of the R parameter for different time lags in each skin condition, the average results of the standard deviation of the temporal fluctuation of the R parameter for the first time lag in each skin condition are shown in FIG. 27f;

FIGS. 28a-c demonstrate the use of the prototype system for perpendicular laser speckles analysis for in vivo investigation of multiple skin lesions in a group of volunteers (N=5): hemangiomas (N=3), Dermatofibromas (N=2) nevuses (N=4), verrucas (N=3) and scars (N=2), wherein FIG. 28a shows average DFT results of pixels intensities temporal fluctuations for each type of skin lesion, FIG. 28b shows the average DFT amplitudes in the group of hyper-vibrating skin lesion (hemangiomas and dermatofibromas) in comparison to the average amplitudes in the group of hypo-vibrating skin lesion (nevuses, verrucas and scars), and FIG. 28c shows the accuracy of differentiating between hyper and hypo-vibrating skin lesions using a single measurement of 3 sec duration;

FIGS. 29a-d demonstrate the accuracy of differentiating each of the 5 types of measured skin lesions: hemangiomas, dermatofibromas, nevuses, verrucas and scars utilizing a single 3 sec duration measurement, wherein FIG. 29a shows the accuracy of differentiating the hyper-vibrating lesions: hemangiomas from dermatofibromas and FIGS. 29b-d show the accuracy of differentiating each of the hypo-vibrating lesions: nevuses (FIG. 29b), verrucas (FIG. 29c) and scars (FIG. 29d);

FIG. 30 illustrates the 10 mice of the subcutaneous implanted malignancy model: The implanted sub-cutaneous lung cancer lesions are visible on the right flank of each mouse;

FIGS. 31a-b illustrate mice subcutaneous implanted malignancy model results (N=10), wherein FIG. 31a shows average DFT results of temporal fluctuations in pixels intensities in the malignant tumor measured areas in comparison to those results in the adjacent normal areas, and FIG. 31b shows the ratio of malignant area DFT results and adjacent normal area DFT results in 333 msec T (time period) in each mouse; and

FIG. 32 summarizes the results in Mice subcutaneous implanted malignancy and in human volunteers.

### DETAILED DESCRIPTION OF EMBODIMENTS

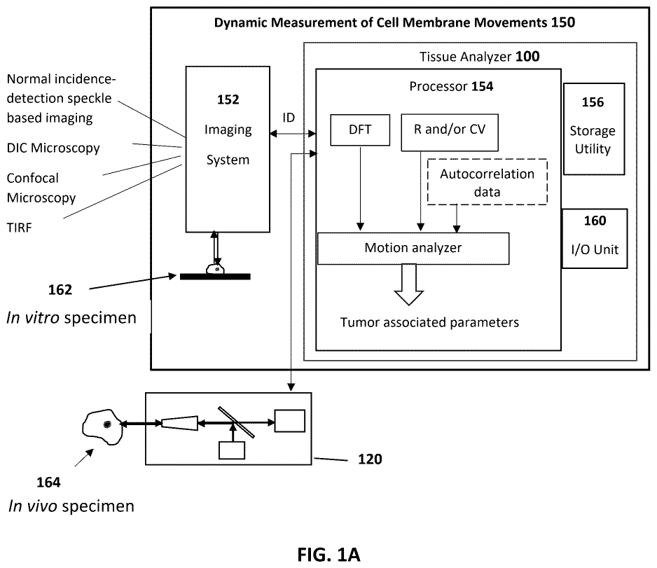

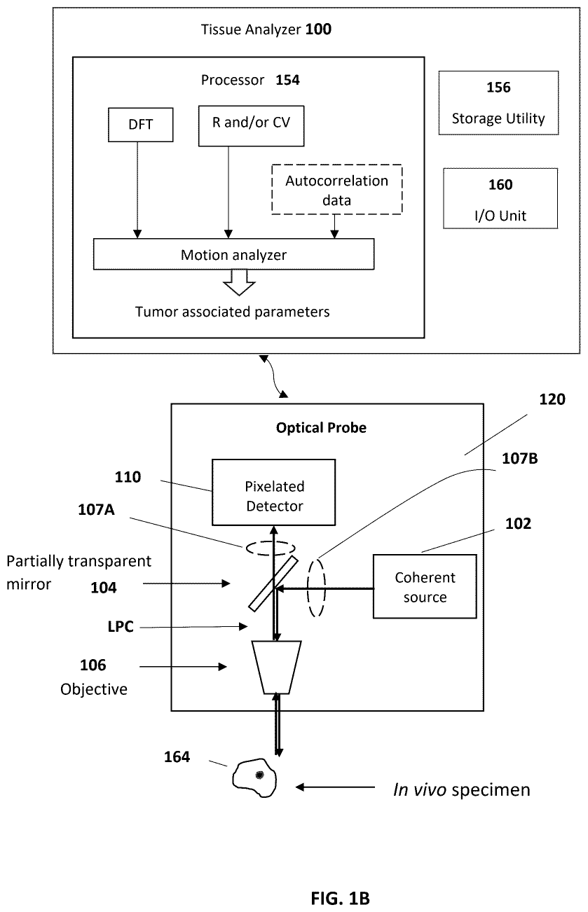

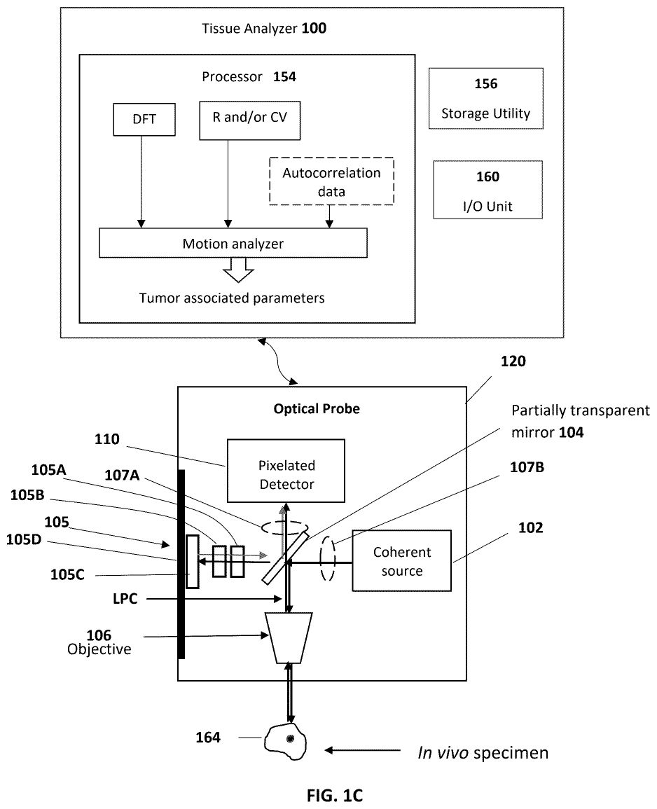

Referring to FIG. 1A, there is illustrated, by way of a block diagram, an inspection system 150 according to some embodiments of the present disclosure for inspecting a cell-containing sample to determine one or more abnormality (tumor) associated parameters, e.g., detecting malignant cells in the sample. In the description below, the “cell-containing sample” is at times referred to as “tissue”.

The inspection system 150 includes a control system which operates as a tissue analyzer system 100 configured for data communication (via wires or wireless communication of any known suitable type) with an image data provider. The latter may be an imaging system 152 acquiring the image data, or an external storage device in which image data generated by imaging system is stored.

The image data ID being provided includes a sequence of images acquired from the tissue. The tissue analyzer system 100 includes/is configured as a computer system including inter alia such main functional utilities as input/output utility 160, storage utility 156, and data processor 154. The data processor 154 is configured and operable to process and analyze the image data to identify predetermined dynamics in the image data indicative of vibrational motion of cells' surfaces (caused by vibrational motion of cell's membranes and/or that of intracellular particles), and generate data indicative of location of a tissue region containing the malignant cells. More specifically, the data processor 154 is configured and operable to determine data indicative of a distribution of mechanical properties within the measurement regions of the cell-containing sample. To this end, the processor operates to determine (i) Discrete Fourier Transform (DFT) of data corresponding to the input image data ID and generate DFT representation thereof which is indicative of temporal position changes of cellular constituents, and/or (ii) determine, for each of one or more pairs of images from said sequence of images, data indicative of a Pearson correlation coefficient, R, between images of the pair; and extract, from said DFT representation and/or said data indicative of the Pearson correlation coefficient, R, at least one tumor associated parameter of the cells in the sample being inspected.

As will be exemplified further below, the data indicative of the Pearson correlation coefficient, R, between images of the pair may include the Pearson correlation coefficient, R itself, and/or a coefficient of variance, CV, corresponding to temporal variation of the Pearson correlation coefficient, R. The paired images may include sequential (adjacent in time) images, and/or images timely spaced by one or more images of said sequence of images. For the case that paired images (images of the pair) are timely spaced by one or more images of the sequence of images, i.e., the paired images have different time lags between them, analysis of Pearson correlation coefficient, R, at those different time lags is indicative of the spectral behavior of the Pearson correlation coefficient, R, and thereby is indicative of the existing vibrations within the measurement region.

The determining of the data indicative of the distribution of mechanical properties within the measurement regions may further include determination of autocorrelation values of the image data indicative of a degree of arbitrariness of position changes of cellular constituents.

The imaging system 152 may include DIC microscope and/or confocal microscope and/or TIRF imaging system capable of performing the imaging session(s) on an in vitro specimen 162. Alternatively, or additionally, the imaging system may include a speckle-based system 120, which is capable of performing imaging session(s) on in vitro specimen 162 or in vivo specimen 164. The configuration and operation of the imaging system 120 is described below.

As will be described more specifically further below, the image data pieces being processed preferably correspond to the acquisitions performed using speckle-based focused imaging with normal incidence bright field mode, i.e., incident light propagation axis and axis of propagation of the specularly reflected light being collected are substantially perpendicular to the sample's surface. It should be noted that such “substantial perpendicularity” condition may not be exactly 90 degrees between these axes and the sample's surface but within certain tolerance of up to ±few degrees (e.g., up to ±5 degrees).

It should be understood that the imaging system 152 and the analyzer system 100 may be integral in a common inspection system. In some other embodiments, the analyzer system 100, or parts thereof (e.g. cell surface/intracellular particle motion analyzer) may be located at a remote station (cloud computer). For example, such remote station is configured for data communication with multiple imaging systems via a communication network to thereby use and optimize machine learning techniques and neural networks for properly apply various model based processing enabling extraction of various parameters of tissues describing/characterizing various malignant cells' mechanical conditions in contrast to physiologically normal cells.

Reference is made to FIG. 1B illustrating schematically an exemplary speckle-based imaging system 120 of the presently disclosed subject matter. As exemplified in the figure, the imaging system is in data communication with the analyzer system 100. However, as described above, such communication might be via an external storage device, the speckle-based imaging system may be incorporated in an optical probe unit of a medical device, which also include at least some of the elements of the analyzer system 100.

The imaging system 120 (optical probe) is adapted (controllably operable) to perform one or more imaging sessions and provide corresponding image data. As described above, for the purposes of the presently disclosed subject matter, the imaging session includes a sequence of image acquisitions.

The imaging system 120 includes a coherent light source 102 and a pixelated detector 110. Each image acquisition includes illumination of the tissue with the coherent light being propagating along a normal incidence light propagation channel LPC and being focused on a surface of the tissue via objective lens unit 106, collection by said objective lens 106 of light reflected from the illuminated tissue towards the light propagation channel LPC and detection of the collected reflected light by the pixelated detector. As shown in the figure, the imaging system may include a partially transparent mirror 104 for reflecting illuminating light towards the incidence light propagation channel LPC and transmitting collected light propagating along said channel towards the detector 110.

The imaging system may also include a converging lens 107A before the detector 110 and a converging lens 107A at the optical way between the coherent light source 102 and the objective lens 106. The first lens 107A is utilized for converging the reflected light onto the pixelated detector 110, and the second lens 107B enables a perpendicular illumination on the tissue surface.

The image data generated during the imaging session is indicative of predetermined dynamics of signals reflected from the surface of the tissue being imaged corresponding to vibrational motion of cells' surface in the tissue. This enables processing of the image data to locate a tissue region containing the malignant cells. More specifically, the image data includes images of the tissue and speckle patterns caused by the movement (vertical vibration) of cells' surface which is detectably different between malignant cells and physiologically normal cells. The processing and analysis of the so-obtained image data will be described more specifically further below.

FIG. 1C illustrates schematically another exemplary speckle-based imaging system of the present disclosure. To facilitate understanding, the same reference numbers are used for identifying components that are common in the examples of the systems of the present disclosure.

The imaging system 120 exemplified in FIG. 1C is configured and operated generally similar to that of the example of FIG. 1B, namely is adapted (is configured and controllably operable) to perform an imaging session (including a sequence of image acquisitions) and provide corresponding image data. The system 120 includes a coherent light source 102 and a pixelated detector 110. Each image acquisition includes illumination of the tissue with the coherent light being propagating along a normal incidence light propagation channel LPC (via a beam splitter 104) and being focused on a surface of the sample via objective lens unit 106, collection by said objective lens 106 of light reflected from the illuminated sample towards the light propagation channel LPC and detection of the collected reflected light by the pixelated detector. In the example of FIG. 1C, the imaging system 120 further includes a phase and intensity modulator mechanism/device 105, which includes an adjustable phase modulator 105A, adjustable intensity modulator 105B, a partially transparent mirror 105C, and possibly also an additional element 105D.

Such additional element can be constituted by a black surface that absorbs radiation and is aimed at preventing, on the one hand, the return of that part of the radiation that was not reflected by the transparent mirror 105C back into the optical path and preventing, on the other hand, the exit of laser radiation from the device other than through the objective 106 and thus ensure that only/mainly the specular reflected light is detected.

The input light from the coherent light source 102 is incident on beam splitter/combiner 104, which reflects part of this light towards the objective 106 to be focused on the surface of the sample being inspected and transmits the other part of input light (constituting a reference beam) towards the phase and intensity modulator unit 105. This reference beam passes through the adjustable phase and intensity modulators 105A and 105B which apply a phase and intensity modulation thereto and allows its propagation towards the partially reflective mirror 105C and reflects the phase and intensity modulated reference beam back to pass through the adjustable phase and intensity modulators 105A and 105B towards the beam splitter/combiner 104 which reflects the phase and intensity modulated reference beam towards the detector 110. The part of the reference beam which is not reflected by the partially reflective mirror 105C will be eradicated by processes of absorbance, or scattering or reflection or combinations of the above by component 105D. Hence, the image data generated by the pixelated detector 110 during the imaging session is indicative of destructive interference effect between the phase and intensity modulated reference beam and the beam reflected from the tissue.

That destructive interference reduces the constant part of intensity of the detected light, while the fluctuating part of the light intensity (due to changing interference at the object plane) is not changed. The results of that are relatively more pronounced pixel's light fluctuations (the constant part of the pixels intensity is reduced but the part of fluctuating intensity is not changed) that improve the signal to noise ratio. Thus, those relatively more pronounced fluctuations of light intensity more efficiently indicate the dynamics of signals reflected from the tissue corresponding to vibrational motion of cells' surface in the tissue. This enables processing of the image data to locate a tissue region containing the malignant cells.

As described above with reference to FIG. 1B, the image data includes images of the tissue and speckle patterns influenced by the movement (vertical vibration) of cells' surface which is detectably different between malignant cells and physiologically normal cells. The processing and analysis of the so-obtained image data will be described more specifically further below.

It should be noted that some other known speckle-based techniques, e.g., Speckle rheological microscopy (SHEAR), are aimed at studying/monitoring the motion dynamics of tissue specimen in the XY plane of the tissue. On the contrary, the technique of the present disclosure is directed to determining data indicative of cells' motion dynamics along the vertical axis (Z axis). Another important difference is that other known techniques, e.g., SHEAR, examine the cells' dynamics in the depth, which means within the tissue sample, whereas the technique of the present disclosure is specifically aimed and configured to monitor/measure the cell's motion dynamics in the surface region of the tissue sample. Accordingly, in the present technique, the objective 104 is configured to focus the coherent laser illumination on the surface of the tissue sample and thereby enable collection/detection of specular reflections from the surface region (using the same objective), rather than focusing laser illumination on deep layers in the tissue as for example used in SHEAR. This important difference highlights the advantageous configuration of the system of the present disclosure which enables in-vivo inspection of a specimen with suspected tumors, while eliminating the need to perform and inspect a biopsy section of the tumor.

The technique of the present disclosure is based on the inventors' understanding that the use of surface region inspection allows for identifying tumorous cells inside the tissue (in depth) because vertical (Z-axis) vibrations of tumorous cells inside the tissue induce Z axis surface vibrations in the surface tissue surrounding the inside tumor. By this, the tumorous cells inside the tissue can be detected by the system of the disclosure, while eliminating the need to perform biopsy of the tumor.

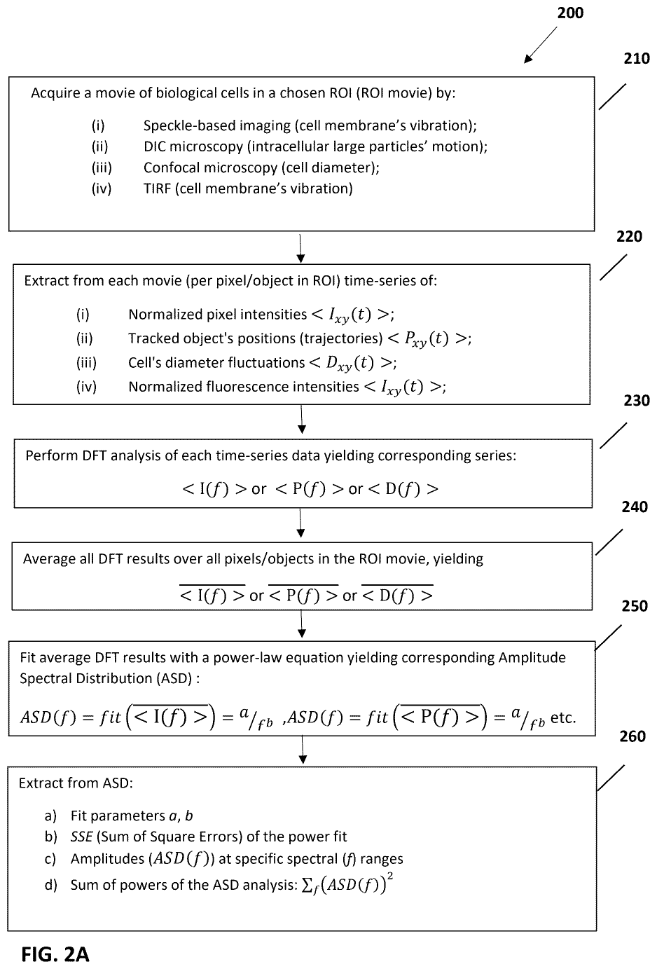

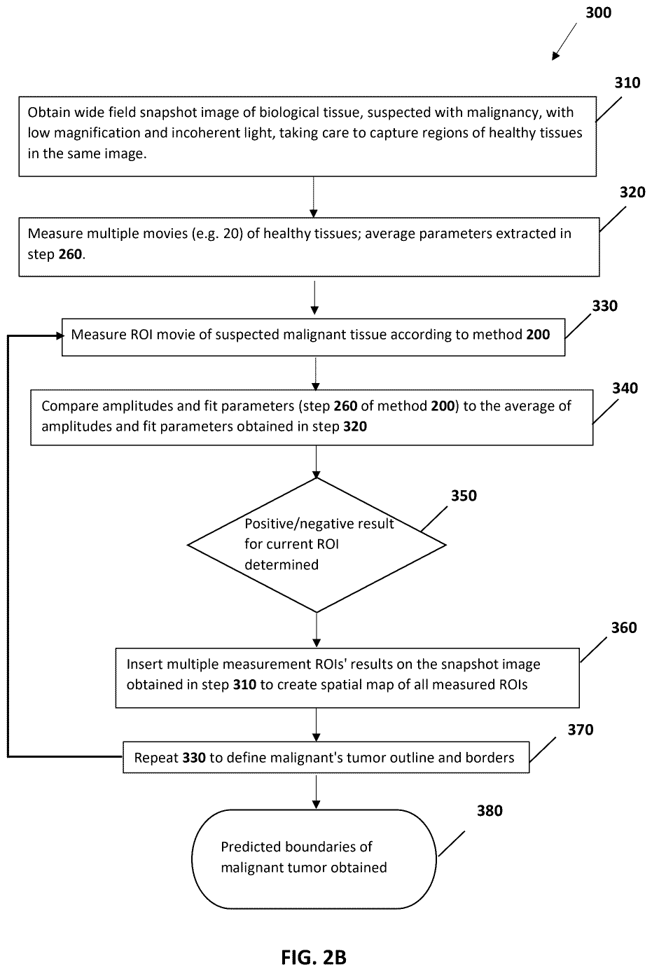

FIG. 2A exemplifies, by way of a flow diagram 200, the operation of the analyzer system 100 of the present disclosure, suitable for analyzing the image data acquired by one or more of the imaging techniques of different types. In this specific not limiting example, the determination of distribution of mechanical properties of the cells utilizes determination of the DFT representation of the image data indicative of temporal position changes of cellular constituents. It should, however, be understood that the principles of the presently disclosed subject matter are not limited to this specific example. The alternative and/or additional approach of determination of the coefficient R and/or coefficient CV, as well as additional determination of autocorrelation function, will be exemplified further below.

As shown in the figure, in step 210, image data of a region of interest (ROI) in the tissue is provided being in the form of a sequence of images (video/movie). This can be done by one or more of the following: (i) using the above-described speckle-based imaging technique of the presently disclosed subject matter, in which case the image data enables extraction therefrom of the vibration of the cell surface (vertical-axis or z-axis vibration); (ii) using DIC microscopy, in which case the image data enables extraction therefrom of intracellular large particles' motion; (iii) confocal microscopy allowing extraction of data indicative of a cell diameter from the corresponding image data; and (iv) TIRF imaging allowing to determine, from the image data, data indicative of cell surface vibration.

The image data is then processed and analyzed. This optionally, but in some embodiments preferably, includes a pre-processing (step 220) which is followed by DFT (steps 230 and 240) and model-based analysis (step 250) allowing extraction of one or more features characterizing various malignant cells' mechanical conditions in contrast to physiologically normal cells (step 260). In highly dynamic cells (such as malignant cells) all parameters in box 260 are expected to be increased. The exemplary details of each of these steps are presented in the figure in a self-explanatory manner.

Reference is made to FIG. 2B exemplifying, by way of a flow diagram 300, identification/definition of the tumor cells/tumor region from the image data analysis. First, a relatively wide field snapshot image of a tissue, suspected with malignancy is acquired (step 310). To this end, a relatively low-magnification image may be detected, and may be implemented using incoherent light. By that, a clear (without speckles) low magnified image (similar to a regular scope image) of the investigated area is obtained for reference, capturing healthy and malignant cells containing tissue regions in the same image. Then, a non-suspicious (healthy) region is imaged by coherent light to obtain a sequence of images (video) and this image data is analyzed (step 320). The image analysis is generally as described above with reference to FIG. 2A to extract average values of parameters of interest, e.g., as shown in step/box 260 of FIG. 2A. Then, coherent light measurements (imaging and data analysis) are performed on each suspicious tissue region, being region of interest (ROI)—step 330. This is also performed generally similar to that of FIG. 2A. The amplitude and fit parameters extracted from the image data of coherent light of the suspicious tissue and analyzed over those determined in step 320 for the healthy tissue (step 340) enabling determination of positive/negative result for the respective ROI (step 350). The results obtained for all ROIs with coherent light may then be combined (i.e. inserted on the initially obtained low magnification snapshot image of incoherent light to thereby create spatial map of all measured regions (step 360). The measurement technique for suspicious regions can be repeated to define malignant's tumor outline and borders (step 370) and by this generate data indicative of predicted tumor borders (clean margins)—step 380.

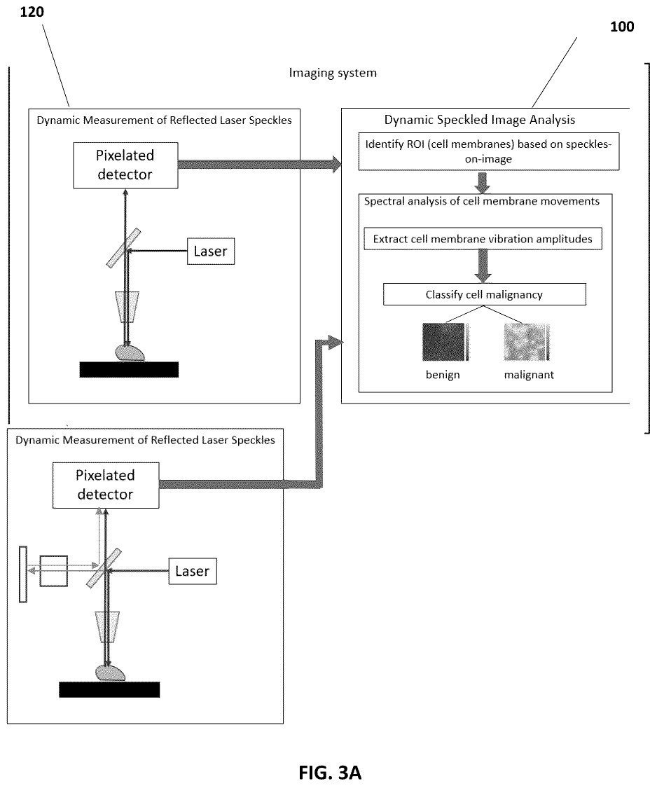

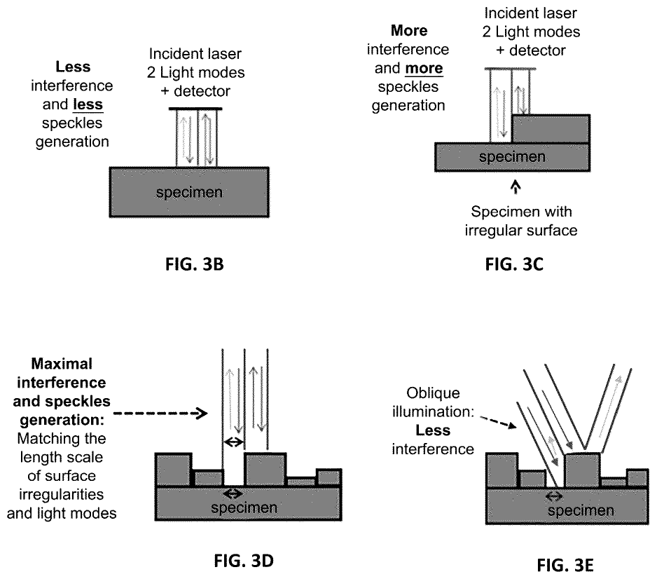

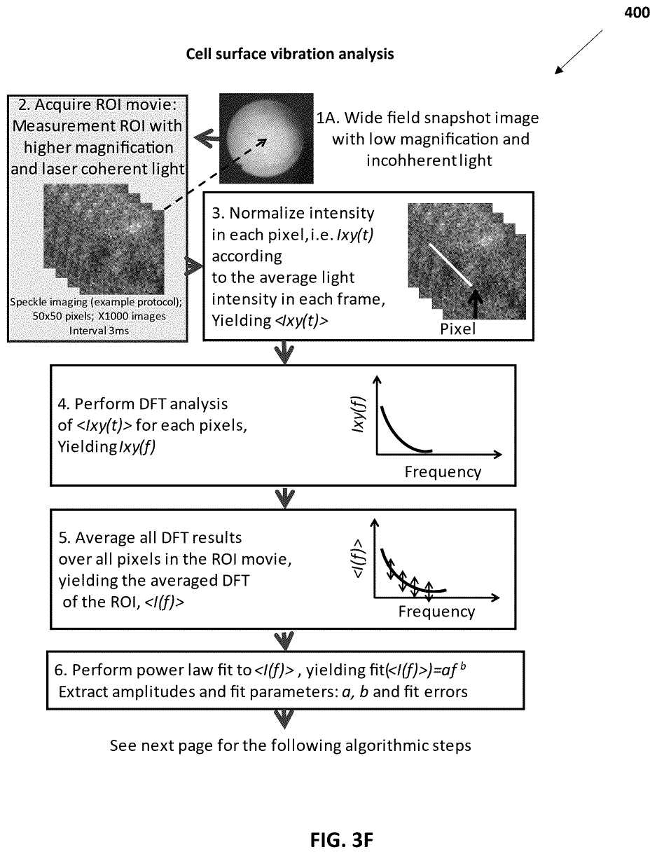

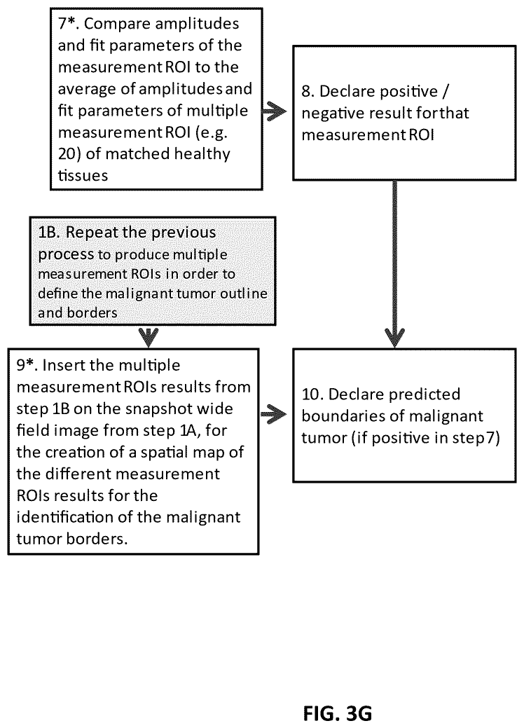

Reference is now made to FIGS. 3A-3F which show more specifically the implementation of the technique of the presently disclosed subject matter using speckle-based imaging technique as described above with reference to FIG. 1B.

FIG. 3A shows schematically the speckle-based imaging system 120 (e.g., that of FIG. 1B or FIG. 1C) configured and operable for dynamic measurements of so-called “reflected laser speckles” by implementing focused imaging of a tissue surface using normal incidence/detection optical scheme, and illustrates, in a self-explanatory manner, the main steps of the image data analysis applied to image data obtained by system 120 to identify and distinguish the malignant cells from surroundings.

FIGS. 3B-3F illustrate more specifically the important and advantageous features/effects of the use of focused imaging with normal incidence/detection optical scheme. Any incident wave from the far field can be decomposed into incident light modes, which represent the spatial degrees of freedom of the incident light field (in the plane perpendicular to the direction of light incidence). Their diameter depends on the wavelength and relates to the speckles' diameter. In FIGS. 3B-3D two adjacent incident light modes are illustrated. As shown in the figures, coherent illumination is focused on a specimen's surface along an axis perpendicular to the surface, and substantially specularly reflected light (propagating along the same perpendicular axis) is collected and detected by a pixelated detector.

For a specimen having substantially planar surface (FIG. 3B), interference effects result in relatively weak speckles generation; and for a specimen having high vertical surface irregularities (surface topology) shown in FIG. 3C, interference effects cause higher speckles generation. For a specimen having a high spatial density surface pattern of vertical irregularities (FIG. 3D) such optical scheme provides relatively high interference and speckles generation effects.

Thus, the present disclosure is based on detecting a significant component of the laser illumination specularly reflected from the non-regular surface of the tissue surface, generating the speckled interference pattern. This speckled interference pattern is indicative of the non-regularity of the tissue surface and the motion dynamics of the tissue surface along the axis perpendicular to the surface (z-axis).

As described above, some known speckle-based techniques, e.g., Speckle rheological microscopy (SHEAR), utilizing laser illumination focused in the inside region of the tissue and relying on scattering of the laser illumination by inside tissue components to derive MSD and diffusion data of those components. Therefore, such techniques can also use oblique illumination and detection, as shown in FIG. 3E. On the other hand the technique of the present disclosure that relies on reflection of laser illumination from the irregular surface of tissues cannot use oblique illumination. Such oblique illumination and detection, on an irregular tissue surface, reduce the degree of interference effects of the reflected light from the surface. Accordingly, the efficiency of speckles generation in that condition is reduced in comparison to speckles generation efficiency on the same surface in perpendicular illumination and collection conditions.

Accordingly, the technique of the present disclosure utilizes normal incidence and collection optical scheme with focused illumination on the surface region which provides for generation of speckles indicative of interference of the laser illumination specularly reflected mainly from the surface region (forming the majority of light being detected) thus providing high-sensitivity detection of surface motion dynamics along z-axis on a nanometric scale.

It should be understood that high spatial density surface pattern (vertical/perpendicular or tilted irregularities) results in cell surface vibration (mainly along vertical or tilted axis) thus enabling to obtain image data in the form of a sequence of focused images of a tissue surface with speckle patterns superimposed on the image, where the speckle patterns vary in the sequentially acquired image data pieces. This enables to directly associate/assign the intensity variation of light detected by a specific pixel with/to the vibration of the respective surface point. The inventors have shown that this effect of high sensitivity of the speckle variation to the cell surface vibration is hard to obtain using oblique incidence light scheme.

Hence, the above-described adjustment of optics and focusing conditions provides maximal matching between the length scale of the surface irregularities and the length scale of the speckles—light modes and imaging pixels. The length scale/diameter of the incident light mode should match the length scale of the surface irregularities in order for changes in the surface irregularities to maximally produce interference between light modes returned (reflected/scattered) from the illuminated surface. This interference pattern of the light response of the surface to the coherent illumination produces the speckles patterns at the image plane where the speckles size relates to the numerical aperture (NA) of the optical system. The pixelated detector system optimally reflects the time dependent changes in the speckles patterns if the length scale of the speckles matches the length scale of the imaging pixel. This optimal matching enables the accurate translation of the vertical motion of the surface irregularities to fluctuations in pixels' intensities.

FIGS. 3F-3G illustrate a flow diagram 400 of the image acquisition and image data analysis of the speckle-based inspection technique. In step 1A, a wide field snapshot image (e.g. with low magnification and incoherent light) is acquired. Then, a sequence of images of the selected regions of interest (suspicious region) using coherent light is obtained with higher magnification and coherent light (step 2), using a certain imaging protocol, providing image data in the form of a sequence of image data pieces, each including an image of ROI with respective speckle pattern. The image data analysis are as follows: each pixel intensity is normalized according to the average light intensity in each frame (step 3), DFT is performed with respect to each pixel to obtain spectral data (step 4), and DFT results are averaged over all the pixels of the movie to obtain averaged DFT (step 5), and model-based analysis (fitting) are performed to extract amplitudes and fit parameters (step 6).

The amplitudes and fit parameters relating to a specific ROI are then compared to the average of amplitudes and fit parameters of multiple measured ROI (e.g. 20) of matched healthy tissues (step 7), and positive/negative result for this specific ROI is obtained (step 8). In case of positive result, this data is used for prediction of boundaries of malignant tumor (step 10). The previous process is repeated for multiple ROIs thus producing multiple measurements of suspicious regions in order to define the malignant tumor outline and borders (step 1B), and the multiple measurement results of respective multiple ROIs are inserted on the snapshot wide field image, for creation of a spatial map of the different ROIs' measurement results and thus identification of the malignant tumor borders (step 9).

It should be noted that the above described data processing/analyzing steps 7 and 9 (as well as similar steps 340 and 360 of the flow diagram 300 of FIG. 2B) may utilize Artificial intelligence (AI), Machine learning (ML), deep neural networks (DNN), or any other suitable known approach(es) for optimal identification of malignant tissues and their boundaries.

As described above, the principles of the presently disclosed subject matter are based on the inventors' understanding and demonstration that mechanical vibrations affect multiple cell properties, including its diffusivity, entropy, internal content organization, and thus the cell function. The inventors have utilized various imaging techniques to quantify mechanical vibrations of cells.

More specifically, the inventors have utilized DIC, confocal, and TIRF microscopies to study mechanical vibrations in live (Jurkat) T cells. Vibrations were measured via the motion of intracellular particles and plasma membrane. These vibrations depend on adenosine triphosphate (ATP) consumption and on Myosin II activity. The inventors used spectral analysis of these vibrations to distinguish the effects of thermal agitation, ATP dependent mechanical work and cytoskeletal visco-elasticity. Parameters of spectral analyses could be related to mean square displacement (MSD) analyses with specific advantages in characterizing intracellular mechanical work.

The inventors identified two spectral ranges where mechanical work dominated vibrations of intracellular components: 0-3 Hz for intracellular particles and the plasma-membrane, and 100-150 Hz for the plasma membrane. The 0-3 Hz vibrations of the cell membrane that were measured in an experimental model of immune synapse (IS) affect the IS formation and function in effector cells and can facilitate immunological escape of extensively vibrating malignant cells.

The inventors have also utilized the novel speckle-based imaging technique and image data analysis for detection of malignant tumors. In particular, experiments have been conducted to compare a) cell membrane vibrations before and after augmentation using mibefradil and b) cell surface fluctuations of normal primary lymphocytes, normal bladder epithelium, normal primary melanocytes, normal prostate epithelium and normal lung air way epithelium cells and Jurkat, transitional cell carcinoma, melanoma, prostate carcinoma and lung carcinoma-malignant cells. The experimental results clearly indicate that dynamic reflective laser speckled image analysis is sensitive to cell surface fluctuations and may be used to detect malignant tissues with high accuracy, including detection of such tissue boundaries.

Mechanical work inside living cells plays a significant role in cell physiology. For instance, direct transport of intracellular constituents is conducted by molecular motors such as kinesin, dynein, and myosin II. Other indirect intracellular motor activities may control important biophysical parameters, including intracellular diffusivity [2] (entropy [4] and phase partitioning of cell content [4]. Indirect motor activity may include the incoherent fraction of mechanical forces that are applied by molecular motors on multiple sites on the cytoskeleton [2]. Thus, these incoherent forces impact the cytoskeleton. The cytoskeleton is an elastic mesh, and thus it transfers those forces to intracellular constituents, e.g., vesicles and organelles that are embedded within or adjacent to it. Applied forces on the cytoskeleton from tension generation by cortical actin may also influence the mechanical activity of the cytoskeleton [12].

Notably, mechanical work generates forces that are nonthermal and depend on ATP consumption. As a result of these forces, the cytoskeleton transfers mechanical work and augments the diffusion of intracellular particles [2] (It also increases intracellular entropy and decreases the partition of the intracellular content, as in liquid phase separation (LLPS) [4].

The plasma membrane (PM) is physically connected to the cortical actin. Thus, both thermal and active fluctuations of the actin mesh translate into corresponding fluctuations of the PM. In the case of T cells, their activation is an outstanding example of the significance of such PM fluctuations and their effect on cell biology and decision making. T cells get activated upon specific triggering of their T-cell antigen receptor (TCR). Such triggering occurs when TCRs recognize their cognate ligands, namely antigens, presented on the major histocompatibility complex (pMHC) on the surface of antigen presenting cells (APCs). It has been shown that the interactions between the TCR-pMHC and TCR activation depend on repeatedly applied perpendicular forces [13]. Thus, plasma membrane fluctuations may significantly contribute to the effective rates of TCR engagement and triggering, specificity of antigen recognition and cell activation.

The inventors have studied intracellular diffusion and intracellular mechanical work, as they occur in T cells. Specifically, the impact of non-equilibrium forces on intracellular particles motion enables the investigation of those forces by analyzing the dynamics of these particles. Intracellular diffusion motion is usually characterized as anomalous diffusion, for which the mean square displacement (MSD) is not linearly correlated to the time-lag of measurements. The MSD equation is (Δr²)=K_{α}t^{α}, where K_{α} is the diffusion coefficient and α is the diffusion power. Finding these specific anomalous diffusion parameters does not usually facilitate the identification of the main cellular mechanisms that explains those results. The reason is that different underlying mechanisms may lead to similar anomalous diffusion K_{α} and α results [16]. Three main mathematical models have been defined in relation to different cellular mechanisms that may govern the intracellular anomalous diffusion, including visco-elasticity, diffusion, and percolation in a crowded environment and medium with traps or energetic disorder. Fractional Brownian motion (FBM) is a model that is characterized by long-range temporal correlations and relates to diffusion motion in visco-elastic media. The model of Random walk on a fractal (RWF) enables to characterize diffusion motion or percolation in fractal media, such as crowded environment. Through the Continuous Time Random Walk (CTRW) model, the particle diffusion is hindered by trapping events and binding interactions. The motion of the particle is characterized by a broad distribution of waiting times between jumps. In a wider definition, this model also applies to a medium with energetic disorder.

The diffusion motion patterns of a particle that is stuck in a trap and will randomly gain enough energy to jump to another location may be similar to the diffusion motion patterns of a free particle that randomly gains a large amount of mechanical energy that will cause it to jump to a relatively remote location. Both situations are described by the CTRW model. Accordingly, the impact of mechanical energy on intracellular diffusion is likely to cause the anomalous diffusion patterns to better match that model. A distinctive difference between the CTRW model and the other FBM or RWF models is that the CTRW model describes a non-ergodic process, while FBM and RWF describe ergodic processes. Accordingly, if a break in ergodicity could be demonstrated while analyzing diffusion motion in living cells, it is reasonable to assume that in that situation the CTRW model and its related underlying mechanisms are dominant and better explain the cellular condition. Following that, an analytic framework of intracellular diffusion motion that combines the effects of spatial fluctuations with ergodicity breaking should clearly capture the impact of intracellular mechanical work on the anomalous diffusion. Such an analysis should be able to discern underlying mechanisms of intracellular diffusion motion that may yield similar anomalous diffusion parameters (K_{α} and α) but differ in their ergodicity.

The power spectral density (PSD) analysis of a wide range of time-dependent parameters was studied in many fields of science, including physics, biophysics, geology, weather science, etc. [9]. Often, the PSD has the form [9]:

$${μ}_{s} ( f , ∞ ) = \frac{A}{{f}^{β}}$$

where μₛ denotes the power (i.e. squared amplitude) of the vibrational motion, A is an amplitude, f is (time-domain) frequency and β is the exponent characteristic of the statistical properties of the particular time-dependent stochastic process studied. This prevalent PSD function has been defined analytically for diverse situations including Brownian Diffusion (BD) [9], and multiple models of anomalous diffusion [9]-[11]. Except for theoretical studies, PSD of diffusion motion was investigated mainly in simulations and basic experimental setups incorporating quantum dots (Houel et al., 2015) or trajectories of tracers in artificial crowded fluids (Weiss, 2013), but not in live cells.

When investigating vibrations in live cells, a combined contribution to the PSD of two components has to be considered: First, a homogenous and random (white-noise-like) contribution due to thermal forces. Second, a periodic or incoherent contribution due to inhomogeneous mechanical work. The second component is naturally related to a break in ergodicity and could be more readily distinguished while analyzing intracellular modes of vibration utilizing PSD calculations.

Spectral analysis of the dynamics of live cells' constituents may advantageously provide better insight into the biophysical mechanisms behind their anomalous diffusion and ergodicity breaking, especially in regard to intracellular mechanical work.

The inventors utilized a relatively simple spectral analysis framework for the exploration of intracellular diffusion and intracellular mechanical work. This framework is based on DFT of temporal position changes of intracellular constituents. This framework then serves to analyze the intracellular diffusion of intracellular particles (e.g., vesicles or other small organelles) and fluctuations of cell diameter in live Jurkat cells a) before and after ATP depletion, b) before and after treatment with blebbistatin, as well as in Jurkat cells before and after treatment with mibefradil. From the PSD results of the motion of cell constituents, the inventors defined parameters that reflect intracellular mechanical work and showed that cells under normal (physiological) conditions are active and produce significant extent of mechanical work. This mechanical work is diminished in the same cells that become non-active after ATP depletion. The plasma membrane dynamic is augmented in the same cells after treatment with mibefradil.

Next, the inventors explored intracellular mechanical work over a wide spectrum of time-scales and frequencies and identified two spectral ranges where mechanical work dominated vibrations of intracellular components: 0-3 Hz for intracellular particles and the plasma-membrane, and 100-150 Hz for the plasma membrane. Such vibrations of the cell membrane are expected to affect the formation and function of the immune synapse by effector cells. Thus, the membrane vibrations of Jurkat cells were studied in an experimental model of the immune synapse using total internal reflection fluorescence (TIRF) microscopy. Indeed, the inventors identified ATP-dependent membrane fluctuations at the model synapse, esp. below 3 Hz. These mechanical fluctuations of the cell membrane may also affect T cell recognition of extensively vibrating malignant cells. Spectral analysis of intracellular vibrations and motion provides a useful tool for characterizing cell condition and activity in health and disease.

The inventors have shown, first by simulation, that spectral analysis of temporal fluctuations of large intracellular particles is related to intracellular diffusivity and intracellular mechanical work.

The cytoskeleton is an elastic polymeric mesh that spans the intracellular volume with a mesh size of around 50 nm [2]. The elastic cytoskeleton mesh is surrounded by a crowded viscous intracellular gel-like medium. These two constituents largely make the two-component visco-elastic cellular content. Notably, the mechanical response of the intracellular medium is mainly elastic and less viscous [2] with low Reynolds number. The energy due to vibrations in this elastic cytoskeleton has the value of: E_{mechanical}=0.5 kA²+Eₗₒₛₛ, where Eₗₒₛₛ is the (relatively small) dissipated energy, k is the equivalent spring constant of the system, and A is the amplitude of the motion. Monitoring movements of an intracellular particle (like a vesicle) that is significantly larger than the cytoskeleton mesh size (50 nm) can reveal the movements of the adjacent cytoskeleton mesh. Spectral analysis of this particle movement (i.e., its change in position over time) will express multiple modes of vibrations of the adjacent cytoskeleton mesh. Each vibration mode of this mesh has a mechanical energy level of approximately 0.5 kA². The integral of the spectrum of vibrations represents the approximated total mechanical energy of the measured part of the cytoskeleton mesh in the specified spectral range. Monitoring movements of multiple intracellular particles and averaging the spectral analysis results of these movements enable insight into the mechanical energy and work of the entire cytoskeleton and cellular system.

Thermal agitation forces and incoherent intracellular mechanical forces (which are a by-product of directed forces that are utilized for cell physiology), both act on the cytoskeleton. Together, they contribute to the cytoskeletal modes of vibrations. These vibration modes can then be revealed by monitoring embedded particles inside the mesh for their diffusion motion. Spectral analysis of the diffusion motion of these particles can be related to the modes of vibration and mechanical energy of the adjacent cytoskeleton.

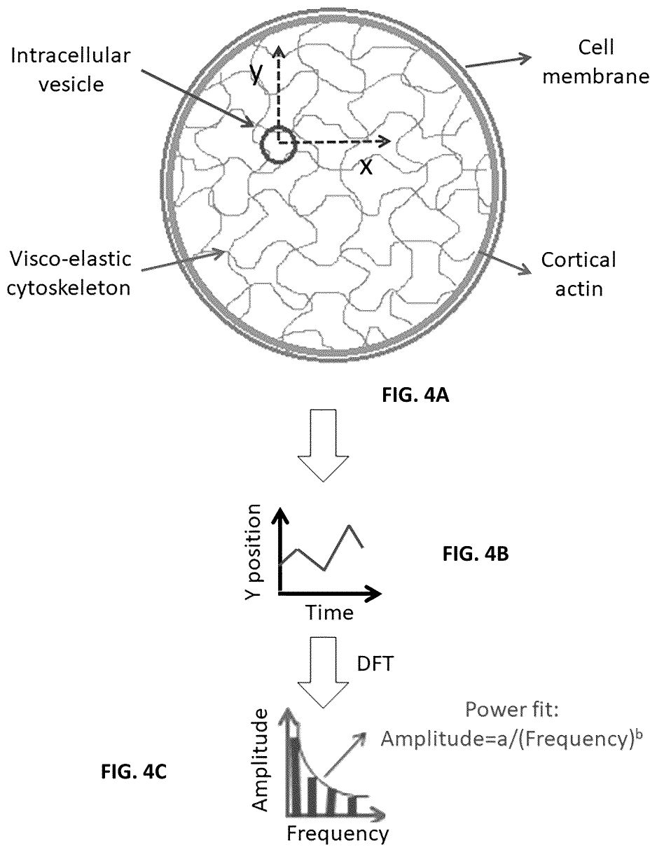

In order to explore these relations, the diffusion motion of an intracellular particle embedded in the elastic cytoskeleton mesh is considered, as illustrated in FIG. 4a. Particle's position change in time is shown in FIG. 4b (along y coordinate only for clarity). The change in particle's position over time could be analyzed by DFT to produce the particle's amplitudes of spatial fluctuations for the corresponding spatial dimensions (x or y), as shown in FIG. 4c. These amplitudes of spatial fluctuations represent the different modes of vibrations that determine the combined mechanical energy of the particle and adjacent elastic cytoskeletal mesh. To further investigate these spectral amplitudes of spatial fluctuations, the following three aspects were considered:

1. The summation (integral) of all powers (the squared amplitudes), which relate to the total mechanical energy of the particle-elastic mesh system in the specified spectral range. Each power represents a specific amplitude of vibration (A or Amplitude) and its corresponding mode of mechanical energy (namely, E_{mechanical}=0.5 kA²).

2. The vibration spectrum is fitted with a power equation for each set of spectral results for each cell and condition:

$${Amplitude}_{estimated} = a / {( frequency )}^{b} \qquad ( 1 )$$

The relation of a and b parameters of the power fit to the diffusion and mechanical work characteristic is described further below.

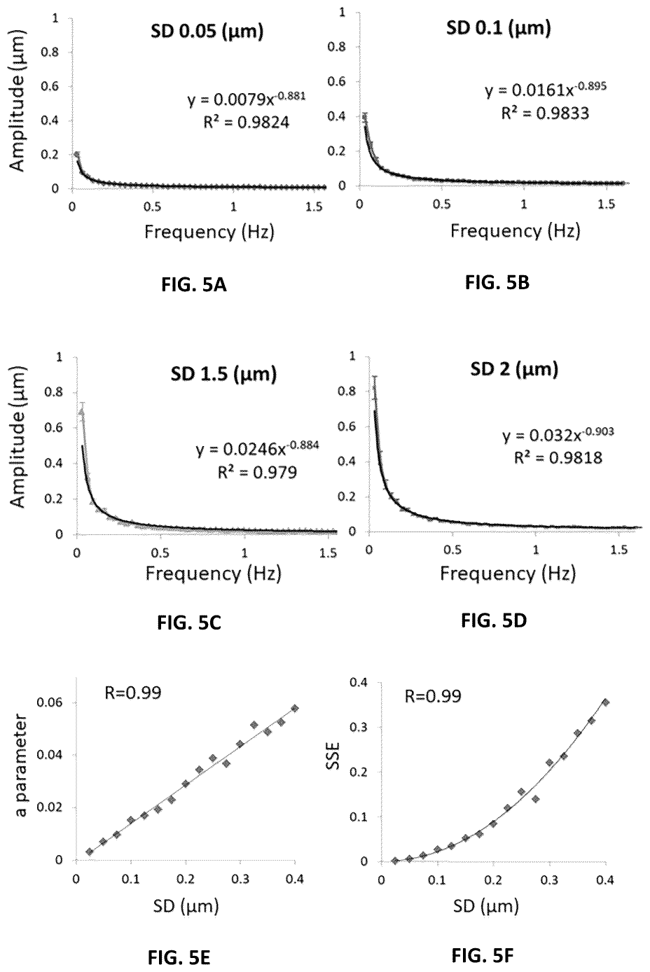

3. The extent to which the actual spectrum of amplitudes fits to the model equation of estimated power. In other words, the inventors quantify the magnitude of the sum of squared errors (SSE) that relates the spectrum to its power fit equation. Then, the correlations of SSE values to the intracellular diffusion and mechanical work characteristic are investigated. A general diffusion process can be characterized by its typical probability density function (PDF) of translocations for each corresponding time-lag, and following that, by the statistics of MSDs. First the condition of Brownian diffusion is analyzed, for which α=1. The PDF of translocation for each time-lag in this case is Gaussian. The inventors simulated the movement of particles undergoing normal diffusion with different diffusion coefficients (represented by the different standard deviations of the PDF of translocation Gaussians; FIGS. 5a-5d). In this simulation, calculating the spectra of amplitudes of fluctuations (of position changes in time) reveals that the compatibility of a power fit model to these spectral results is high. It also shows that the a parameter of the power fit (Eq. (1)) is correlated to the standard deviation (SD) of PDF of translocations (FIG. 5e) and accordingly, to diffusivity. This simulation of normal diffusion indicates that the SSE of the power fit is also correlated to the SD of PDF of translocations and diffusivity (FIG. 5f).

The characteristic PDF of a diffusing particle (along with its parameters K_{α} and α) can be related to the spectral analysis results of its position changes in time. For an ergodic diffusion process, the PDF of translocations in a time-lag that corresponds to the interval between measurements reveals the statistic of the sequential translocation steps of that diffusive object. Knowing this statistic of translocations does not allow one to reconstruct the exact trajectory of that particle during measurements. Still, it is possible to anticipate the different amplitudes of spatial fluctuations and their correspondent statistical frequencies from the given PDF of translocations. The knowledge of the different amplitudes of spatial fluctuation with their corresponding frequencies of occurrence is generally equivalent to the results of the DFT analysis of the position fluctuations of that same particle over time. In this analysis, the different frequency-dependent amplitudes of the DFT represent the different amplitudes of the particle's spatial fluctuations (i.e., translocations). Similarly, the corresponding frequencies of these amplitudes (in the DFT) represent the equivalent probability of occurrence of these translocations (in the PDF). Thus, it is expected that the DFT results of this particle diffusion movements will be related to its PDF of translocations and accordingly, to its diffusion parameters.

Following that, the possible analytical relations between the DFT power fit parameters a and b and the PDF parameters K_{α} and α in conditions that included anomalous or nonergodic diffusion were explored and are described herein.

Due to the possible relation between the DFT of a particle's position change and the PDF of translocations, the inventors analyzed the specific possible correlations between DFT powers fit parameters a and b in Eq. 1 and the diffusion parameters K_{α} and α. Considering a diffusion process: an increase in K_{α} relates to an increase in the width of the PDF of translocations. This increase implies bigger translocations for most probabilities. Such a case implies elevated DFT amplitude results for most frequencies. This will produce higher values of the a parameter of the powers fit (in a general power function y=a/x^{b}, increasing a will increase all the function values). Therefore, it can be expected that K_{α} will be positively correlated to the a parameter of the power fit, as can be seen in the simulation presented in FIG. 5e).

In ergodic sub-diffusion processes, α<1 and the shape of the PDF of translocations may not be Gaussian. In such cases, the magnitude of translocations that correspond to the lower probabilities are relatively small in comparison to the magnitude of translocations for the same probabilities in a Gaussian PDF that characterizes Brownian diffusion. The DFT amplitudes that are related to this sub-diffusion PDF are characterized by relatively low amplitudes at low frequencies. The lower DFT amplitudes in the low frequencies range produces lower b values of the matching power fit. Note that in a general power function y=a/x^{b}, decreasing the value of the b parameter changes the shape of the function, where its elevated proximal (close to zero) part becomes less steeper and wider. For such ergodic sub-diffusion processes, the values of b are positively correlated to the a values. Following the same principles, the positive correlation of b and a values can be anticipated for the alternative condition of super-diffusion.

In non-ergodic anomalous diffusion processes, the a values may be relatively high and the shape of the PDF of translocation is non-Gaussian and may be non-symmetric. In such cases, the average magnitude of translocations corresponding to the lower probabilities (from both sides of the PDF graph) depends not only on the shape of the PDF of translocations but also on its symmetry. In this situation, the average magnitude of translocations corresponding to the lower probabilities of the PDF are no longer correlated primarily to the shape of the PDF of translocation and a, but also depend on the non-ergodic process and the extent of asymmetry of the PDF. Accordingly, the correlation between a and b of the matched power fit may break due to a non-ergodic asymmetric process, especially as a result of intracellular mechanical work.

In living cells: the applied forces that relate to intracellular mechanical work may be directional in contrary to the perfect random and symmetric thermal forces or the elastic forces of the relatively symmetric cytoskeleton mesh. Those forces due to intracellular mechanical work will break the ergodicity and the symmetry of the affected diffusion motion in cells. Following that, the high b values in this condition of non-equilibrium nonergodic process may be the result of two contributions to b. The first contribution to b relates to large translocations (α) and the shape of the PDF. This adds to a second contribution to large translocations that relates to the breaking of ergodicity and symmetry due to mechanical work.

To summarize the expected influence on the a and b parameters of the power fit by adding mechanical work to the cellular system:
(i) The a parameter increases due to the increase in K_{α} and diffusivity associated with active cells.
(ii) Values of b also increase due to the increase in α (power of diffusion), while added mechanical work breaks ergodicity and further increases b values.

According to these arguments, the product value of a·b could be used to differentiate active cells from non-active ones. In an ergodic diffusion process, SSE values of the power fit formula that fit the spectral amplitudes of position temporal fluctuations are correlated to diffusivity, as demonstrated in FIG. 5f. This result may be explained by the assumption that in a more dynamic system the errors from expected values should be more significant. As the dynamics of the system or variance of translocations is higher, the variance of variance (or the fourth moment) will be higher as well. It is reasonable to assume that in an active, non-ergodic system the applied forces are not perfectly random and symmetric as thermal forces. Accordingly, the amplitudes spectrum in this case will be less “smooth.” Thus, the SSE values of the power fit will increase further relative to the basic levels of SSE values due to the degree of dynamics of the particles and errors of measurements.

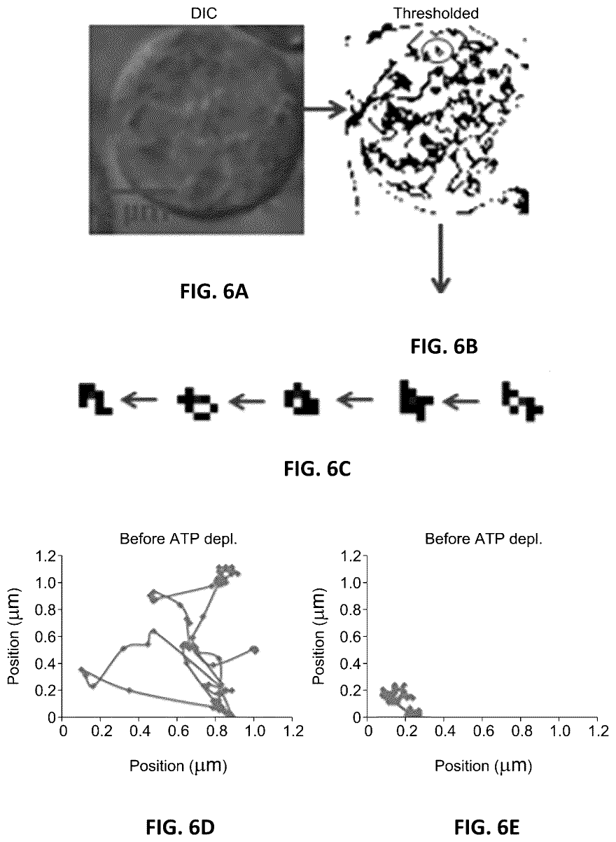

In the following experimental results of the spectral analysis of position fluctuations in time of intracellular particles in Jurkat T lymphocytes, each cell before and after ATP depletion, are presented. Specifically, the goal was to explore the relations of these results to diffusion parameters (K_{α} and α) that were calculated for the same cells and conditions. Depletion of cellular ATP was induced by 30 min incubation with 0.2 μM of the mitochondrial complex 1 inhibitor Rotenone (Sigma-Aldrich, St. Louis, MO, United States) together with 10 mM glycolysis inhibitor 2-deoxy-D-glucose (Sigma-Aldrich, St. Louis, MO, United States). For the visualization and monitoring of intracellular objects, including vesicles, Differential Interference Contrast (DIC) microscopy was employed. Reference is made to FIG. 6a where DIC image of a representative live Jurkat cell is shown. DIC image stacks were taken with FV-1200 confocal microscope (Olympus, Japan) equipped with an environmental incubator (temperature and CO2) using a 60×/1.42 oil objective. Cells were imaged repeatedly every 0.3 s, with a total of 100 images acquired for each cell. This measurement time allowed the inventors to effectively avoid the constrains of the limited cell size (up to ~10 μm) on diffusion. The cell image stacks were first converted to 8-bit images and thresholded (yielding binary images) to segment individual entities for tracking. For intracellular particle tracking the ImageJ plugin MultiTracker (Kuhn lab, the University of Texas at Austin) was utilized.

FIG. 6b shows the DIC image of the representative live Jurkat cell of FIG. 6a after thresholding for object tracking. Thresholding levels were defined according to the histogram of gray levels of the images. The inventors noticed that a small range of thresholding values (in gray levels) were appropriate for segmentation, since too narrow threshold values caused fragmentation of the objects into isolated pixels, whereas threshold values that were too wide resulted in object contour thickening and unification. Analyzing the size distribution of the segmented objects, revealed that most of these objects were in the size range of intracellular vesicles or organelles (0.15 to ~1.17 μm, average diameter 0.5 μm). Particles' diameters were similar in cells before and after ATP depletion.

After thresholding the objects, the x and y positions of each identified particle at each point of time (determined by the MultiTracker plug in) were recorded (FIGS. 6c-6e). FIG. 6d shows examples of trajectories of an intracellular particle in an untreated cell (100 steps); whereas FIG. 6e shows examples of trajectories of an intracellular particle in an ATP-depleted cell (100 steps). Then, the DFT of these time dependent position changes were calculated for each spatial dimension. The average DFT amplitudes of all moving particles in each cell under each condition were determined for the x and y spatial dimensions. A fit to a model of power series (y=a/x^{b}) was conducted for the DFT amplitudes results such that the parameters a, b, and SSE of the power fit could be obtained.

From the position results of the detected intracellular particles, the MSD values for time-lags from 0.3 to 3 s (with a 0.3 s gradual increase) were calculated. The average MSD values were determined for that series of time-lags for each cell before and after ATP depletion. These values were fitted to a model of power series to determine the corresponding K_{α} and α values for the underlying diffusion process in these cells. As expected, the K_{α} and α values were higher in the normal active cells, as compared to the same cells after ATP depletion (K_{α}: 0.023 μm²/s vs. 0.013 μm²/s with p<10⁻⁴. α: 0.924 vs. 0.809, with p<10⁻³).

To estimate ergodicity in the cells, a basic principle was employed, which implies that in an ergodic system the distribution of translocations of a specific trajectory is not dependent on its spatial location. Following that, the distributions of translocations of all trajectories in a perfectly ergodic system are similar. In the described herein experiment, the distribution of translocations of each trajectory or a particle is reflected by this particle's MSD results. Evaluating the heterogeneity of all particles MSD results in a cell (SD of MSD results in that cell) will produce an estimation of the ergodic level in that cell system [9]). When this hypothesis was used to compare the level of ergodicity in the active cells to the level in the same cells after ATP depletion, it was found (as expected) that the level of ergodicity in active normal cells is lower than in non-active ATP-depleted cells based on the SD values of MSD results in the two group of cells (SD of MSD's=0.026 μm² in normal cells vs. SD of MSD's=0.018 μm² in ATP-depleted cells, p=0.01).

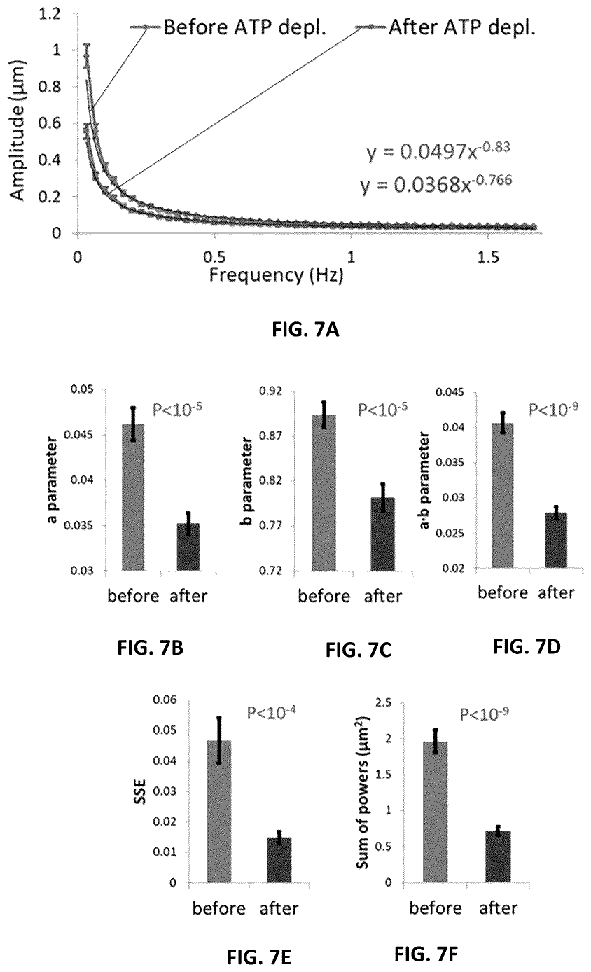

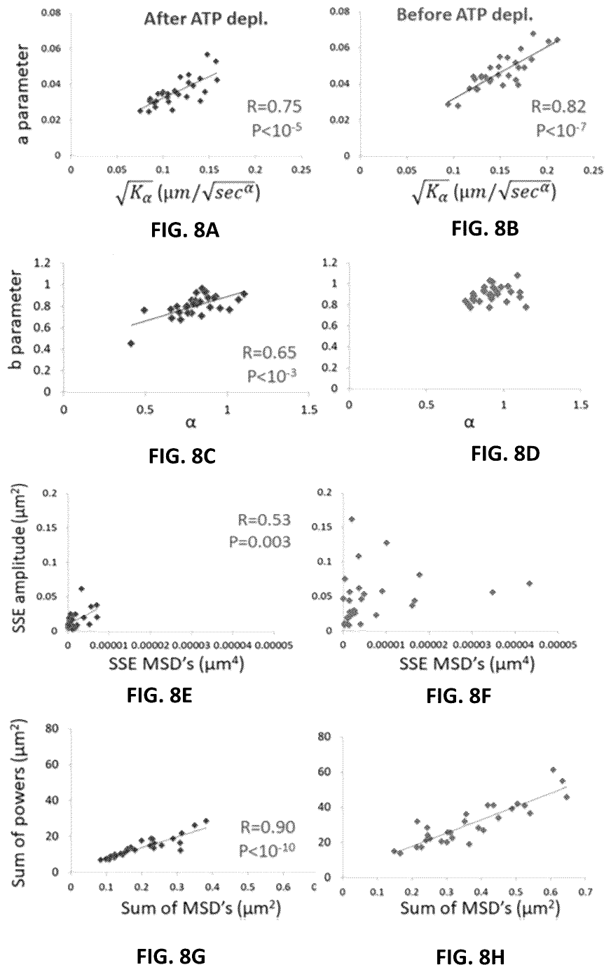

FIGS. 7a-7f summarize the results of the DFT analysis of particles position changes in living Jurkat cells before ATP depletion and DFT results of the same living cells after ATP depletion (that inhibits cellular active mechanical work). As expected, a (FIG. 7b), b (FIG. 7c), SSE (FIG. 7e), and the sum of all powers (FIG. 7f) are all higher in active live cells as compared to the same cells after ATP depletion. Next, the ability of these parameters, derived from spectral analysis of position fluctuations, to capture different aspects of particle motion, esp. in comparison to the prevalent anomalous diffusion parameters K_{α} and α was evaluated. Specifically, the correlation between these two groups of parameters was studied, and is illustrated in FIGS. 8a-8h which show in detail the correlations of amplitude spectral density (ASD)/power spectral density (PSD) parameters and mean square displacement (MSD) parameters in live cells before and after adenosine triphosphate (ATP) depletion. FIG. 8a shows the correlation between the a parameter of ASD analysis and \sqrt{K_{α}} of MSD analysis in ATP-depleted cells. Analyses relate to DIC microscopy results of intracellular particles motion as shown in FIGS. 7a-7f (n=29). FIG. 8b shows the correlation between the a parameter of ASD analysis and \sqrt{K_{α}} of MSD analysis in cells before ATP depletion. FIG. 8c shows the correlation between the b parameter of ASD analysis and α of MSD analysis in ATP depleted cells. FIG. 8d shows the correlation between the b parameter of ASD analysis and α of MSD analysis in cells before ATP depletion. FIG. 8e shows the correlation between the SSE parameter of ASD analysis and SSE of power fit to MSD analysis in ATP depleted cells. FIG. 8f shows the correlation between the SSE parameter of ASD analysis and the sum of squared errors (SSE) of power fit to MSD analysis in cells before ATP depletion. FIG. 8g shows the correlation between “Sum of powers” parameter of PSD analysis and sum of MSD's parameter (from MSD analysis) in ATP depleted cells. FIG. 8h shows the correlation between “Sum of powers” parameter of PSD analysis and sum of MSD's parameter (from MSD analysis) in cells before ATP depletion. R- and P-values of significant correlations are presented in the corresponding correlations images.

Strikingly, the two groups of parameters were significantly correlated in ATP-depleted cells (FIGS. 8a, 8c, 8e, 8g). In nonactive cells, most of mechanical forces are thermal and random. Thus, it is expected that the a parameter will be related to K_{α}, the b parameter will be related to α and SSE of the fit to the amplitudes will be related to the SSE of fit to the MSD values (as discussed above).

On the other hand, for cells before ATP depletion, there was no correlation between b and α probably due to the break in ergodicity (as also discussed above). These cells were physiologically intact and active, and produced mechanical work. Therefore, the b parameter values may express the break in ergodicity that is typical for living active cells.

Moreover, in active cells the correlation between SSE of the fit of amplitudes and the SEE of the fit of MSD's also seemed to break. This is probably due to the addition of forces that relates to intracellular mechanical work. These forces may act in a similar time-scale and frequencies to our observations and may directly influence the spectrum of position fluctuations related to these frequencies.

The sum of powers of the spectral analysis was found to be correlated to the sum of all MSD values under both cell conditions (FIGS. 8g, 8h). The sum of powers of the particles' spatial fluctuations over time may represent a summation of all modes of vibrations (in this time-scale) of these particles that are embedded in an elastic medium. Therefore, this summation of all powers relates to the total mechanical energy of this system, namely the mechanical work plus thermal energy when the system is under non-equilibrium. It relates only to thermal energy when the system is in equilibrium. The sum of all MSD values represents the diffusivity of these particles. The mechanical energy and diffusivity are expected to be correlated in cellular systems both under equilibrium and non-equilibrium conditions, as shown in a previous work by the inventors [4]).

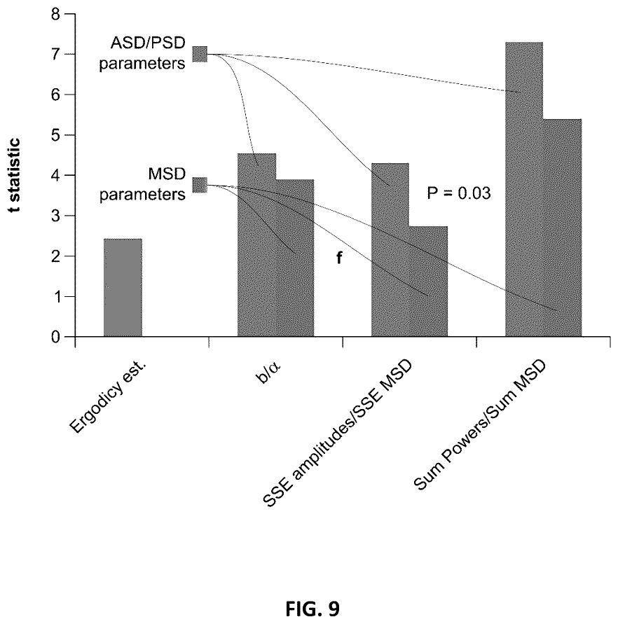

The inventors further have tested whether these new parameters, which relate to the amplitudes or powers of temporal position fluctuations, have a better discriminative ability to differentiate between active working cells and non-active ATP-depleted cells in comparison to the classical diffusion parameters of K_{α} and α. To this end, the t-statistic results that have been obtained while using each parameter were analyzed to differentiate the two physiological conditions (FIG. 9). Referring now to FIG. 9, the t-statistic values of each parameter when comparing normal active cells to the same cells after ATP depletion reflects the discriminative strength of that parameter to create two groups of results that are statistically diverse. The t-statistic values of the new parameters (ASD/PSD analysis based) are higher than the t-statistic values of classical diffusion parameters (MSD analysis based). This difference is statistically significant as summarized in FIG. 9 for the following parameters: the b parameter vs. α, sum of squared errors (SSE) of amplitudes vs. SSE of MSD's, and “Sum of powers” vs. Sum of MSD's. The P-values for the difference in t-statistics values between ASD/PSD parameters and the corresponding MSD parameters was calculated according to t-test for paired two samples and was found to be 0.03. The t-statistics value for the ergodic test ( ) is also presented, however the discriminative ability or t-statistic of the parameter for ergodic estimation alone is the lowest (FIG. 9; left bar). It is concluded that the new DFT-derived parameters may detect better the increase in mechanical energy that characterizes active and physiologically normal (in cells contrast to non-active ATP-depleted ones), in comparison to the classical diffusion parameters of K_{α} and α.

In the following, experiments related to the spectral analysis of temporal fluctuations in cell diameter before and after ATP depletion will be detailed.

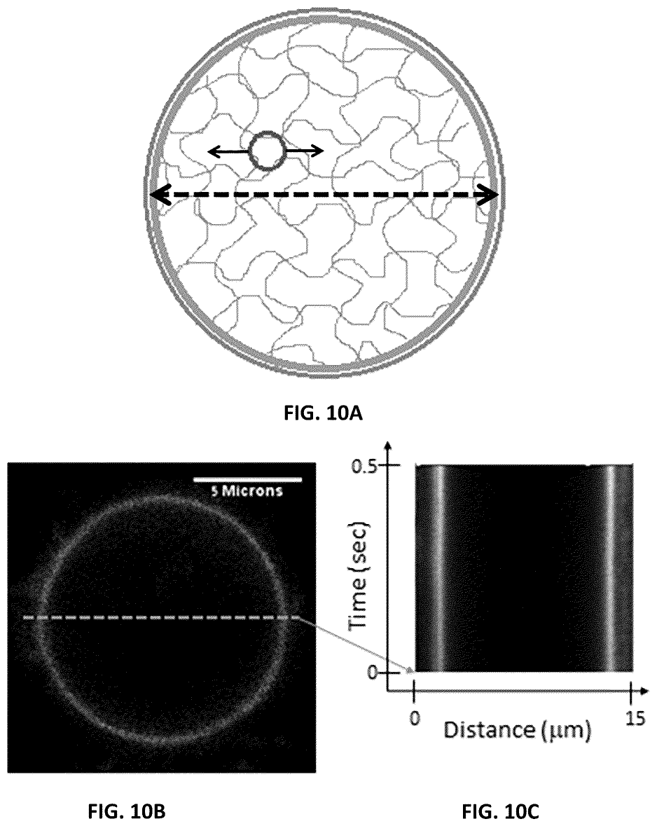

In active cells the mechanical work of the elastic cytoskeleton augments the motion of intracellular particles [2]. By that it increases the amplitude of the particles' modes of vibrations and mechanical energy. This mechanical work of the elastic cytoskeleton mesh on particles that are embedded within must have a co-effect on the dynamics of the elastic mesh borders, which are intimately related to the cell membrane. In other words, the actively vibrating and elastic cytoskeletal mesh that augments the motion of embedded particles will also produce matching vibrations of its boundaries, which are mechanically coupled to the cell membrane by the cortical actin (schematically illustrated in FIG. 10a [5,6]. The arrows indicate possible mechanical relation between intracellular cytoskeleton fluctuations (that may be detected by the motion of imbedded particles) and the fluctuations of cytoskeleton borders or the cortical actin (that may be detected by following changes in cell diameter).

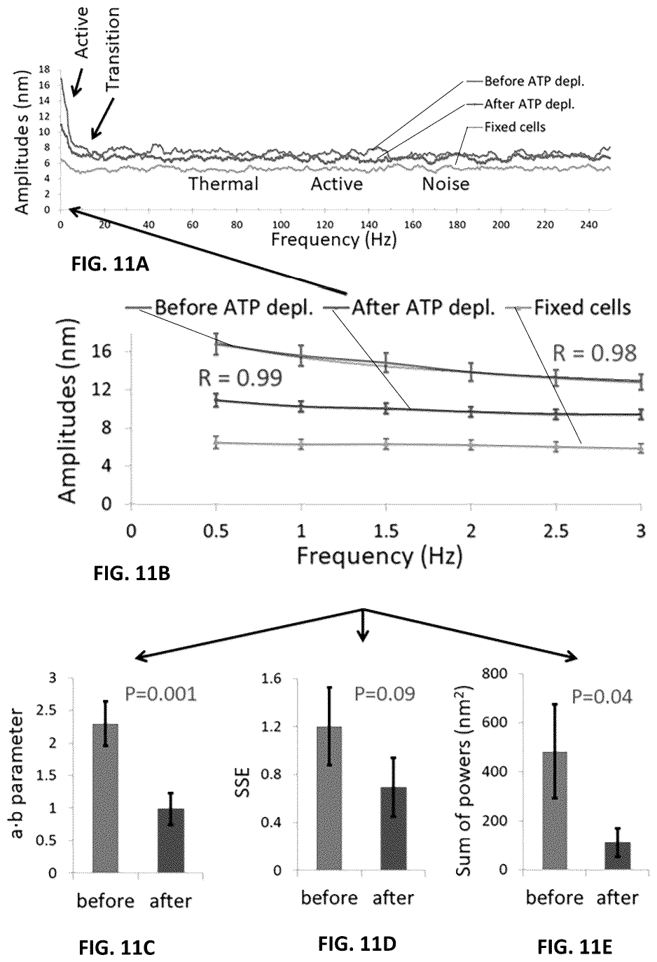

Following that, the inventors assumed that monitoring fluctuations in cell diameter exhibits similar spectral patterns to the spatial fluctuations of intracellular particles. In order to test this assumption, the inventors first highlighted the cell membrane via fluorescent staining of CD45, an abundant surface glycoprotein in T cells. Then fast and repetitive line-scans across the cell membrane at its apparent mid-section were conducted by confocal scanning microscopy (FIG. 10b). Jurkat cells were imaged using an Abberior Expertline confocal/STED microscope (Abberior Instruments, Göttingen, Germany), mounted on a TiE Nikon microscope and operated by the Inspector software (v0.13.11885; Abberior Instruments, Göttingen, Germany). The cells were excited using a 638 nm pulsed laser (90 ps) 2 mW/cm² at 50% power for x-t live cell experiments. Samples were imaged with a (CFI-SR-HP) Apochromat TIRF X100 NA 1.49 oil immersion objective (Nikon Instruments). Image stacks were generated by taking 1,000 serial images with acquisition time of 2 ms for frames of unidirectional 300 pixels (50 nm pixel size, 5 μs pixel dwell time). The reflection light was detected using an APD with a band-pass filter of 650-720 nm and a pinhole setting of 1.1 Airy units. Each line was scanned once. The repetitive line-scans could then be presented as a kymograph (FIG. 10c). Cell membrane position was determined according to the pixel with the highest intensity. Cell diameter fluctuations were analyzed in each Jurkat cell before and 30 minutes after ATP depletion. After DFT analysis, average amplitudes of each frequency were calculated for each experimental condition. The data were then smoothed using a moving average window of 10 data points in the spectra (i.e., 5 Hz). The average amplitudes of 14 Jurkat cells, each cell before and after ATP depletion, are presented in FIGS. 11a,b. As a control, the average amplitudes of 20 Jurkat cells after fixation are presented as well. As can be seen in FIG. 11a there are two distinct frequencies ranges for power fit: <3 Hz and >3 Hz. The first range of frequencies (<3 Hz) is compatible with the range of frequencies that have been explored in the above described experiment, utilizing repeated DIC images of intracellular particles. Concentrating on amplitudes in the frequency range <3 Hz (FIG. 11b) reveals that these amplitude-spectra are similar to the amplitude-spectra obtained for DIC images of intracellular particles. According to FIG. 11e, the sum of powers parameter is reduced after ATP depletion and the power fit parameters, namely SSE and a·b, are also reduced (FIG. 11c, 11d). As could be assumed, the elastic cytoskeleton modes of vibrations that augment the motion of large intracellular particles (meaning, larger than the mesh size) also impact the motion of the borders of that elastic mesh that are adjacent to the cell membrane. In that way, modes of vibration of the cell diameter relate to modes of vibration of intracellular particles. Both vibration types reflect intracellular mechanical work that is done on the elastic cytoskeleton.

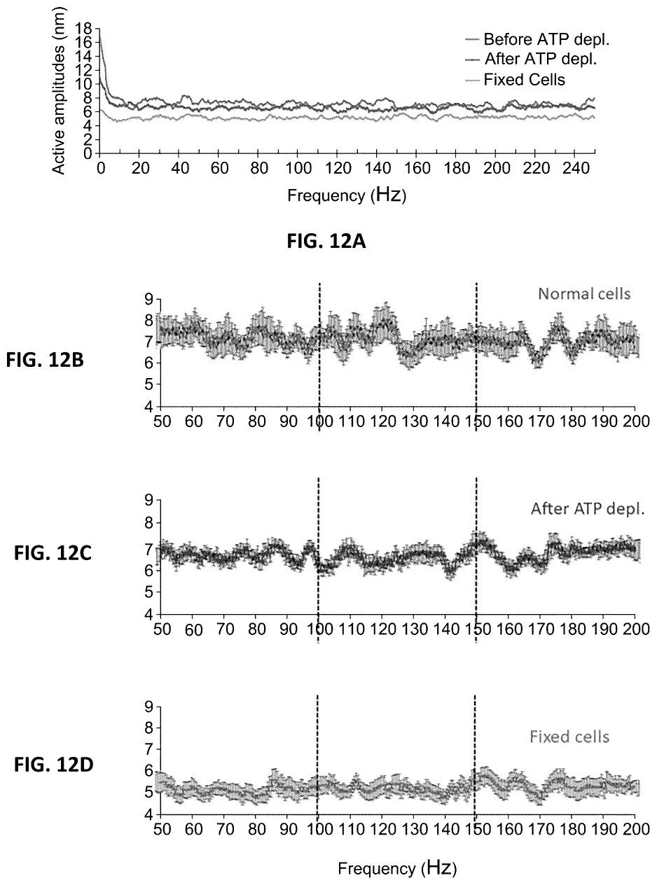

The fast confocal imaging of the cell diameter and its fluctuations enabled to also examine the modes of vibration of this diameter at relatively high frequencies. Specifically, the amplitudes of fluctuations of cell diameter at 50-200 Hz in cells were studied before and after ATP depletion and also in fixed cells (FIGS. 12a-d). These results have shown that in the frequency range between 100 and 150 Hz, the amplitudes are less random relative to the amplitudes in the other frequency ranges.

In an ideally viscous medium in equilibrium, the spectrum of thermal forces on a particle is equivalent to white noise and independent of frequency. Thus, the power spectrum of spatial fluctuations of such a particle should be completely random and non-correlated. If correlations in the particle motion appear due to extra thermal forces, as elastic forces in the medium or forces due to mechanical work, then the amplitude spectrum of that particle motion is expected to be less random. Autocorrelation analysis of the amplitude spectra will lead to higher values and a decrease in decay with increased frequency lags. Therefore, autocorrelation analysis may differentiate an amplitude-spectrum that is more typical to ideal Brownian process or to noise from an amplitude-spectrum that is more typical to elastic forces or mechanical work.

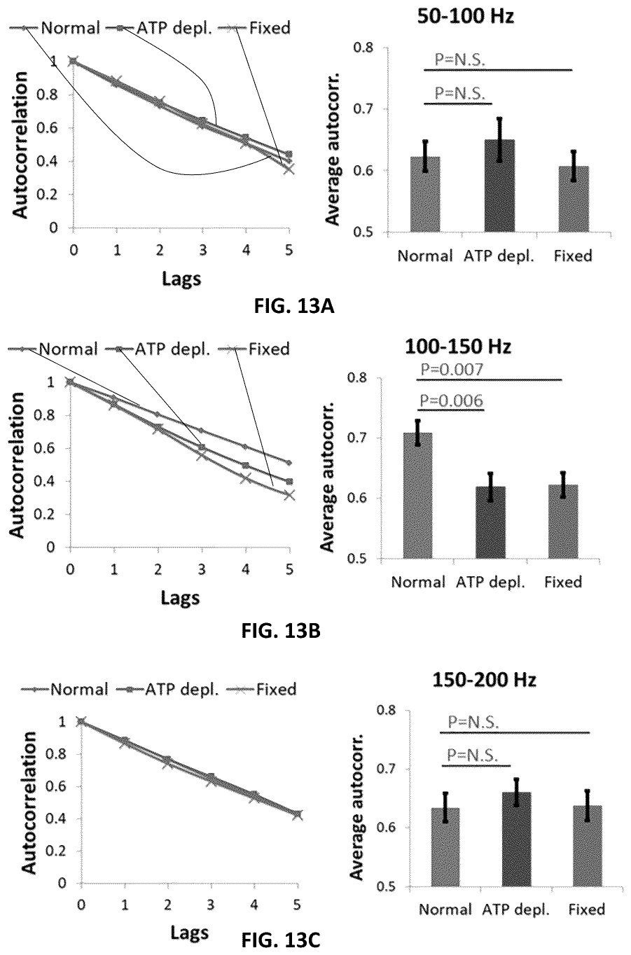

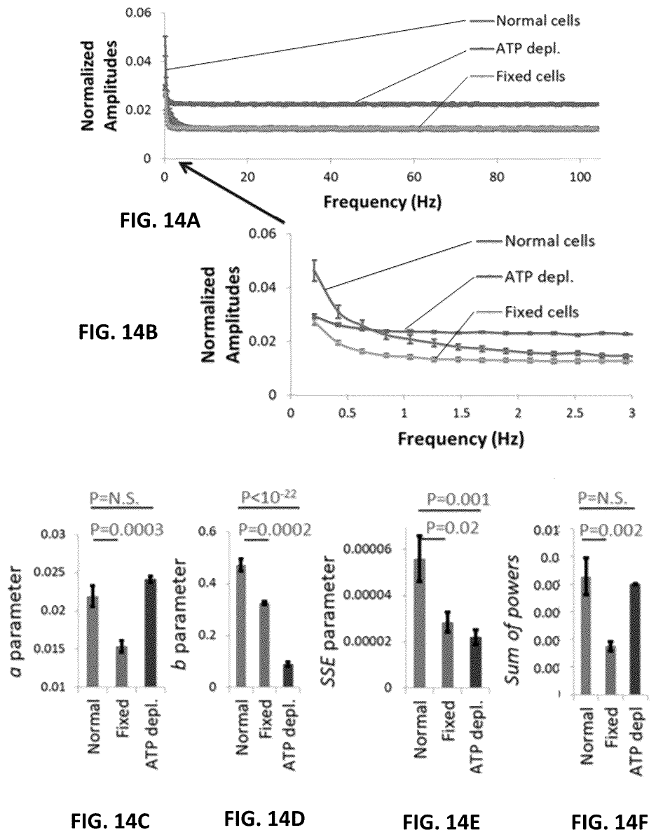

Following this concept, three ranges of frequencies of the amplitude-spectra of the cells were analyzed for autocorrelation: 50-100 Hz, 100-150 Hz, and 150-200 Hz. In each range of frequencies, the average autocorrelation results for each lag, for each cell and for each cellular condition are presented in FIG. 13a-c. According to FIG. 13a, at the 50-100 Hz range, the decay of the autocorrelation function was similar and pronounced for the fixed cells, normal and ATP-depleted cells. At the next frequencies range of 100-150 Hz (FIG. 13b), the fixed and ATP-depleted cells have similar and more pronounced decay relative to the autocorrelation function decay of normal cells. At the last frequencies range of 150-200 Hz (FIG. 13c), the decay was similar and pronounced under all cells conditions. It is assumed that in ATP-depleted cells no significant mechanical work is produced. Following this assumption, it seems that the difference in the decay between normal and ATP depleted cells in 100-150 Hz may be due to a larger extent of mechanical work in normal active cells that reduces the randomness of their amplitudes of vibrations. If elasticity was the main contributing factor in this frequency range, the decay of autocorrelation in fixed cells and ATP-depleted cells are not expected to be similar. This is since the mechanical characteristics of the intracellular medium are very different under these two conditions. Last, at the frequency ranges of 50-100 Hz and 150-200 Hz, autocorrelation decay functions under all conditions are pronounced and similar. This indicates that the measured powers in this frequency range may represent thermal agitation or noise of the measurement system. Differences in the shape of the amplitude-spectra (FIGS. 12a-d), compare panels b with c and d) and related autocorrelation analyses (FIG. 13b) suggest that intracellular mechanical work can be observed and related primarily to the 100-150 Hz frequency range.

So far, intracellular fluctuations as captured by the motion of intracellular particles or by the cell boundaries were described. The fluctuations of the cell membrane may have an impact on the formation and function of the immune synapse that forms between T cells and antigen presenting cells (APCs) [13]. To study such a possible impact, the inventors measured fluctuations of Jurkat cells at their interface with coverslips coated with αCD3ε antibodies. Such coverslips often serve as a model for the immune synapse, as the cells spread on the coverslips and get robustly activated. The membrane of the cells was stained with an αCD45 primary antibody, labeled with Alexa647 and imaged by time-lapse TIRF microscopy. Imaging in TIRF enabled sub-diffraction sensitivity of the intensity signal to membrane fluctuations along the Z-axis (perpendicular to the interface). The cells were imaged using a TiE Nikon microscope and were excited using a 647 mn pulsed laser (90 ps) at 2 mW/cm² (20% power). Samples were imaged using a (CFI-SR-HP) Apochromat TIRF X100, NA of 1.49, oil-immersion objective (Nikon Instruments). For each cell, image stacks were generated by taking 1,000 serial images with an acquisition time of 4.8 ms per individual frame of 128×128 pixels (160 nm pixel size). The reflection light was detected using an avalanche photodiode (APD) with a band-pass filter of 650-720 nm. TIRF images analysis: In each cell, a squared ROI of 121 pixels was chosen at the cell interface with the coverslip. Fluorescence intensity of each pixel in each image was normalized by dividing its intensity with the average intensity of that time-dependent image. The temporal fluctuations of the normalized fluorescence intensities were analyzed by DFT for each pixel in a ROI. The amplitudes of the DFT analyzes were then averaged for each frequency for all the pixels of an ROI to obtain the averaged DFT results of each ROI (or cell) in each condition. Live cells were measured without and after ATP depletion, while fixed cells served for control.

The averaged DFT results of each ROI (or cell) could then be compared between cells and conditions and analyzed by the power fit parameters as presented in FIGS. 14a-f. The amplitude spectral density (ASD) results for frequencies >3 Hz (and up to 100 Hz) were similar for normal cells and cells after fixation (FIG. 14a; green and blue curves). Measured fluctuations in fixed cells were likely due to thermal motion and noise of the measurement system. The thermal fluctuations depend on the mechanical properties (as elasticity or stiffness) of the measured system. In the synapse model used here, the stiffness of the coverslip governed the mechanical properties of the system and the related thermal motion in fixed and live normal cells. Otherwise, and as expected, active fluctuations at that frequency range in live cells could not have been detected (see FIG. 11a). The relatively higher level of thermal fluctuations in ATP-depleted cells is probably due to an interruption of the immune synapse and some disconnection of cells from the stiff αCD3-coated coverslip. At frequencies <3 Hz, membrane fluctuations were significantly higher in normal active cells than in fixed cells and in ATP-depleted cells (FIG. 14b; compare blue curve to green and red curves). Also, the power fit parameters were significantly higher in normal cells relative to fixed cells (FIGS. 14c-14f). Due to the suggested partial disconnection of the ATP depleted cells from the coverslip their thermal/baseline fluctuations were higher and that increased their a and sum of powers parameters values (FIGS. 14c, 14f). Parameters b and SSE are less sensitive to the extent of adhesion of the cells to the coverslip since they depend mostly on the shape of the power-fit curve. Thus, b and SSE capture better the conditions of low intracellular mechanical work in those ATP depleted cells. These results suggest that ATP-dependent cytoskeletal motion significantly contribute to membrane fluctuations at low (<3 Hz) frequencies; and that these fluctuations directly modify the interface of the cells with a TCR-activating surface that mimics the immune synapse.

The same experimental procedure of TIRF imaging of immune synapse model was used by the inventors to monitor and compare cell membrane vibrations in three types of lymphocytes: primary lymphocytes (benign), CD8 (malignant) and Jurkat (malignant). For each cell, 1000 images were captured with a time lag of 4.8 ms between each sequential image. In each cell, the inventors chose for analysis a squared region of interest (ROI) of 121 pixels (the size of a pixel is 0.16 μm) at the cell interface with the coverslip. The temporal fluctuations of the normalized fluorescence intensities were analyzed via DFT for each pixel in that ROI. The amplitudes were then averaged for each frequency for all the pixels of an ROI. The average DFT results of each ROI (or cell) could then be compared between cells.

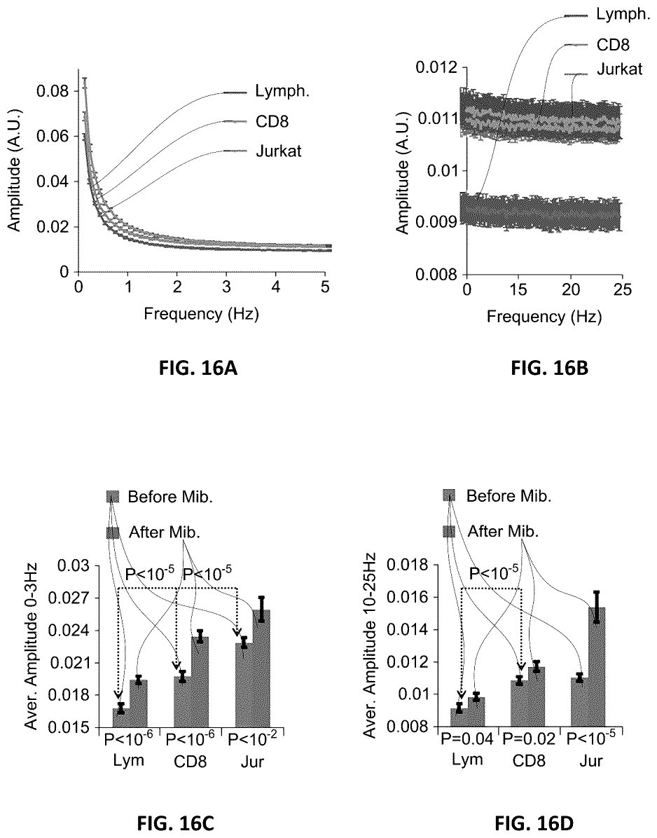

FIGS. 16a-d show fluctuations of the cell membrane of primary lymphocytes (benign), CD8 (malignant) and Jurkat (malignant) cells in a model of the immune synapse imaged by TIRF microscopy, wherein FIG. 16a shows DFT results of fluctuations of normalized intensity of anti-CD45 antibodies labeled with Alexa647, which highlighted the plasma membrane of cells. The cells adhered to coverslips coated with αCD3ε antibodies. Amplitudes of primary lymphocytes (N=192) are in blue, CD8 cells (N=165) are in green and Jurkat cells (N=237) are in red, shown is frequency range of 0-5 Hz. FIG. 16b shows frequency range of 10-25 Hz of the amplitudes in FIG. 16a. FIGS. 16c-16d show average amplitudes results for the primary lymphocytes, CD8 and Jurkat cells in two frequency ranges: 0-5 Hz and 10-25 Hz before and after Mibefradil treatment.

The TIRF microscopy results shown in FIGS. 16a-d clearly indicate that Mibefradil increases cell membrane vibrations in all cell types, and cell membrane vibrations are higher in the malignant cell types (CD8 and Jurkat) in comparison to the benign primary lymphocytes both at low frequencies of 0-5 Hz and at higher frequencies of 10-25 Hz.

The inventors further studied active modes of vibrations of the cytoskeleton and plasma membrane in lymphocytes. Specifically, they analyzed spatial fluctuations of intracellular particles and of the cell diameter utilizing DFT analysis. The cytoskeletal motion was studied by monitoring the motion of intracellular large particles, larger than the cytoskeleton mesh size of around 50 nm. Such particles are typically embedded inside the cytoskeleton. Their motion reflects cytoskeletal fluctuations due to the mechanical coupling between these particles and the surrounding elastic mesh. Cytoskeletal fluctuations could then be also reflected in fluctuations of the cell membrane and its diameter. The amplitudes of vibration of the cytoskeleton were related theoretically and experimentally to the extent of intracellular mechanical work. This allowed further to compare mechanical vibrations in physiologically intact cells in comparison to ATP-depleted cells or cells after treatment with blebbistatin. Focusing on relative changes in the results under these various conditions largely cancels out possible contribution of extracellular effects, which are unchanged between these measurements. The extent of mechanical vibrations in lymphocytes, especially the mechanical vibrations of the plasma membrane, could significantly impact the immune synapse [13].

As described in detail above, the inventors demonstrated the existence of active, ATP-dependent vibrations of the cell membrane of Jurkat T cells after spreading and activation in an experimental model of an immune synapse. In that way, the extent of cellular mechanical vibrations may influence the ability of T lymphocytes to create stable immune synapse and to generate adequate immune response.

There are two main approaches to characterize the complex intracellular medium. If viewed as a highly complex solution, then the motion of intracellular particles could be naturally analyzed in terms of time-dependent translocations and diffusivity. Still the intracellular content can also be viewed as a two-component elastic gel; i.e., an elastic polymeric mesh made of the actin cytoskeleton, immersed in crowded viscous gel. In this case, the medium would be more intuitively analyzed in terms of the spectrum of its vibrations.

The random motion of particles has been theoretically and experimentally investigated through their modes of vibration using PSD analysis. The PSD analysis is classically calculated by first performing a Fourier transform of each individual trajectory x(t) (or y(t)) over the finite observation time T and then averaging the spectral results for a statistical ensemble of all possible trajectories [9] (In some theoretical types of anomalous diffusion this analysis is not integrable. In such cases, the PSD analysis was adopted to use the Fourier transform of the autocorrelation function of the random process, since autocorrelation is integrable. This enabled to characterize the spectral contents of that non-integrable process according to Wiener-Khinchin theorem [11]. In the experiments performed by the inventors the number of measurements was relatively large (100), yet finite. Thus, the particles' displacement results were analyzed by DFT, while the conversion to the autocorrelation function seemed unnecessary. In each cell the results of many particles or trajectories were averaged (average number of trajectories for a cell was 39 with SD of 16) which enabled the inventors to rely on a statistical ensemble for the amplitude spectral density (ASD) or PSD calculations, as in the classic way for calculation of these spectra.

In the case of Brownian motion, the relation between powers of fluctuations and the related frequencies could be described by a power-law equation in the form:

$${μ}_{s} = \frac{c {K}_{α}}{{f}^{2}} \qquad ( 2 )$$

where μs stands for the power, f is the related frequency, K_{α} stands for the diffusion coefficient and c is a constant [10]). From that equation the amplitude of fluctuations, Aₛ, can be defined as

$${A}_{s} = \frac{\sqrt{c {K}_{α}}}{{f}^{1}} \qquad ( 3 )$$

In the case of FBM sub-diffusion, when α<1, the power of the frequency (f) is changed to α+1 (compare to a value of 2 in Brownian motion) [10], [11].

The experimental results obtained by the inventors in living cells follow these theoretical equations. Indeed, the inventors found that the PSD (or ASD) results can be accurately fitted with a power-law equation (Eq. 1). The parameter a derived from the fits to the experimental amplitudes was linearly correlated to the square root of diffusivity and K_{α} results both before and after ATP depletion (FIGS. 8a, 8b). This is expected from the theoretical relation a=\sqrt{cK_{α}}. The values of the power b of the fit to the ASD results were relatively close to 1, as suggested by (Eq. 3) for FBM. Nevertheless, the differences of b from 1 may be attributed to the major differences between intracellular motion and Brownian motion due to elasticity, fractal media, mechanical work and break in ergodicity [1].

Aside from the fit parameters of a and b, the inventors considered two additional parameters: SSE of the power fit and sum of powers of the PSD analysis. The inventors found that all of these ASD- and PSD-related parameters were sensitive to intracellular mechanical work. This intracellular mechanical work augmented the cytoskeletal vibrations via a non-ergodic process. The inventors found that the ASD- and PSD-related parameters could better distinguish mechanically active cells from non-active ATP depleted cells, as compared to the regular MSD-based anomalous diffusion parameters (FIG. 9). The lower sensitivity of the MSD-based anomalous diffusion parameter a to respond to intracellular mechanical work may be related to the fact that ATP depletion reduces the elasticity of the cytoplasm of living cells. Accordingly, the value of a in ATP-depleted cells may be influenced by two opposing effects: First, an increase in a value due to the decrease in elasticity upon ATP depletion [2]; Second, a decrease in a due to the decrease in motivated random forces [2]. On the other hand, the corresponding parameter b of the ASD analysis is influenced also by the break in ergodicity that accompanies the increase in intracellular mechanical work. This sensitivity of b to nonergodic processes may improve its ability to detect the effect of the increase in intracellular dynamics, associated with intracellular mechanical work.

Incoherent forces due to intracellular mechanical work may be applied at different locations on the cytoskeleton, each with its own frequency. Such forces are expected to make the ASD results of cytoskeletal fluctuations more complex, lowering the quality of a fit to a relatively simple power-law model. In this situation the system could be characterized as having relatively high energetic disorder, which directly relates to lower ergodicity. In contrast, ASD results of the same network experiencing only thermal forces (i.e., “white noise” forces that don't have any frequency preference) will more accurately follow a fit of a power-law model. Accordingly, SSE values are higher in normal active cells in comparison to non-active ATP-depleted cells. Again, these differences are due to the addition of mechanical forces and break in ergodicity in active cells. Measuring the parameter of Sum-of-powers is a relatively direct way to evaluate the mechanical energy of the vibrating system—in this case the cytoskeleton.

The calculation procedure of the ASD or PSD fluctuation parameters seems to be simpler and more automatic in comparison to the calculation of MSD parameters. MSD analyses require taking statistical measurements of multiple displacement results that relate to different time-lags for each particle. The cytoskeletal vibrations could be monitored by motion of particles that are embedded within it but also by the motion of its borders—namely, the cortical actin and the adjacent cell membrane. Analyzing fluctuations in cell diameter by ASD and PSD calculations that were conducted in the same cells before and after ATP-depletion revealed compatible results with the ASD and PSD analysis of intracellular particles motion. The power fit parameters of cell diameter fluctuations a·b and the sum of powers were higher in normal active cells, as compared to the same cells after ATP depletion.

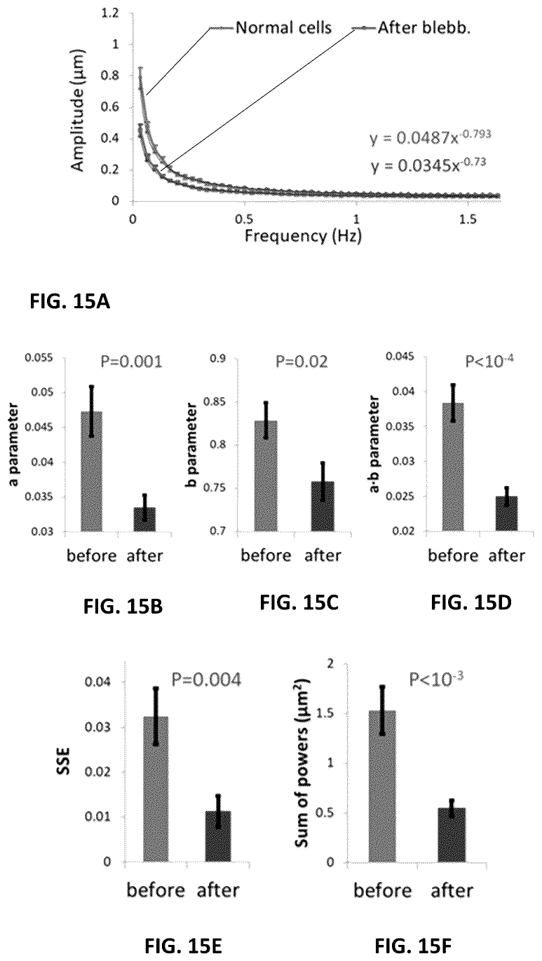

The confocal microscope line-scan imaging of fluctuations of the cell diameter, detailed above, enabled to conduct ASD analyses over a wide range of frequencies. Thus, the inventors could define several specific ranges of frequencies, each with a dominant underlying mechanism (FIG. 11a). These mechanisms control the amplitude of the cytoskeletal fluctuations in their related spectral range, as follows: At 0-3 Hz cytoskeletal fluctuations are governed by incoherent fraction of ATP-dependent molecular motors (such as myosin II) forces, as suggested by Guo et al. (2014) [2]. This mechanism may also explain the detailed above DIC results of the motion of intracellular particles that were measured in similar lower frequencies (FIGS. 7a-f). To further support this suggested mechanism the inventors conducted similar experiments to those presented in FIGS. 7a-f with cells treated with the myosin II inhibitor blebbistatin (FIGS. 15a-f). The effects on intracellular motion of blebbistatin treatment and ATP depletion were similar (compare ergodicty and FIGS. 15a-f). These findings support the role of myosin II motors in the generation of our described intracellular mechanical work and active motion. At the successive range of frequencies below 100 Hz, thermal agitation dominates. This was also suggested by Guo et al. (2014) [2] and is also supported by the current findings (FIG. 13a). Interestingly, analysis of cell diameter fluctuations at 100-150 Hz indicated that active, ATP-dependent mechanical fluctuations likely dominate in this frequency range. Active mechanical tension fluctuations and tension generation of the cortical actin may explain these results [12].

It is noted that the T cell surface is covered with mobile microvilli. Microvilli mobility has been shown to depend on actin remodeling and occurs over time scales of seconds to tens-of-seconds [14]. Since inventors' measurements of cell diameter rely on the identification of a stain of the plasma membrane, they could in principle capture some of the microvilli dynamics and interfere with the diameter measurements. However, the (frequency) spectra of the presently disclosed subject matter are focused on relatively faster processes (of 0.5-3 Hz) than actin remodeling [15]. Moreover, it was shown in previous studies by the inventors that the measured spectra correlate with forces and volume changes that occur at the borders of the cell with similar spectra to inventors' current measurements [12]). These findings support that active cell fluctuations dominate the measured spectra detailed herein. Still, a possible contribution from microvilli dynamics on these measurements cannot be completely ruled out at the lowest frequencies.

In addition to known in the art microscopic techniques, i.e. DIC, confocal microscopy and TIFR microscopy, the inventors have used the novel speckle-based imaging technique, as described above and exemplified in FIGS. 1B and 3A-3F. The inventors have found that using speckle-based imaging technique, preferably utilizing the optical scheme of normal incidence illumination and collection channels with respect to the tissue surface of focused coherent light and detection of the collected light by a pixelated detector, enables to obtain the image of the surface with the speckle pattern superimposed with the image, which provides for high-sensitivity capturing of the vibrations of the tissue surface (associated with vibration of cells' membranes and intracellular particles' movement). Also such a speckle-based imaging system can be advantageously used in a relatively thin scope tube of a diagnostic medical device for the purpose of in-vivo diagnosis of malignant tissues.

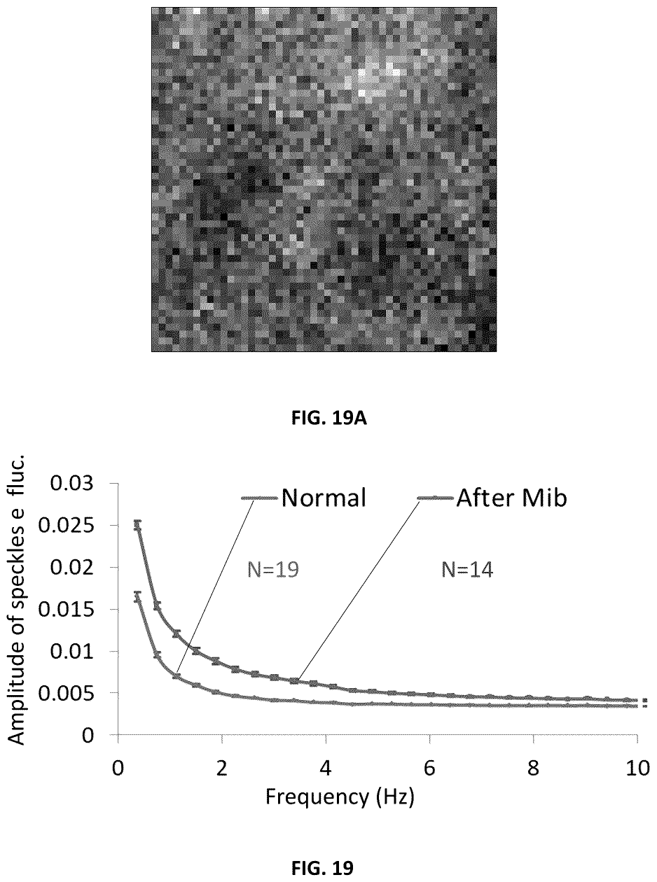

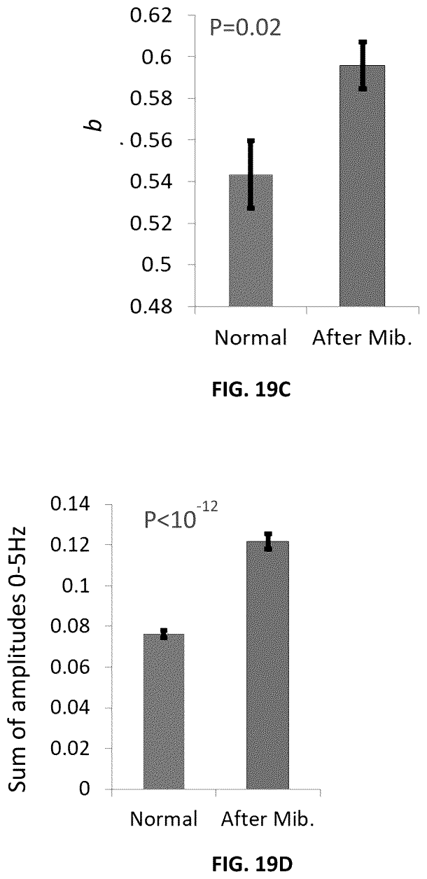

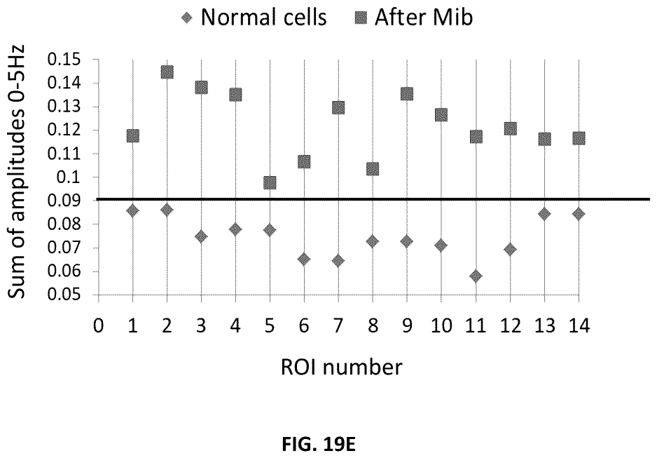

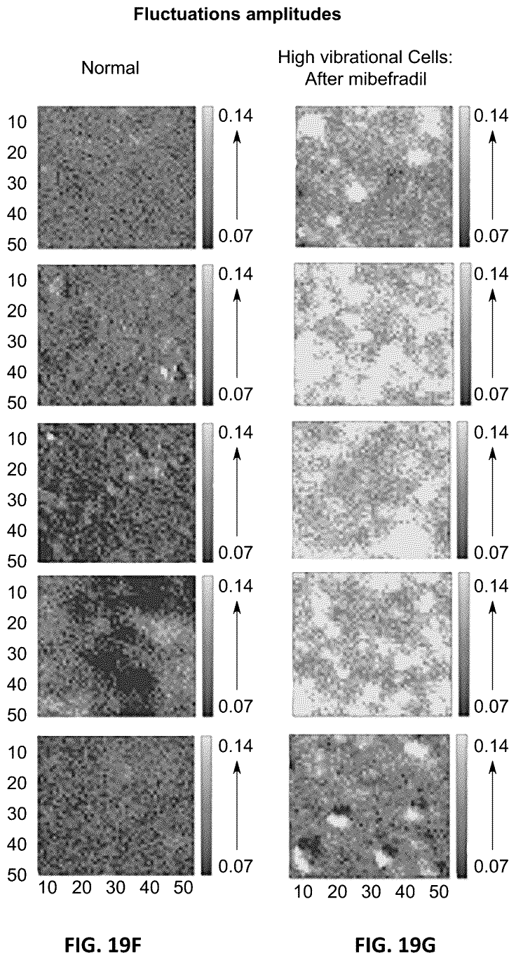

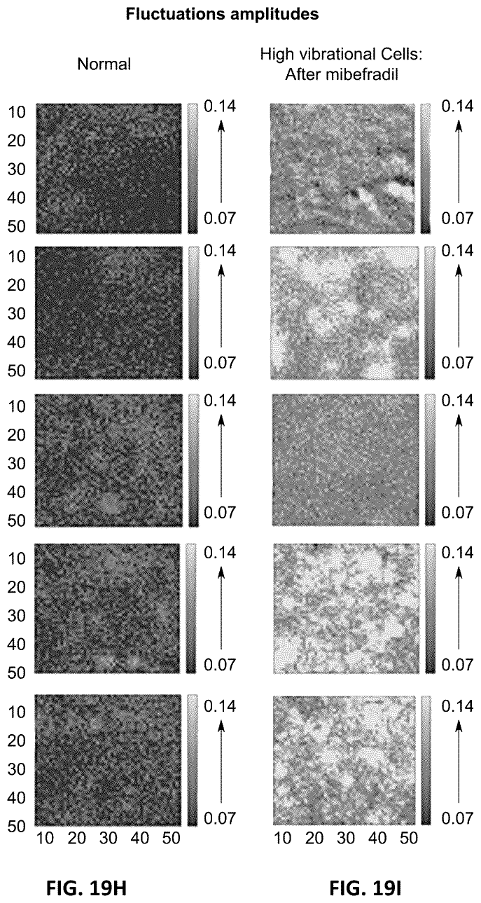

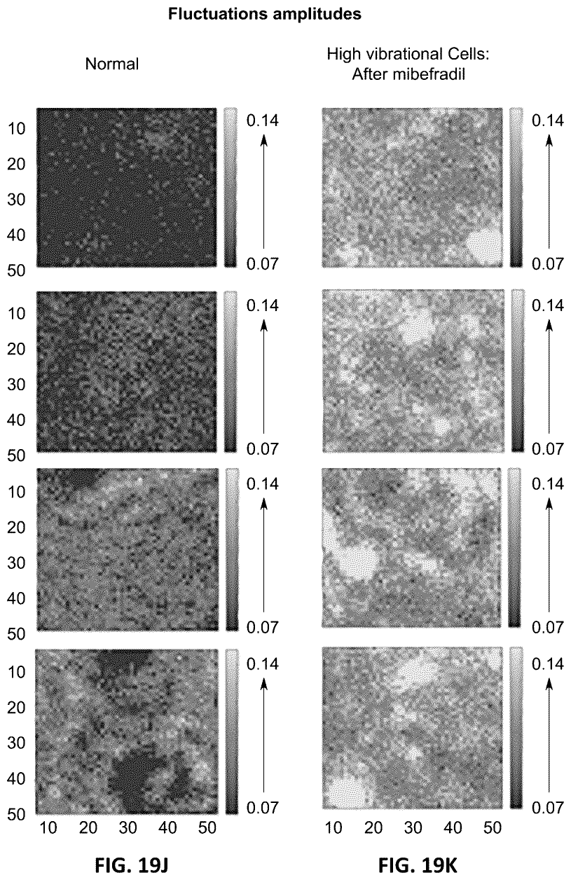

The inventors have used the above-described imaging system 120 (the experimental set up was built by modifying an inverted fluorescence microscope set up) to acquire the sequence of tissue's images-one such image is shown in FIG. 19A. The image data analysis described above were then used to determine cell vibrations at the surface of aggregation of cells before and after the augmentation of cell membrane vibrations using mibefradil.

Mibefradil is a selective blocker of cell membrane calcium channels with greater selectivity for T type (low voltage) calcium channels. The inventors have shown that mibefradil treatment relates to an increase in mechanical vibrations of the cells' membrane. Therefore, by blocking these specific calcium channels mibefradil can reduce tension generation of the cortical actin (by inhibiting myosin-actin interactions) making it softer, which enables more fluctuations of its adjacent plasma membrane.

FIG. 19B shows results of DFT analysis of fluctuations of normalized speckles' intensities. FIGS. 19C and 19D show power fit parameters for the ASD analysis results in the cells (shown in FIG. 19B) before and after mibefradil treatment: parameter b (FIG. 19C) and sum of amplitudes in the 0-5 Hz range (FIG. 19D). Multiple areas of cells (N=14) were measured and compared each before and after mibefradil treatment. When amplitudes in the 0-5 Hz range of the multiple areas of cells (N=14) before and after mibefradil treatment were plotted (FIG. 19E) it could be concluded that a threshold, allowing classification of active/inactive cells, may be defined, and is marked on FIG. 19E by a black horizontal line. The efficient detection of cells' surface vibrations by the novel speckle-based imaging technique was further demonstrated by comparing fluctuation amplitudes in these 14 ROIs (14 areas) of normal cells (FIGS. 19F, 19H, 19J) vs. the same 14 ROIs of these high-vibration cells after mibefradil (FIGS. 19G, 19I, 19K).

Further support for the advantageous use of the speckle-based imaging technique of the presently disclosed subject matter in the detection of malignant superficial tissues is provided from the experimental results comparing healthy primary lymph cell with Jurkat-malignant live cells. Multiple areas-ROIs (N=22) of aggregation of primary lymphocytes (benign) were imaged as detailed in FIG. 3E. Utilizing the same image procedure, multiple areas-ROIs (N=16) of aggregation of Jurkat malignant cells were imaged and the ROIs' results from both cell type aggregates were compared.

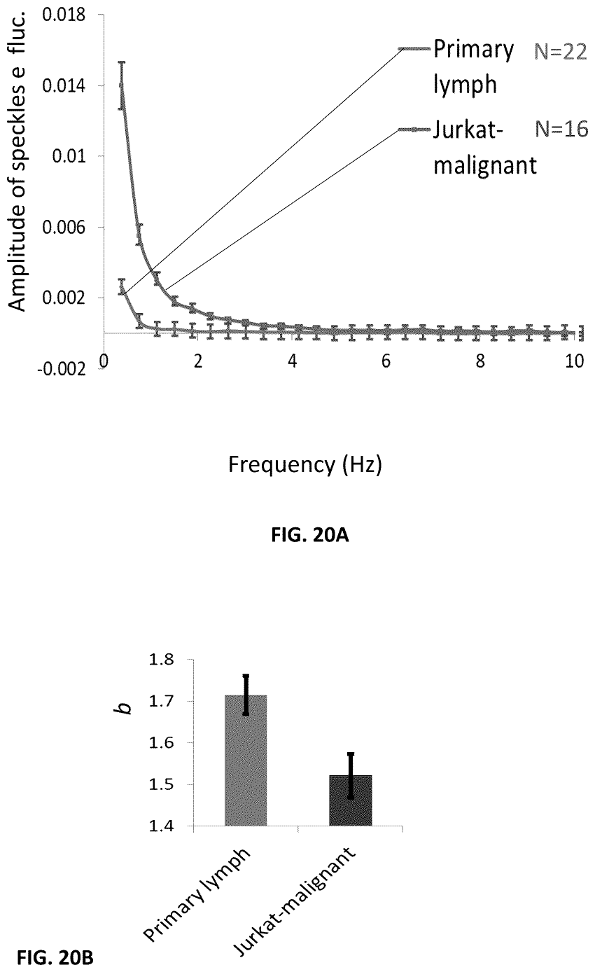

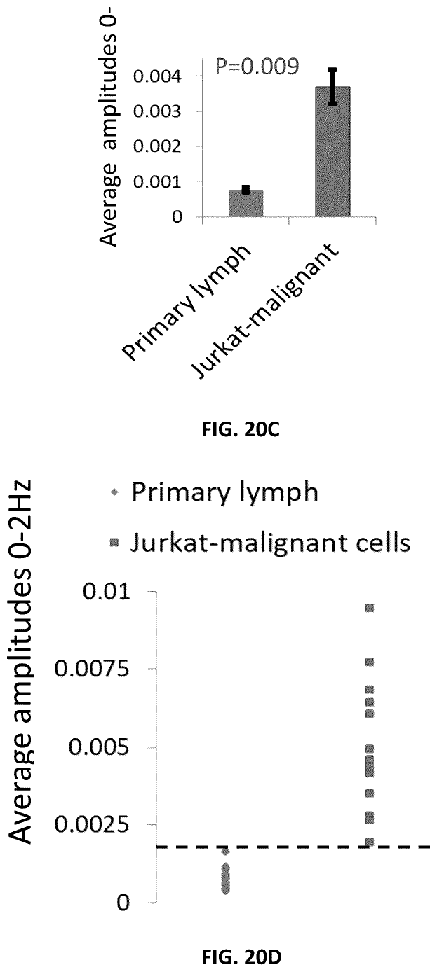

FIGS. 20A-20D show results of dynamic reflective laser speckled imaging of normal primary lymph cells and Jurkat malignant cells. FIG. 20A shows DFT results of fluctuations of normalized speckles' intensities. As expected, based on the theory and results presented above, malignant cells show higher amplitudes of fluctuation, especially in 0-2 Hz frequency range. FIGS. 20B-20C show power fit parameters for the ASD analysis shown in FIG. 20A. In particular, b parameter (shown in FIG. 20B as a bar graph) is higher in Jurkat-malignant cells as compared to normal lymph cells, reflecting more active mechanical work occurring in the malignant cells. Average amplitudes of cell membrane vibrations in the 0-2 Hz range, obtained from the DFT analysis are shown in FIG. 20C and are in agreement with the above-discussed assumption that increased low-frequency (<3 Hz) membrane fluctuations may enable malignant cells to escape immunological surveillance. A scatter plot, shown in FIG. 20D compares average amplitudes in the 0-2 Hz range of individual areas of primary lymph and Jurkat malignant cells, and a dashed horizontal line in black marks a possible threshold allowing classification of malignant cells with ~100% accuracy.

TCR activation has been shown to be a dynamic process, in which the TCR-pMHC bond is repeatedly ruptured and reconnected by perpendicular forces to the immune synapse plane. Rupture forces acting on the TCR-CD3-pMHC bond promote conformational changes of the TCR chains that promote TCR activation [13]. Specifically, these conformational changes enable exposure and phosphorylation of immunoreceptor tyrosine-based activation motifs (ITAMs) on the TCR intracellular chains and further propagation of T cell activation signals [16]. Here, the inventors have shown that cytoskeleton vibrations may result in corresponding vibrations of the cell diameter and plasma membrane. The matching of the TCR-CD3-pMHC bond strength and pulling forces at the synapse could enable specificity of the TCR response. Repeated triggering of the TCR by cell vibrations could further provide sensitivity and specificity to this response [13]. The described force strength and frequency through this process are around 10 pN and 1 Hz [17]. According to inventors' results of cell diameter fluctuations (FIG. 11b), the perpendicular component of the cell membrane fluctuations at 1 Hz has an amplitude of ~16 nm. From previous AFM measurements [12]), the tension fluctuations of the (Jurkat) cell surface at 1 Hz have an amplitude of ~0.001 μN/μm. Multiplying the tension fluctuations of 0.001 μN/μm and spatial movements of 16 nm produces forces of ~16 pN due to this motion. Thus, the inventors conclude that the scales of forces and frequencies related to their measured membrane fluctuations are suitable for activating engaged TCRs at the immune synapse. In that way, lymphocyte vibrations may control or interfere with the T cells' ability to respond to important immunological stimuli.

The inventors studied intracellular and membrane vibrations in Jurkat cells that originated from human leukemic T cells. Malignant cells typically have increased active mechanical fluctuations at relatively low frequencies (below 3 Hz) [2,3]. They also have a softer surface [7,8], which depends mainly on the degree of cortical actin tension. If indeed fluctuations of the T cell membrane contribute to sensitivity and specificity of TCR-pMHC interactions, these properties of (non-adherent) malignant cells could hinder the ability of the T cell to properly recognize and react against the malignant cells. Specifically, the T cell may not be able to accurately evaluate the affinity of the TCR-pMHC bond, and to create repeated and sufficient TCR deformations for maximal triggering of the TCR. By this mechanism, transformed cells may escape immune surveillance and killing by cytotoxic T cells.

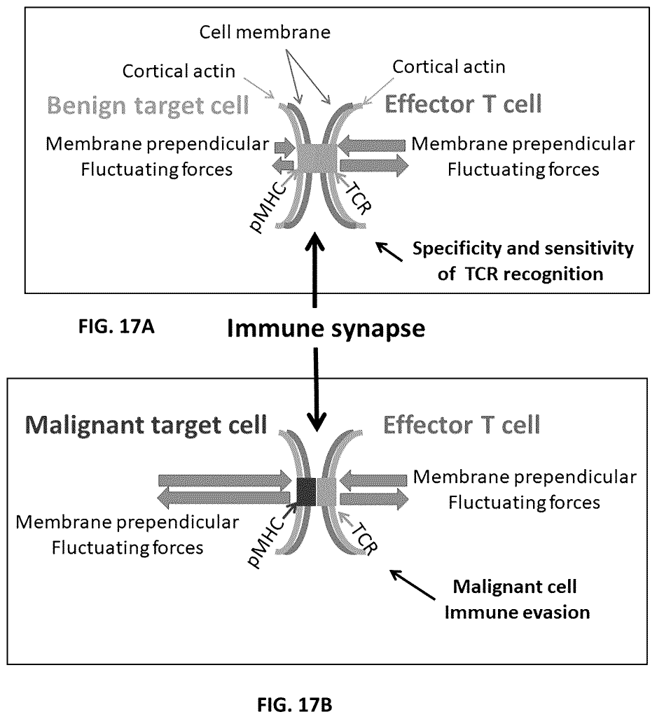

Reference is made to FIGS. 17A and 17B which schematically illustrate possible effects of cell membrane fluctuations on T cell function. FIG. 17A illustrates an immune synapse between an effector T cell with its specific TCR and a benign target cell with a complimentary pMHC. Both cell membranes and their attached cortical actin are mechanically vibrating but to a different extent. Resultant perpendicular forces act on the TCR-pMHC complex, leading to its modified lifetime. The benign target cell membrane is relatively firm and stable. The more pronounced membrane fluctuations of the effector T cell could effectively produce repeated and precise rupture forces on the TCR-pMHC complex to generate effective cellular response. A similar illustration of an immune synapse between effector T cell and a malignant target cell is shown in FIG. 17B. The malignant target cell membrane and its underlying cortical actin are less firm and fluctuate more relative to benign cells (as in FIG. 17A). The fluctuations of the effector T cell are milder relative to the membrane fluctuations of the malignant target cell. Thus, the TCR-pMHC complex is subject to incoherent forces, abrogating precise and organized activation of the TCR and the effector T cell. This may further lead to possible immune evasion of the malignant cell.

As described above, living cells can change their dynamical and mechanical properties in relation to their physiological or pathophysiological state. In that regard, malignant cells have higher level of intracellular mechanical work and higher active (ATP-dependent) and indirect dynamics. The source of the higher indirect dynamics is from dissipation of intracellular mechanical work processes. The inventors have shown that this higher intracellular active and indirect dynamics is reflected by higher vibrations of the cell surface. This cell surface is defined by the cell membrane, which is mechanically attached to the cortical actin part of the cytoskeleton. Malignant cells are also softer than their correspondent benign cells. According to that, malignant tissues differ from their neighboring normal tissues regarding their mechanical properties and dynamics. Analyzing the cells surface or tissue surface vibrations reveals those differences.

The inventors have utilized perpendicular reflected laser speckles for measuring and analyzing cells surface dynamics and textures. The results reveal major differences regarding those parameters between malignant and their matched benign cells in 5 different cancer types. Those major detected differences of cells surface characteristics enable a very accurate differentiation between malignant and benign cells.

The inventors have built a handy prototype system, and further extended the measurements to multiple types of skin lesions in volunteers. The inventors have demonstrated the ability of the initial prototype to classify common and prevalent benign skin lesions very accurately, indicating the high sensitivity and efficiency of this diagnostic tool. Such a system can be used for pre-clinical measurements in-vivo and in animal models of subcutaneous implanted malignancies. The results of such pre-clinical experiments in mice and in human volunteers will be described below. As expected, these results have also shown a robust ability of the technique of the present disclosure to differentiate malignant from benign skin lesions.

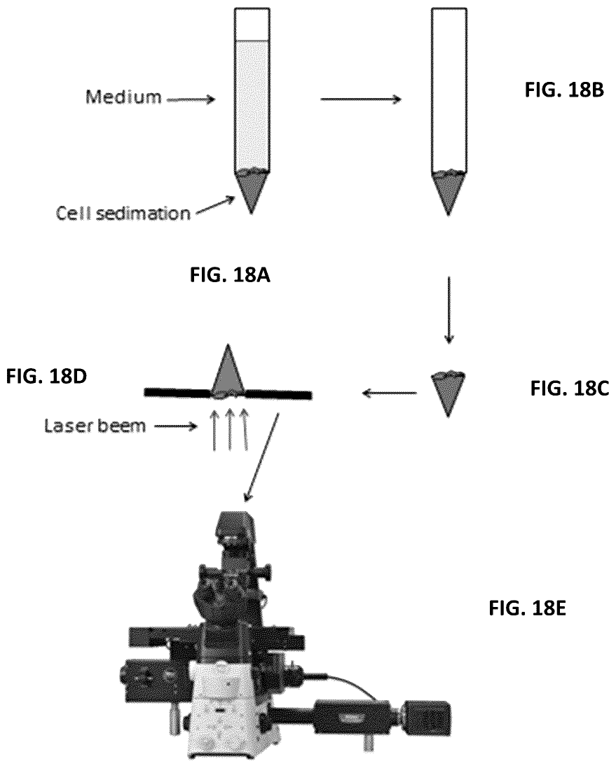

In the following sections the results of the experiments conducted by the inventors are presented with reference to FIGS. 18-32.

Reference is made to FIGS. 18a-e showing experimental procedure for the preparation of an in-vitro model for tissue cell surface of malignant and benign cells.

The inventors used perpendicular laser reflection/scattering from cellular surfaces from multiple cell lines and analyzed the dynamics and structure of the laser-induced speckles patterns. These patterns reveal the underlying cellular differences in dynamics and texture between malignant and benign cells. The imaged speckle size is to match the length-scale of those textural and dynamics differences. Accordingly, the inventors used a laser with a 0.647 μm wavelength and ×10 magnification with a 1.6 μm pixel size. In order to model in vitro the surface of malignant and benign tissues, the cells were sedimented from malignant and matched benign cellular cultures on the bottom of a laboratory tube. The inventors took out the above medium liquids and then imaged the surface of those plaques of cells (FIGS. 18a-e): The laboratory tube with the sediment of cells and above the cellular medium (FIG. 18a), the laboratory tube after the removal of the cellular medium (FIG. 18b), cutting and removing the upper part of the tube to leave only its lower part that contains the sediment of cells (FIG. 18c), putting the lower part of the tube on the microscope stage to directly illuminate and analyze the cells surface (FIGS. 18d-e).

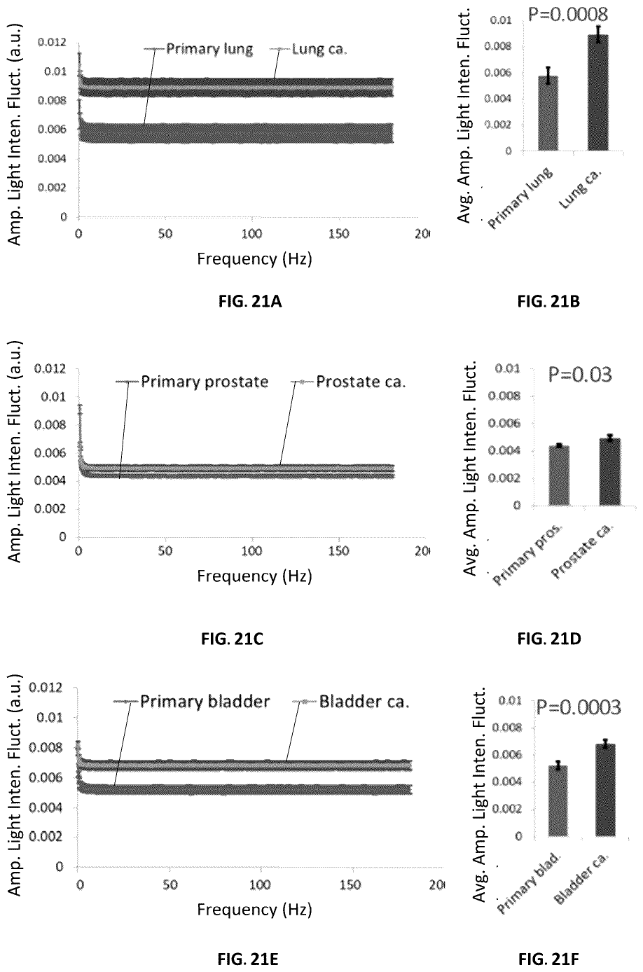

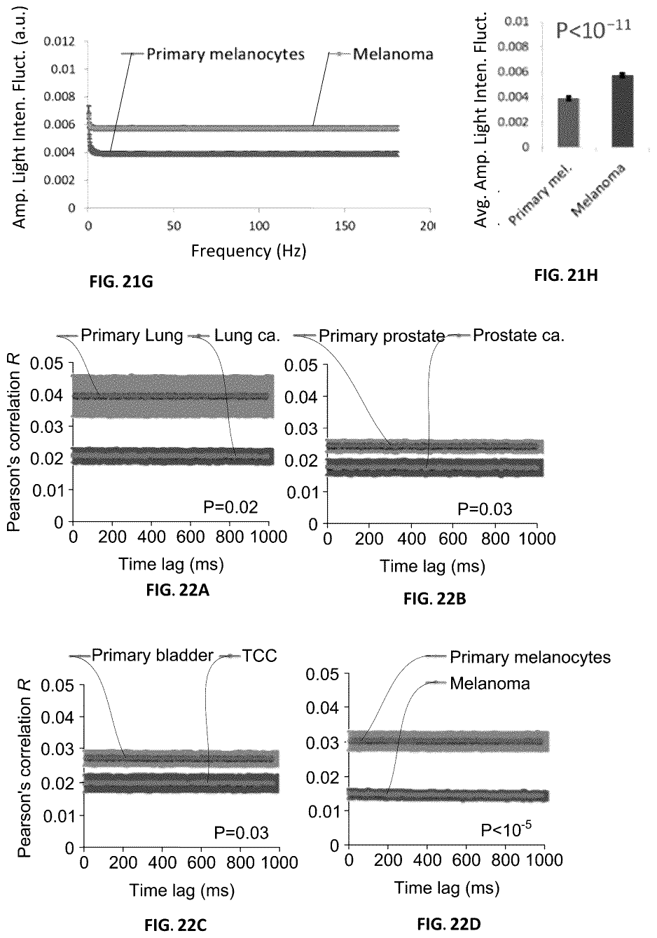

In each malignant and in each matched benign plaque of cells, between 30 and 40 different rectangular areas with a size of 50×50 pixels (80×80 μm) were measured for the laser speckles analysis. Each measurement area of 50×50 pixels was imaged repeatedly 1000 times with a time interval of 2.6 ms between each sequential image. The laser light illuminated the cellular surface and then reflected or scattered back from that surface, inspected by the CCD detector. The position of the detector was stationary at the axis of the incident light. For the analysis of the stacks of images (each stack with 1000 images of 50×50 pixels) from the different measurement fields, the basic parameters of DFT, autocorrelation and Pearson correlation coefficient R between each two images with different time lags between them have been chosen. The inventors calculated those parameters results for 4 types of benign and their matched malignant cell lines: primary lung air way epithelium cells, primary prostate epithelial cells, primary bladder epithelium cells and primary melanocytes cells and their matched malignant cell lines. These results are summarized in FIGS. 21-23.

FIGS. 21a-h illustrate the experimental results of vibrations in cell sediments of malignant vs. matched benign (primary) cells. FIGS. 21a, 21c, 21e, and 21g show amplitude spectrum of light intensity fluctuations for primary cells (lung N=32 (FIG. 21a), prostate N=36 (FIG. 21c), bladder N=32 (FIG. 21e) and melanocytes N=40 (FIG. 21g)) vs. their corresponding malignant cells (lung N=26, prostate N=44, bladder N=39 and melanoma N=38 cancers); FIGS. 21b, 21d, 21f, and 21h show the respective averaged amplitudes, compared between the benign and malignant cells in FIGS. 21a, 21c, 21e, and 21g. As can be seen in FIGS. 21a-h and, as expected, the DFT amplitudes results of all the malignant cell lines are clearly higher than their benign matched cell lines.

FIGS. 22a-d illustrate the experimental results of Pearson's R values in cell sediments of malignant vs. matched benign (primary) cells, when the Pearson's R values of the intensities in each ROI of different images were analyzed for different time lags. FIG. 22a shows R values in primary lung cells in comparison to malignant lung cells (N=32 for primary lung, N=26 for lung cancer), FIG. 22b shows R values in primary prostate cells in comparison to malignant prostate cells (N=39 for primary prostate, N=38 for prostate cancer), FIG. 22c shows R values in primary bladder cells in comparison to malignant TCC cells (N=35 for primary bladder, N=39 for TCC), and FIG. 22d shows R values in primary melanocytes cells in comparison to malignant melanoma cells (N=40 for primary melanocytes, N=49 for malignant melanoma cells). The amplitudes of R parameter in all the malignant cell lines were lower than the R parameter amplitudes in their benign matched cells, which was also expected due to the higher dynamics in the malignant cells.

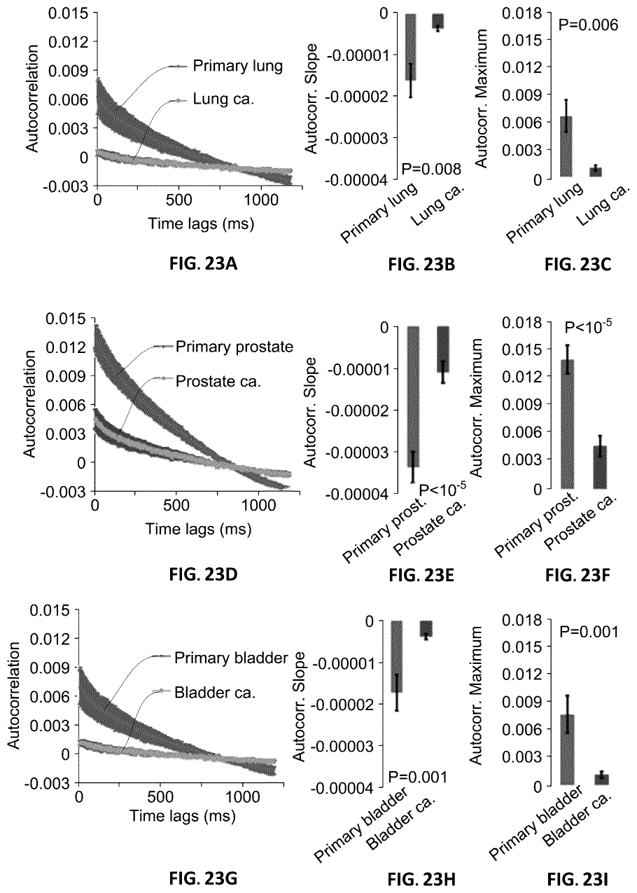

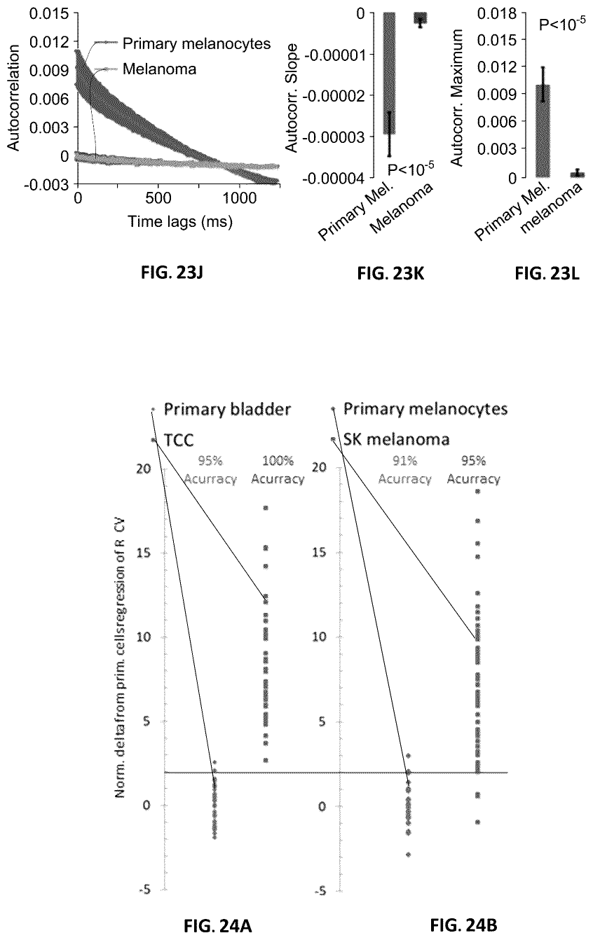

FIGS. 23A-I illustrate the autocorrelation values and decay in cell sediments of malignant vs. matched benign cells, wherein FIGS. 23A, 23D, 23G, and 23J show the autocorrelation of light fluctuations for primary cells (lung N=32 (FIG. 23A), prostate N=36 (FIG. 23D), bladder N=32 (FIG. 23G) and melanocytes N=40 (FIG. 23J)) vs. their corresponding malignant cells (lung N=26, prostate N=44, bladder N=39 and melanoma N=38 cancers). FIGS. 23B, 23E, 23H, and 23K show the autocorrelation slope and FIGS. 23C, 23F, 23I, and 23L show the autocorrelation maximum, compared, respectively, between the benign and malignant cells in FIGS. 23B, 23E, 23H, and 23K. The Autocorrelation maximum and slope were significantly lower in all the malignant cell lines which implies more arbitrary cell surface motion in those cells.

In addition, the inventors calculated the variation of the basic R parameter (i.e., the coefficient of variance (CV) of the temporal variation of R) with proper normalizations. Using the CV(R) parameter allowed to differentiate measurements areas (50×50 pixels) of Transitional Cell Carcinoma (TCC) and melanoma cell surfaces from measurements areas of their matched primary benign cells (Primary epithelial bladder cells, and primary epidermal melanocytes) with accuracies of 97.5% and 93%, respectively.

FIGS. 24a-b illustrate the experimental results, in the form of the normalized delta from primary cells regression of R CV parameter results in malignant versus match benign cells tissues model, demonstrating the use of CV(R) parameter to differentiate measurements areas (50×50 pixels) of Transitional Cell Carcinoma (TCC) and melanoma cell surfaces from measurements areas of their matched primary benign cells (Primary epithelial bladder cells, and primary epidermal melanocytes) with accuracies of 97.5% and 93%, respectively, wherein FIG. 24a shows the Normalized delta from primary cells regression of R CV parameter results in Transitions cell carcinoma (TCC) cells (N=34) and primary bladder epithelial cells (N=41), and FIG. 24b shows the Normalized delta from primary cells regression of R CV parameter results in malignant melanoma cells (N=62) and primary epidermal melanocyte cells (N=23).

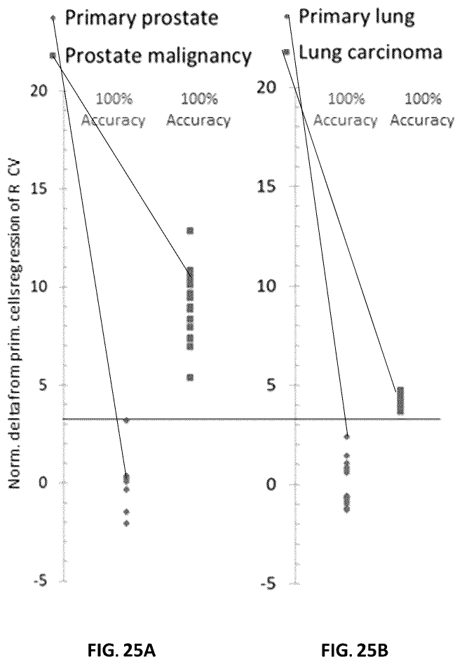

FIGS. 25a-b illustrate similar experimental results, in the form of normalized delta from primary cells regression of R CV parameter results in malignant versus match benign cells tissues model for malignant lung carcinoma cells, malignant prostate carcinoma cells and their matched benign primary epithelial cells, wherein FIG. 25a shows the Normalized delta from primary cells regression of R CV parameter results in prostate carcinoma cells (N=20) and primary prostate epithelial cells (N=8), and FIG. 25b shows the Normalized delta from primary cells regression of R CV parameter results in malignant lung carcinoma cells (N=37) and primary lung epithelial cells (N=14). These results show that the malignant cell lines could be differentiated from their benign matched cells with high level of accuracy.

Taken together, the results on the in vitro cell-line models of 4 different solid tumors and of leukemia indicate a common biophysical mechanism that enables their differentiation from benign matched cell lines. Thus, the technique of the present disclosure, utilizing perpendicular laser speckles analysis, is applicable to the detection of many types of malignancies.

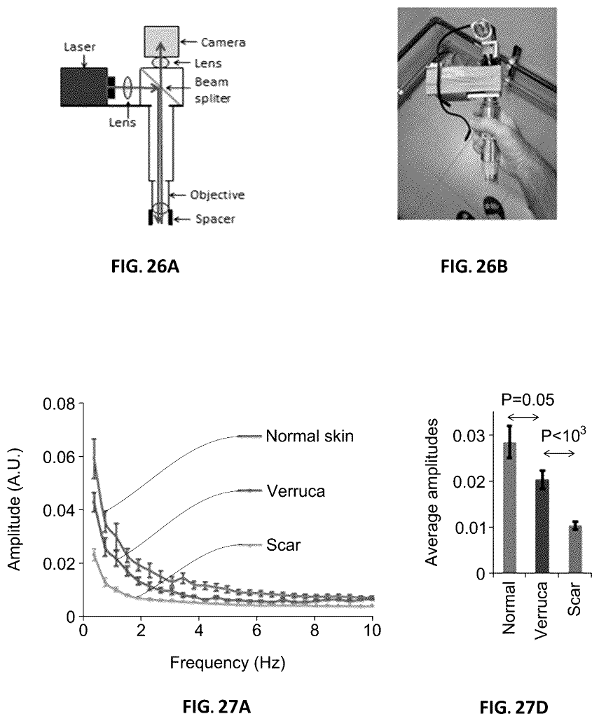

The inventors have developed and assembled a basic, yet portable prototype system for the investigation of living tissues using the technique of the present disclosure of perpendicular laser speckles analysis. FIG. 26b shows an image of this prototype system (probe) and FIG. 26a shows a scheme of its components.

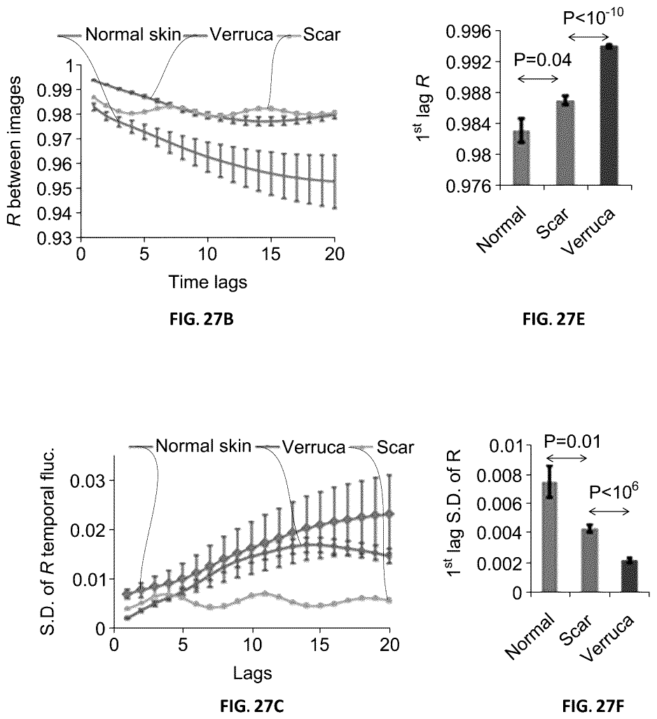

For the initial evaluation of this system, the inventors applied it on human skin to analyze a scar tissue and a verruca and compared those results to results from normal neighboring skin. For each measurement area of 50×50 pixels, 1000 consecutive images were captured with a time interval of 3.3 ms between following images. The magnification of ×2.5 with a pixel size of 1.38 μm was used. The results of the R parameters and DFT are presented in FIGS. 27a-f for in vivo investigation of skin lesions for each tissue condition: scar, verruca, and normal skin. More specifically these figures show a verruca (N=12) and a scar (N=11) in comparison to neighboring normal skin (N=12), where FIG. 27a shows DFT results in the frequency range <10 Hz in verruca, scar and normal skin, and FIG. 27d shows average amplitudes in the frequency range <3 Hz for each condition. FIG. 27b shows the average R parameter results for different time lags in each skin condition, and FIG. 27e shows the average R parameter results for the first time lag in each skin condition. FIG. 27c shows the average results of the standard deviation of the temporal fluctuation of the R parameter for different time lags in each skin condition, and FIG. 27f shows the average results of the standard deviation of the temporal fluctuation of the R parameter for the first time lag in each skin condition (error bars in FIGS. 27 a-c are SEM).

Regarding the R parameter, the inventors calculated its average value for each time-lag and also the standard deviation for each time lag of that parameter fluctuation over the multiple time-dependent measurements. For each condition, 11-12 areas were measured and analyzed. As can be seen in FIGS. 27d-f, for all the three parameters that were calculated (average amplitudes (for f<3 Hz), 1^{st} lag average R, 1^{st} lag standard deviation of R) the results are significantly different for the normal tissue, the verruca, and the scar. By observing all the calculated data that is presented in the three graphs: FIG. 27a, FIG. 27b and FIG. 27c, it can be seen that there are differences in the response of those basic parameters to the increasing frequencies (or time-lags). It should be noted that more parameters can aid in the discrimination of those different tissue conditions and others. These results clearly demonstrate the ability of the technique of the present disclosure to differentiate different pathological conditions of tissues. Malignancy is such a main pathological condition that relates to a very significant change in the tissue mechanical and dynamical properties.

The inventors have further extended their experiments with the basic prototype system to a larger number of human volunteers, to demonstrate the ability of the system to accurately differentiate and classify multiple common benign skin lesions. Measurements were performed in 5 volunteers for 5 types of common benign skin lesions: nevuses (N=4), hemangiomas (N=3), dermatofibromas (N=2), verrucas (N=3) and scars (N=2). The measurement procedure was conducted as previously described, capturing during 3 sec a stack of 1000 images for each measurement session. Prior to analysis, the raw measured data (pixels light intensities) was normalized.

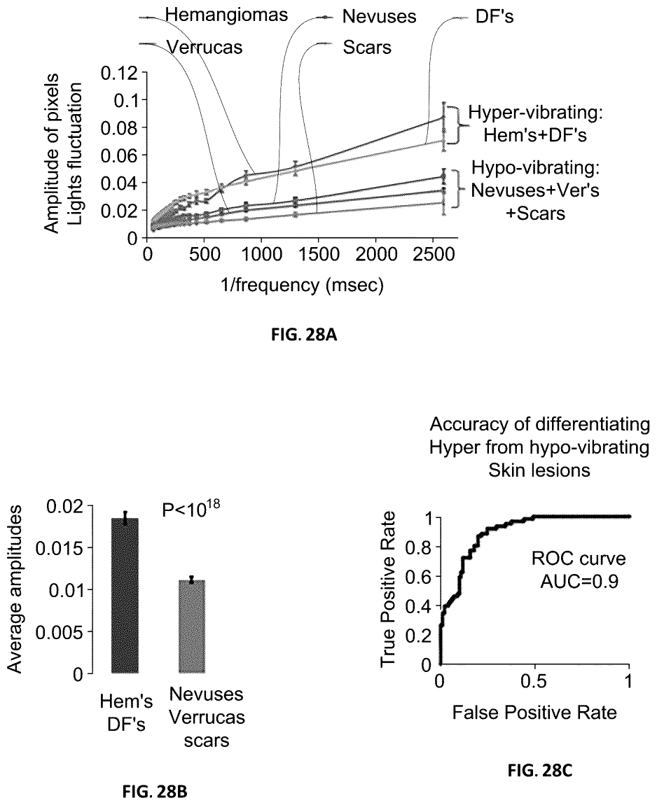

In this connection, reference is made to FIGS. 28a-c showing the results for perpendicular laser speckles analysis for in vivo investigation of multiple skin lesions in a group of volunteers (N=5): hemangiomas (N=3), Dermatofibromas (N=2) nevuses (N=4), verrucas (N=3) and scars (N=2). FIG. 28a shows average DFT results of pixels intensities temporal fluctuations for each type of skin lesion, FIG. 28b shows the average DFT amplitudes in the group of hyper-vibrating skin lesion (hemangiomas and dermatofibromas) in comparison to the average amplitudes in the group of hypo-vibrating skin lesion (nevuses, verrucas and scars), and FIG. 28c shows the accuracy of differentiating between hyper and hypo-vibrating skin lesions using a single measurement of 3 sec duration. Error bars in panels a and b are SEM.

To characterize the variance in the results, the measurements were repeated 7-20 times for each lesion. The average results of the temporal fluctuations of the pixels light intensities for each type of skin lesion are presented in FIG. 28a. As can be seen in those results and in FIG. 28b, the amplitudes of the pixels intensities fluctuations are higher in hemangiomas and dermatofibromas, in comparison to those amplitudes in nevuses, verrucas and scars. Accordingly, the first two skin lesions were next classified as hyper-vibrating skin lesions, and similarly—the three last skin lesions were next classified as hypo-vibrating skin lesions. As demonstrated in FIG. 28c, classification of each single measurement to those two groups of skin lesion could be done accurately with AUC (area under the ROC curve)=0.9. After this initial classification to either hyper or hypo-vibrating skin lesions, the inventors proceeded with further sub-classification.

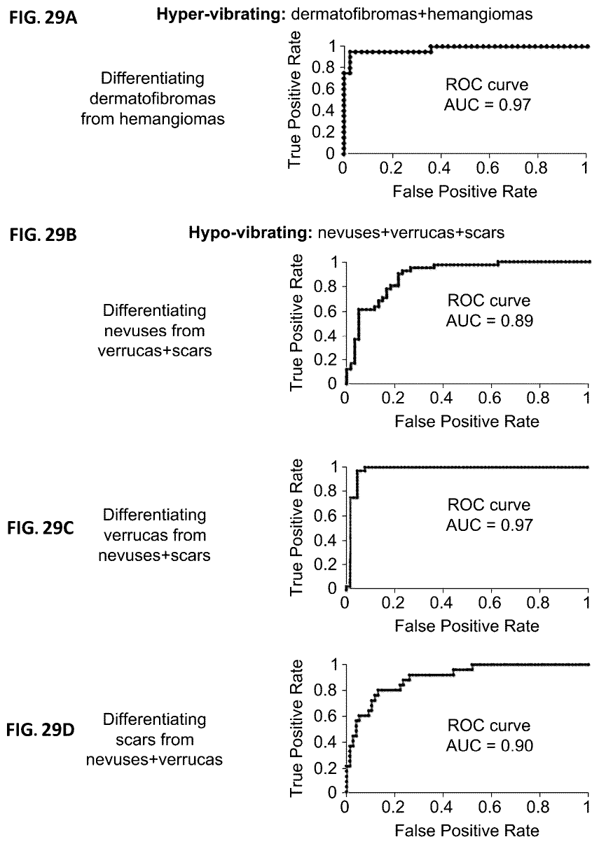

This classification distinguished the specific type of skin lesion, as demonstrated in FIGS. 29a-d illustrating the accuracy of differentiating each of the 5 types of measured skin lesions: hemangiomas, dermatofibromas, nevuses, verrucas and scars utilizing a single 3 sec duration measurement. FIG. 29a shows the accuracy of differentiating the hyper-vibrating lesions: hemangiomas from dermatofibromas, and FIGS. 29b-d show the accuracy of differentiating each of the hypo-vibrating lesions: nevuses (FIG. 29b), verrucas (FIG. 29c) and scars (FIG. 29d). For this latter sub-classification, 4 parameters were utilized: The spatial CV of light intensities in the measured area of 50×50 pixels, the spatial average of amplitudes related to a predetermined frequency in the measured area of 50×50 pixels, the spatial standard deviation of amplitudes related to a predetermined frequency in the measured area of 50×50 pixels, and the spatial CV of amplitudes related to a predetermined frequency in the measured area of 50×50 pixels. As shown in FIGS. 29a-b, the accuracy of classifying each specific skin lesion is high (AUC between 0.89 and 0.97), even for a single and short measurement of 3 sec. Using multiple measurements provides for further increasing the AUC values and accuracy.

Thus, the ability of this first initial prototype to classify common and prevalent benign skin lesions in an accurate way indicates the high sensitivity and efficiency of this diagnostic tool. It also indicates that the system/technique of the present disclosure can accurately classify malignant tumors in-vitro, as well as pre-clinical measurements in-vivo, in animal models of subcutaneous implanted malignancies.

The following is the description of the experiments conducted by the inventors using application of the basic prototype on subcutaneous implanted malignancy model in mice.

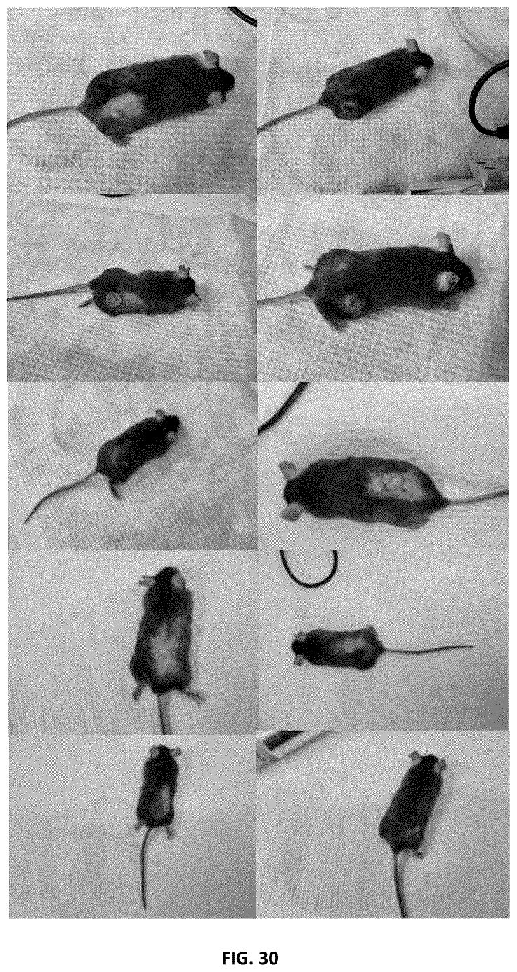

The inventors have measured 10 live (yet, sedated) mice that developed sub-cutaneous superficial malignant tumors as a result of sub-cutaneous injection of murine malignant lung carcinoma cells (FIG. 30). The implanted sub-cutaneous lung cancer lesions are visible on the right flank of each mouse. For measurements, the inventors utilized the above-described prototype device. In contrast to previous experiments with the prototype in which 8 bit images were used, in the present experiments 300 images, being 12 bit images, were acquired with the same 3.3 msec interval between them. The acquisition of images in this set-up took about 1 sec. The analysis of the 50×50 pixels ROIs was done as previously described. For each mouse, 5 measurements were conducted for the malignant tumor and for the adjacent normal skin and then-averaged for obtaining the final results of that mouse.

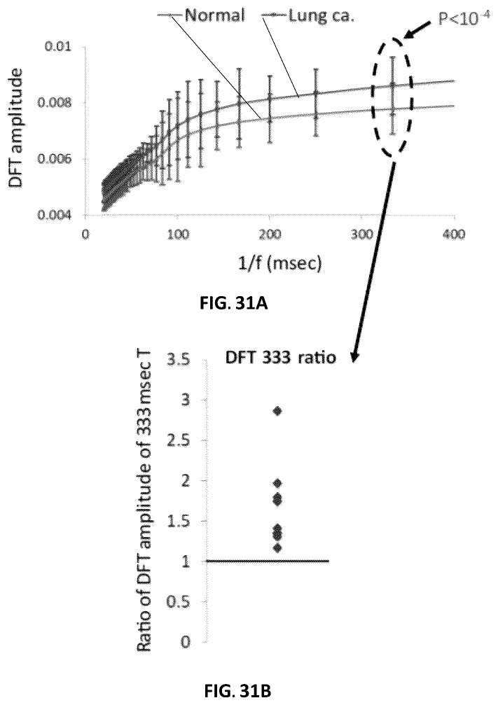

The average DFT results in the 10 mice are summarized in FIGS. 31a-b. FIG. 31a shows average DFT results of temporal fluctuations in pixels intensities in the malignant tumor measured areas in comparison to those results in the adjacent normal areas. The results at the time period (T) of 333 msec are highlighted and the significance of the difference in results in that time period is also shown. FIG. 31b shows the ratio of malignant area DFT results and adjacent normal area DFT results in 333 msec T in each mouse.

As expected, the DFT amplitudes at the tumor sites were higher, mainly at the time period of 333 msec in comparison with the same amplitudes at the adjacent normal skin (FIG. 31a). Namely, for each mouse the inventors calculated the parameter value of the malignant area divided by this value for the adjacent normal area. These ratios were higher than 1 for all mice. This implies that those measured DFT amplitudes, which reflect tissue vibrations, were all higher in malignant areas relative to their adjacent normal skin areas (FIG. 31b).

Thus, in-vivo results in mice subcutaneous implanted malignancy models reinforce the previous in-vitro results with malignant cell-lines obtained by the inventors. Both results are indicative of that (1) live malignant cells and tissues have higher dynamics, and that (2) dynamic measurements could differentiate malignant from normal cells and tissues.

Finally, the inventors have demonstrated the ability to differentiate malignant skin lesions from benign skin lesions in human volunteers (as detailed below).

The following is the description of the experiments conducted by the inventors using application of the above-described prototype device on human volunteers with: BCC (Basal cell carcinoma—malignant skin tumor), hemangiomas, nevuses and verruca.

Following the same procedure of the prototype measurements in the mice model, an area of malignant BCC and adjacent normal skin area in two human volunteers were measured (the BCC diagnosis was determined afterwards by biopsies). In the same way, Hemangiomas, nevuses and verruca (benign skin lesions) were measured in another human volunteers. As previously described, the ratios of DFT amplitudes at 333 msec time period between the skin lesion area and the adjacent normal skin were calculated.

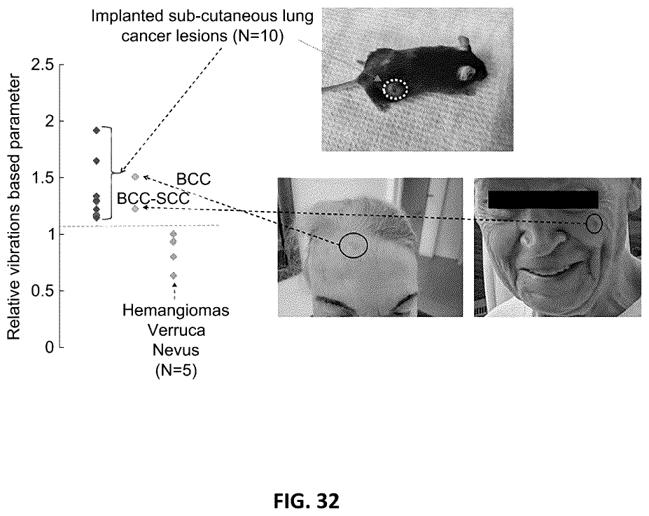

FIG. 32 summarizes the results in Mice and in human volunteers. Shown in the figure are the ratios of malignant area results divided by the adjacent normal area results for (i) the subcutaneous implanted malignancy mice model (FIG. 30), (ii) two human volunteers with a malignant BCC, (iii) other volunteers with benign hemangiomas, nevuses or verruca. Images of the BCC lesions and a representative subcutaneous implanted malignancy lesion in a mouse are shown on the right.

As expected, the ratios of malignant area results divided by the adjacent normal area were higher than 1 for BCC, yet lower than 1 for the benign lesions (hemangiomas, nevuses and verruca). These results reinforce the results of the mice subcutaneous implanted malignancy model experiment (also shown for comparison), in which the malignant subcutaneous skin lesions had ratios higher than 1.

Thus, the inventors have shown that spectral analysis (either ASD or PSD) may provide a simple and effective technique to study active cellular vibrations and the overall mechanical activity of cells. Active vibrations of the cell membrane may influence lymphocyte ability to respond to immunological cues and may further enable malignant cells to escape immunological surveillance.

1. An inspection system comprising an analyzer configured as a computer system configured and operable for data communication with an image data provider to receive image data comprising a sequence of image data pieces corresponding to a sequence of acquisitions of measurement regions of a cell-containing sample being inspected collected using a pixelated detector, said computer system comprising a data processor configured and operable for processing and analyzing the image data to identify dynamics in the image data indicative of vibrational motion of cells in the sample in a direction substantially perpendicular to the cells' surface, and generating data indicative of one or more abnormality associated parameters of cells in the sample being inspected, said processing and analyzing comprising:
determining data indicative of a distribution of mechanical properties within the measurement regions located within a surface region of the cell-containing sample, by carrying out the following:
determining at least one of the following: (i) determining Discrete Fourier Transform (DFT) of data corresponding to said image data and generating DFT representation of said image data indicative of temporal position changes of cellular constituents, and (ii) for each of one or more pairs of images from said sequence of images, determining data indicative of a Pearson correlation coefficient, R, between images of the pair; and
extracting, from at least one of said DFT representation and said data indicative of the Pearson correlation coefficient, R, at least one abnormality associated parameter of the cells in the sample being inspected.

2. The inspection system according to claim 1, wherein said image data pieces correspond to the acquisitions performed using speckle-based imaging using substantially normal incidence of coherent illumination on the surface region of the cell-containing sample and detection of substantially specular reflection from said surface.

3. The inspection system according to claim 1, characterized by at least one of the following:
said data indicative of the Pearson correlation coefficient, R, between images of the pair comprises at least one of the following: the Pearson correlation coefficient, R; spectral variation of the Pearson correlation coefficient, R; and a coefficient of variance, CV, corresponding to temporal variation of the Pearson correlation coefficient, R;
said determining of the data indicative of the distribution of mechanical properties within the measurement regions further comprises determining correlations of values of the image data indicative of a degree of arbitrariness of position changes of cellular constituents;
the image data is indicative of said sequence of image acquisitions performed by one or more of the following imaging systems: Differential Interference Contrast (DIC) microscope, confocal microscope, wide-field microscope with epi-illumination or Total Internal Reflection Fluorescene (TIRF) based imaging system.

4. The inspection system according to claim 1, characterized by at least one of following: the images of the pair are sequential images; and the images of the pair are images timely spaced by one or more images of said sequence of images.

5. (canceled)

6. (canceled)

7. The inspection system according to claim 1, wherein said one or more tumor associated parameters comprise at least one parameter of malignant cells selected from the following: existence of malignant cells in the sample; grading of malignancy of the cells, location of the cells in the sample.

8. (canceled)

9. The inspection system according to claim 1, wherein the image data comprises said image acquisitions performed by a speckle-based imaging system, the image data comprising the sequence of images of said cell-containing sample with speckle patterns superimposed with said images, variation of said speckle patterns along said sequence of images being indicative of the vibrational motion of the cells' surface in the direction substantially perpendicular to the cells' surface.

10. The inspection system according to claim 1, wherein said data processor comprises a processing utility configured and operable to perform Discrete Fourier Transform (DFT) of data corresponding to the image data being received and generate DFT representation thereof, and a motion analyzer utility configured and operable to analyze the DFT representation of the image data and identify and locate motions of the cell surface and/or intracellular particles.

11. The inspection system according to claim 10, wherein said motion analyzer utility is preprogrammed to perform model-based processing of the DFT representation of the image data to determine corresponding Amplitude Spectral Distribution (ASD) representation of the image data, and extract from the ASD one or more predetermined parameters describing an increase in mechanical fluctuations characterizing malignant cells in contrast to physiologically normal cells.

12. The inspection system according to claim 10, wherein the image data comprises the sequence of images of said sample with speckle patterns superimposed with said images, said one or more predetermined parameters including a frequency of pixel intensity fluctuations.

13. The inspection system according to claim 1, wherein the image data provider comprises an imaging system configured and operable to perform an imaging session including acquisition of a sequence of images of the sample utilizing a pixelated detector and generating corresponding image data.

14. The inspection system according to claim 13, wherein said imaging system is configured and operable to perform speckle-based imaging sessions, wherein each image acquisition includes illuminating a surface of the sample with coherent light and detecting light returned from the illuminated surface of the sample by the pixelated detector located in an image plane of said surface, the image data comprising the sequence of images of said sample with speckle patterns superimposed with said images, variation of said speckle patterns along said sequence of images being indicative of the vibrational motion of the cells' surface in the direction substantially perpendicular to the cells' surface.

15. The inspection system according to claim 14, wherein the imaging system comprises an adjustable phase and intensity modulator device accommodated in an optical path of a part of the illuminating light and configured and operable to apply phase and intensity modulation to said part of the illuminating beam and direct a modulated light beam to propagate along a light collection channel to be combined with the light returned from the sample to thereby create destructive interference between the modulated illuminating light and the light returned from the sample at said pixelated detector.

16. An inspection system for determining one or more abnormality associated parameters of a cell-containing sample, the system comprising: an imaging system configured and operable to perform an imaging session including a sequence of acquisitions on the cell-containing sample utilizing speckle-based imaging using substantially normal incidence of coherent illumination on a surface region of the cell-containing sample, detection with a pixelated detector of substantially specular reflections of the illumination from the surface region of the cell-containing sample and generation of image data in the form of a corresponding sequence of speckled images; and an analyzer system in data communication with said imaging system, the analyzer system being configured and operable to process and analyze the image data to identify predetermined dynamics in the image data indicative of vibrational motion of cells' surface in a direction substantially perpendicular to the cells' surface, enabling determination of said one or more tumor associated parameters.

17. A medical device comprising: a probe unit comprising an imaging system adapted to perform a sequence of image acquisitions of a cell-containing sample during an imaging session and provide corresponding image data, and an analyzer system for receiving and processing the image data to generate data indicative of one or more abnormality associated parameters of the sample, wherein: said imaging system is configured and operable to perform speckle-based image acquisitions, the image data therefore comprising images of the sample's surface superimposed with speckle patterns, and is therefore indicative of vibrational motion of cells' surface in the sample in a direction substantially perpendicular to cells' surface, enabling the processing of the image data to detect a sample's region containing malignant cells and determine said one or more parameters.

18. The medical device according to claim 17, wherein said imaging system is configured and operable to perform speckle-based imaging sessions, wherein each image acquisition includes illuminating a surface of the sample with coherent light and detecting light returned from the illuminated surface of the sample by the pixelated detector located in an image plane of said surface, the image data comprising the sequence of images of said sample with speckle patterns superimposed with said images, variation of said speckle patterns along said sequence of images being indicative of the vibrational motion of the cells' surface in the direction substantially perpendicular to the cells' surface.

19. The medical device according to claim 18, characterized by at least one of the following:
said imaging system is configured to define illumination and light collection channels substantially perpendicular to the sample's surface;
the imaging system comprises an adjustable phase and intensity modulator device accommodated in an optical path of a part of the illuminating light and configured and operable to apply phase and intensity modulation to said part of the illuminating beam and direct a modulated light beam to propagate along a light collection channel to be combined with the light returned from the sample to thereby create destructive interference between the modulated illuminating light and the light returned from the sample at said pixelated detector.

20. (canceled)

21. A method for use in inspection of a cell-containing sample, the method comprising:
providing image data comprising a sequence of image data pieces corresponding to a sequence of acquisitions of measurement regions within a surface region of the cell-containing sample performed using speckle-based imaging using substantially normal incidence of coherent illumination on the surface region and detection by a pixelated detector of substantially specularly reflected light from said surface region,
processing the image data to determine data indicative of distribution of mechanical properties within the measurement regions, said processing comprising:
carrying out at least one of the following: (i) determining Discrete Fourier Transform (DFT) of data corresponding to said image data and generating DFT representation thereof indicative of temporal position changes of intracellular constituents, and (ii) for each pair of image data pieces, determining data indicative of a Pearson correlation coefficient, R, between images of the pair; and
extracting, from at least one of said DFT representation and said data indicative of the Pearson correlation coefficient, R, at least one abnormality associated parameter of the cells in the sample being inspected, thereby identifying predetermined dynamics in the image data indicative of vibrational motion of cells in the sample in a direction substantially perpendicular to the cells' surface.

22. The method according to claim 21, characterized by at least one of the following:
said data indicative of the Pearson correlation coefficient, R, between images of the pair comprises at least one of the following: the Pearson correlation coefficient, R; spectral variation of the Pearson correlation coefficient, R; and a coefficient of variance, CV, corresponding to temporal variation of the Pearson correlation coefficient, R:
the images of the pair are sequential images;
the images of the pair are images timely spaced by one or more images for said sequence of images;
said determining of the data indicative of the distribution of mechanical properties within the measurement regions further comprises determining correlation of values of the image date indicative of a degree of arbitrariness of position changes of cellular constituents;
the cell-containing samples is selected from the following: live cell culture, liquid live cell-containing samples; live tissue samples or organoids.

23. (canceled)

24. (canceled)

25. (canceled)

26. The method according to claim 21, wherein the cell-containing sample is selected from the following: live cell culture, liquid live cell-containing sample; live tissue sample or organoids, said liquid cell-containing sample comprises at least one of the following: blood, plasma, urine, Cerebral spinal fluid, lavage fluid.

27. (canceled)
